(19) United States
(12) Patent Application Publication
(10) Pub. No.: US 2013/0002528 A1
(43) Pub. Date: Jan. 3, 2013

(54) LIQUID CRYSTAL DISPLAY DEVICE, PIXEL CIRCUIT, AND DRIVING METHOD

(75) Inventors: Seiji Ohhashi, Osaka-shi (JP); Tsuyoshi Kamada, Osaka-shi (JP); Tetsuya Ide, Osaka-shi (JP); Shohei Katsuta, Osaka-shi (JP)

(73) Assignee: SHARP KABUSHIKI KAISHA, Osaka-shi, Osaka (JP)

(21) Appl. No.: 13/583,645

(22) PCT Filed: Mar. 25, 2011
(86) PCT No.: PCT/JP2011/057454

§ 371 Date: Sep. 10, 2012

(30) Foreign Application Priority Data
Mar. 29, 2010 (JP) 2010-075784

(51) Int. Cl. G09G 3/36

(52) U.S. Cl. 345/90

(57) ABSTRACT

A liquid crystal display device includes: pixels each composed of n sub-pixels, the pixels being arranged in a matrix; a switching element provided for each sub-pixel; a liquid crystal element provided for each sub-pixel; n reference potential trunk lines having a mutually different magnitude of potential; a first display signal line that supplies a display signal; a scanning line; a controller; a first substrate on which the n reference potential trunk lines and the switching elements are disposed; and a second substrate on which the first display signal lines are disposed. The liquid crystal elements are formed in between the first substrate and the second substrate. A pole at one end of each liquid crystal element of the n sub-pixels is connected to the first display signal line, and a pole at the other end of each liquid crystal element of the n sub-pixels is connected to the respective first to nth reference potential trunk lines via the respective switching elements. From the scanning line, the controller supplies an on-state signal to each switching element of the n sub-pixels with the same timing.

### TECHNICAL FIELD

The present invention relates to a liquid crystal display device, a pixel circuit, and a driving method.

The subject application claims priority based on the patent application No. 2010-075784 filed in Japan on Mar. 29, 2010 and incorporates by reference herein the contents thereof.

### BACKGROUND ART

In recent years, high image quality has been demanded of liquid crystal display devices, and a multipixel method is used (for example, refer to Patent Document 1), in which one pixel is made up of two sub-pixels and the tone is controlled in units of sub-pixels. In the multipixel method, one pixel is composed of two sub-pixels that are electrically equivalent. The multipixel method varies the potential on each supplementary capacitance Cs connected to the two sub-pixels, so as to cause a potential difference between the sub-pixels and to control the rendering of tone.

As a method of constituting a liquid crystal display device, an opposing matrix constitution is proposed (for example, refer to Patent Document 2). The opposing matrix constitution has a scanning bus line, an installation bus line, a switching element and display electrode on a first glass substrate. A transparent electrode for dual-purpose use as a data bus line is provided on a second glass substrate. This opposing matrix constitution does not have lamination of data bus lines and scanning bus lines. For this reason, compared with a constitution other than an opposing matrix constitution, the frequency of occurrence of interlayer shorting is greatly reduced, and yield is good. Also, because the opposing matrix constitution enables inspection and repair of each glass substrate alone, yield is good.

### PRIOR ART DOCUMENT

### Patent Documents

Patent Document 1: Japanese Unexamined Patent Application, First Publication No. 2004-62146
Patent Document 2: Japanese Unexamined Patent Application, First Publication No. S62-133478

### DISCLOSURE OF INVENTION

### Problem to be Solved by the Invention

In the opposing matrix constitution according to the conventional art of Patent Document 2, however, there is no disclosure of multipixel implementation. Also, the multipixel method according to the conventional art of Patent Document 1 does not describe an opposing matrix constitution.

The present invention was made in consideration of the above-noted problem and has as an object to provide a liquid crystal display device constituted by multipixels in an opposing matrix, a pixel circuit, and a driving method.

### Means to Solve the Problem

(1) To achieve the above-described object, a first aspect of the present invention is a liquid crystal display device including: pixels each composed of n (n≧2, where n is a positive integer) sub-pixels that correspond to a plurality of luminance regions, the pixels being arranged in a matrix; a switching element provided for each sub-pixel; a liquid crystal element provided for each sub-pixel; n (1st to nth) reference potential trunk lines having a mutually different magnitude of potential; a first display signal line that supplies a display signal; a scanning line; a controller; a first substrate on which the n (1st to nth) reference potential trunk lines and the switching elements are disposed; and a second substrate on which the first display signal lines are disposed; wherein the liquid crystal elements are formed in between the first substrate and the second substrate, a pole at one end of each liquid crystal element of the n sub-pixels is connected to the first display signal line, and a pole at the other end of each liquid crystal element of the n sub-pixels is connected to the respective first to nth reference potential trunk lines via the respective switching elements, and from the scanning line, the controller supplies an on-state signal to each switching element of the n sub-pixels with the same timing.

(2) In the first aspect of the present invention, the controller may switch the polarity of the potential of the first reference potential trunk line for each frame.

(3) In the first aspect of the present invention, the controller may alternately switch the magnitude of potential to the sequence from the first reference potential trunk line to the nth reference potential trunk line and from the nth reference potential trunk line to the first reference potential trunk line for each frame.

(4) In the first aspect of the present invention, the controller may switch the potential of the first display signal line for each frame, about a prescribed reference voltage as the center, additionally add the prescribed voltage amplitude about the potential to the prescribed reference voltage as the center, and alternately switch the magnitude of the potential between the sequence from the first reference potential trunk line to the nth reference potential trunk line and the sequence from the nth reference potential trunk line to the first reference potential trunk line for each frame.

(5) In the first aspect of the present invention, the liquid crystal display device may further include a second display signal line that supplies a display signal line, wherein each of the liquid crystal elements of n sub-pixels that is disposed so to be adjacent to the n sub-pixels in the row direction may have one end that is connected to the second display signal line and another end that is connected from the first reference potential trunk line to the nth reference potential trunk line, via each respective switching element, and wherein the controller may alternately switch the polarity of the potential on the first display signal line and the second display signal line for each frame.

(6) In the first aspect of the present invention, pixels constituted by the n sub-pixels and the n sub-pixels disposed so as to be adjacent thereto in the row direction may be disposed in a matrix, and further include: a first' reference trunk line having a potential that differs in magnitude with the first reference trunk line and a second display signal line that supplies a display signal wherein the liquid crystal elements of the sub-pixels of pixels that are adjacent in the row direction to sub-pixels of the liquid crystal elements connected to the first reference trunk line via the switching elements may have one end that is connected to the second display signal line and another end that is connected to the first' reference potential trunk line via the switching element, the liquid crystal elements of the sub-pixels of pixels that are adjacent in the row direction to sub-pixels of the liquid crystal elements connected to the second reference trunk line via the switching elements may have one end that is connected to the second display signal line and have another end that is connected to the second reference potential trunk line via the switching element, and the controller may alternately switch the relationship between the magnitude of the potential on the first reference potential trunk line and the magnitude of the potential on the first' reference trunk line for each frame.

(7) In the first aspect of the present invention, the controller may alternately switch from a relationship in which the potential on the first reference potential trunk line is larger than the potential on the first' reference trunk line to a relationship in which the potential on the first' reference trunk line is larger than the potential on the first reference potential trunk line for each frame, or alternately exchange the polarity of the potential on the first' reference trunk line with the polarity of the potential on the first reference potential trunk line for each frame.

(8) In the first aspect of the present invention, pixels constituted by the n sub-pixels and the n sub-pixels disposed so as to be adjacent thereto in the row direction may be disposed in a matrix, and further include: a first' reference trunk line having a potential that differs in magnitude with that of the first reference trunk line, a third' reference trunk line having a potential that differs in magnitude with that of a third reference trunk line, and a second display signal line supplying a display signal, wherein the liquid crystal elements of the sub-pixels of pixels that are adjacent in the row direction to sub-pixels of the liquid crystal elements connected to the first reference trunk line via the switching elements may have one end that is connected to the second display signal line and another end that is connected to the first' reference potential trunk line via the switching element, the liquid crystal elements the sub-pixels of pixels that are adjacent in the row direction to sub-pixels of the liquid crystal elements connected to the second reference trunk line via the switching elements may have one end that is connected to the second display signal line and another end that is connected to the second reference potential trunk line via the switching element, and the liquid crystal elements of the sub-pixels of pixels that are adjacent in the row direction to sub-pixels of the liquid crystal elements connected to the third reference trunk line via the switching elements may have one end that is connected to the second display signal line and another end that is connected to the third' reference potential trunk line via the switching element, wherein the controller may alternately exchange the relationship of the magnitude of the potential on the first reference potential trunk line and the magnitude of the potential on the first' reference trunk line and the relationship of the magnitude of the potential on the third reference potential trunk line and the magnitude of the potential on the third' reference trunk line, for each frame.

(9) In the first aspect of the present invention, the controller may alternately switch form a relationship in which the potential on the first reference potential trunk line is larger than the potential on the first' reference trunk line and also the potential on the third reference potential trunk line is larger than the potential on the third' reference trunk line, to a relationship in which the potential on the first' reference trunk line is larger than the potential on the first reference potential trunk line and also the potential on the third' reference trunk line is larger than the potential on the third reference potential trunk line, for each frame, or alternately switch from a relationship in which the potential on the first' reference trunk line is larger than the potential on the first reference potential trunk line and also the potential on the third reference potential trunk line is larger than the potential on the third' reference trunk line, to a relationship in which the potential on the first reference potential trunk line is larger than the potential on the first' reference trunk line and also the potential on the third' reference trunk line is larger than the potential on the third reference potential trunk line, for each frame.

(10) In the first aspect of the present invention, each sub-pixel of pixels on the s-th row (where s is a positive integer) may be, with respect to the n-th reference potential trunk line, disposed in linear symmetry with each sub-pixel of the pixels on the (s−1)th row.

(11) To achieve the above-described object, a second aspect of the present invention is a pixel circuit of a liquid crystal display device in which a liquid crystal is formed between a first substrate, on which a 1st to the nth reference potential trunk lines and the switching elements are disposed, and a second substrate, on which the first display signal lines are disposed, wherein pixels constituted by n (where n, a positive integer, is greater than or equal to 2) sub-pixels corresponding to a plurality of luminance regions are disposed in a matrix, and including: switching elements provided for each of the sub-pixels, liquid crystal elements provided for each of the sub-pixels, n reference potential trunk lines from the 1st reference potential trunk line to the nth reference potential trunk line, having mutually different magnitudes of potential, a first display signal line that supplies a display signal, a scanning line, and a controller, wherein a pole at one end of each liquid crystal element of the n sub-pixels is connected to the first display signal line, and a pole at the other end of each liquid crystal element of the n sub-pixels is connected to the respective first to nth reference potential trunk lines via the respective switching elements, and the controller supplies an on-state signal from the scanning line to each of switching element of the n sub-pixels with the same timing.

(12) To achieve the above-described object, a third aspect of the present invention is a pixel driving method in which a liquid crystal is formed between a first substrate, on which 1st to nth reference potential trunk lines and switching elements are disposed, and a second substrate, on which first display signal lines are disposed, wherein pixels constituted by n (where n, a positive integer, is greater than or equal to 2) sub-pixels corresponding to a plurality of luminance regions are disposed in a matrix, and including: switching elements provided for each of the sub-pixels, liquid crystal elements provided for each of the sub-pixels, n reference potential trunk lines from the 1st reference potential trunk line to the nth reference potential trunk line, having mutually different magnitudes of potential, a first display signal line supplying a display signal, a scanning line, and a controller, wherein a pole at one end of each liquid crystal element of the n sub-pixels is connected to the first display signal line, and a pole at the other end of each liquid crystal element of the n sub-pixels is connected to the respective first to nth reference potential trunk lines via the respective switching elements, and the controller supplies an on-state signal from the scanning line to each of switching element of the n sub-pixels with the same timing.

To achieve the above-described object, in a pixel driving method in which a liquid crystal is formed between a first substrate, on which 1st to nth reference potential trunk lines and switching elements are disposed, and a second substrate, on which first display signal lines are disposed, pixels constituted by n (where n, a positive integer, is greater than or equal to 2) sub-pixels corresponding to a plurality of luminance regions are disposed in a matrix, and includes: switching elements provided for each of the sub-pixels, liquid crystal elements provided for each of the sub-pixels, n reference potential trunk lines from the 1st reference potential trunk line to the nth reference potential trunk line, having mutually different magnitudes of potential, a first display signal line supplying a display signal, a scanning line, and a controller, wherein a pole at one end of each liquid crystal element of the n sub-pixels is connected to the first display signal line, and a pole at the other end of each liquid crystal element of the n sub-pixels is connected to the respective first to nth reference potential trunk lines via the respective switching elements, and the controller supplies an on-state signal from the scanning line to each of switching element of the n sub-pixels with the same timing.

### EFFECT OF THE INVENTION

According to the present invention, pixels, each of which is composed of n (n≧2, wherein n is a positive integer) sub-pixels that correspond to a plurality of luminance regions, are arranged in a matrix. A switching element provided for each sub-pixel; a liquid crystal element provided for each sub-pixel; n (1st to nth) reference potential trunk lines having a mutually different magnitude of potential; a first display signal line for supplying a display signal; a scanning line; a controller; a first substrate having the n (1st to nth) reference potential trunk lines and the switching elements; and a second substrate having the first display signal lines are provided. The liquid crystal elements are formed between the first substrate and the second substrate. One pole of each liquid crystal element of the n sub-pixels is connected to the first display signal line, while the other pole of each liquid crystal element of the n sub-pixels is connected to the respective 1st to nth reference potential trunk lines via the respective switching element. From the scanning line, the controller supplies an on-state signal to each switching element of the n sub-pixels with the same timing. For this reason, a liquid crystal display device constituted by multipixels in an opposing matrix, a pixel circuit, and a driving method are possible.

### BRIEF DESCRIPTION OF THE DRAWINGS

FIG. 1 is an oblique view of one example of a liquid crystal display device to which an embodiment of the present invention is applied.

FIG. 2 is a drawing of the constitution of one example of a liquid crystal display device to which an embodiment of the present invention is applied.

FIG. 3 is an equivalent circuit describing the operation at the Lth frame of the liquid crystal display device having two sub-pixels according to a first embodiment.

FIG. 4 is an equivalent circuit describing the operation at the (L+1) th frame of the liquid crystal display device having two sub-pixels according to the same embodiment.

FIG. 5 is a timing diagram of the liquid crystal display device at the Lth frame and at the (L+1) th frame according to the same embodiment.

FIG. 6 is a drawing describing a layout example on a first substrate 10 to which the same embodiment is applied.

FIG. 7 is a cross-sectional view of an amorphous silicon TFT commonly used in current liquid crystal televisions.

FIG. 8 is an equivalent circuit describing the operation at the Lth frame of the liquid crystal display device having two sub-pixels according to a second embodiment.

FIG. 9 is an equivalent circuit describing the operation at the (L+1) th frame of the liquid crystal display device having two sub-pixels according to the same embodiment.

FIG. 10 is an equivalent circuit describing the operation at the Lth frame of the liquid crystal display device having two sub-pixels according to a third embodiment.

FIG. 11 is an equivalent circuit describing the operation at the (L+1) th frame of the liquid crystal display device having two sub-pixels according to the same embodiment.

FIG. 12 is a timing diagram of the liquid crystal display device at the Lth frame and at the (L+1) th frame according to the same embodiment.

FIG. 13 is a drawing describing a layout example on a first substrate 10 to which the same embodiment is applied.

FIG. 14 is an equivalent circuit describing the operation at the (L+1) th frame of the liquid crystal display device having two sub-pixels according to a fourth embodiment.

FIG. 15 is a timing diagram of the liquid crystal display device at the Lth frame and at the (L+1) th frame according to the same embodiment.

FIG. 16 is an equivalent circuit describing the operation at the Lth frame of the liquid crystal display device having three sub-pixels according to a fifth embodiment.

FIG. 17 is an equivalent circuit describing the operation at the (L+1) th frame of the liquid crystal display device having three sub-pixels according to the same embodiment.

FIG. 18 is a timing diagram of the liquid crystal display device at the Lth frame and at the (L+1) th frame according to the same embodiment.

FIG. 19 is an equivalent circuit describing the operation at the Lth frame of the liquid crystal display device having three sub-pixels according to a sixth embodiment.

FIG. 20 is an equivalent circuit describing the operation at the (L+1) th frame of the liquid crystal display device having three sub-pixels according to the same embodiment.

FIG. 21 is a timing diagram of the liquid crystal display device at the Lth frame and at the (L+1) th frame according to the same embodiment.

FIG. 22 is an equivalent circuit describing the operation at the Lth frame of the liquid crystal display device having three sub-pixels according to a seventh embodiment.

FIG. 23 is an equivalent circuit describing the operation at the (L+1) th frame of the liquid crystal display device having three sub-pixels according to the same embodiment.

FIG. 24 is a timing diagram of the liquid crystal display device at the Lth frame and at the (L+1) th frame according to the same embodiment.

FIG. 25 is an equivalent circuit describing the operation at the Lth frame of the liquid crystal display device having n (even number) sub-pixels according to an eighth embodiment.

FIG. 26 is an equivalent circuit describing the operation at the (L+1) th frame of the liquid crystal display device having n (even number) sub-pixels according to the same embodiment.

FIG. 27 is a timing diagram of the liquid crystal display device at the Lth frame and at the (L+1) th frame according to the same embodiment.

FIG. 28 is an equivalent circuit describing the operation at the Lth frame of the liquid crystal display device having n (odd number) sub-pixels according to a ninth embodiment.

FIG. 29 is an equivalent circuit describing the operation at the (L+1) th frame of the liquid crystal display device having n (odd number) sub-pixels according to the same embodiment.

FIG. 30 is a timing diagram of the liquid crystal display device at the Lth frame and at the (L+1) th frame according to the same embodiment.

### BEST MODE FOR CARRYING OUT THE INVENTION

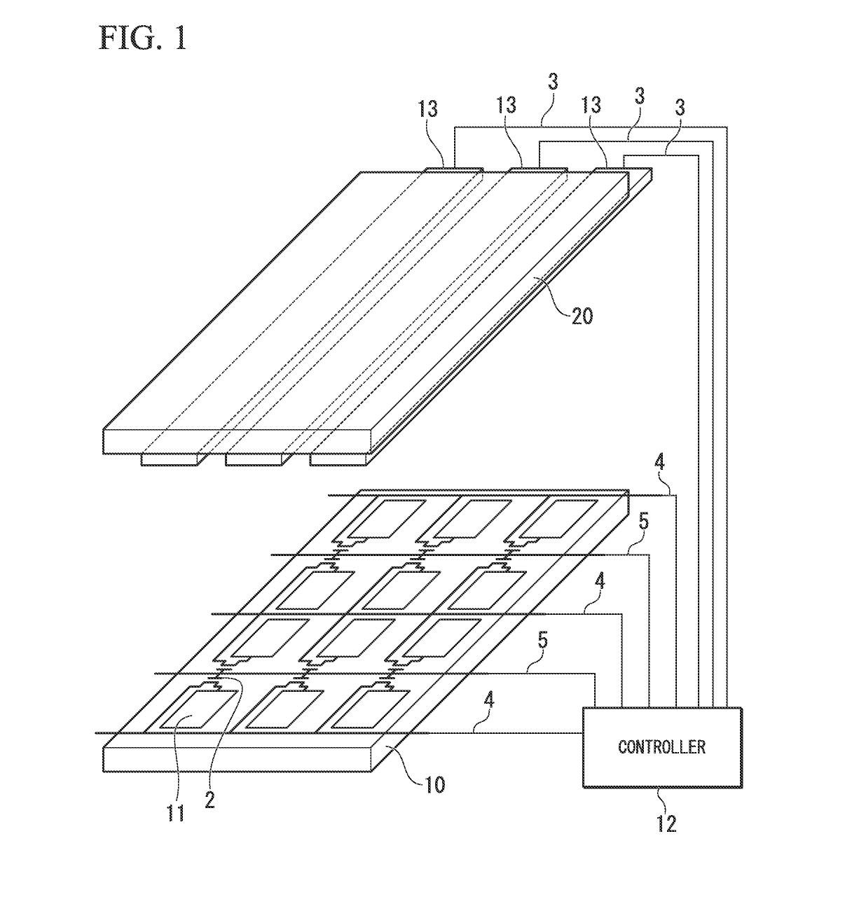

Embodiments of the present invention will be described in detail below, with references being made to FIG. 1 to FIG. 30. The present invention is not restricted to these embodiments, and it is possible to make various modifications thereof within the scope of the technical concept thereof.

FIG. 1 is an oblique view showing one example of a liquid crystal display device to which the embodiment of the present invention is applied. As shown in FIG. 1, the liquid crystal display device of the embodiment of the present invention has the first substrate 10, a second substrate 20 that is disposed in opposition with respect to the first substrate 10, and a controller 12. A liquid crystal material is sealed between the first substrate 10 and the second substrate 20. The first substrate 10 has a plurality of switching elements 2 implemented by a plurality of TFTs (thin-film transistors), a plurality of reference potential trunk lines 4, a plurality of scanning lines (gate bus lines) 5, and display electrodes 11. Additionally, the second substrate 20 has stripe-shaped transparent electrodes 13. The transparent electrodes 13 are each connected to a display signal line (data bus line) 3. In this manner, the switching elements 2, the reference potential trunk lines 4, the scanning lines 5, and the display electrodes 11 are formed on the first substrate 10. On the second substrate 20 that is in opposition thereto, stripe-shaped transparent electrodes 13 that are connected to the display signal lines 3 are formed, thereby constituting an opposing matrix. Also, a backlight (not shown) is disposed below the first substrate 10.

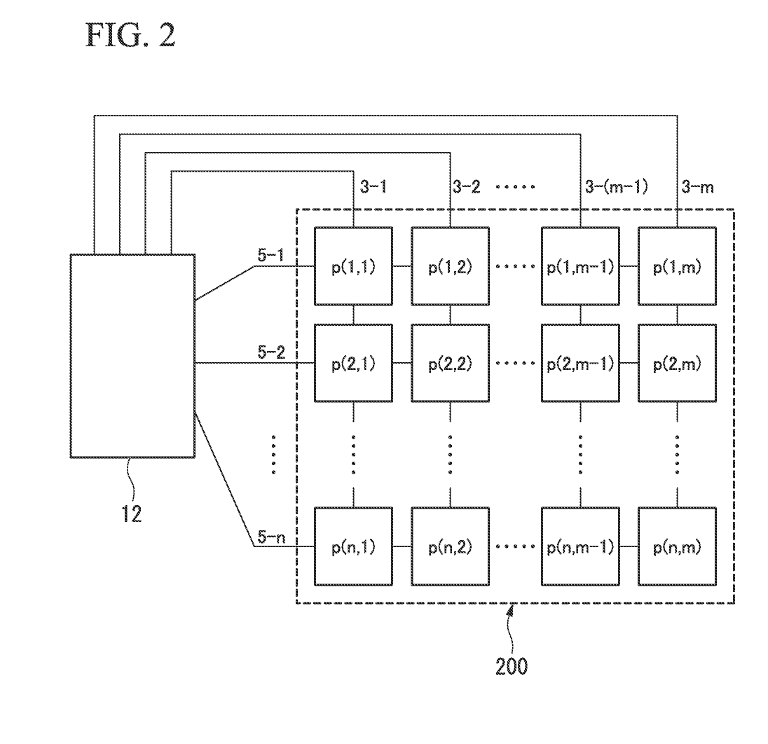

FIG. 2 is a drawing of the constitution of one example of a liquid crystal display device to which the embodiment of the present invention is applied. A general liquid crystal display device has m display signal lines (data bus lines) 3, n scanning lines (gate bus lines) 5, and n×m pixels (p(1, 1) to p(1, m), p(2, 1) to p(2, m) . . . p(n, 1) to p(n, m)), as shown in FIG. 2. The n×m pixels form a pixel section 200. In the case of a liquid crystal display device with a full HD resolution, for example, the number of data bus lines is n=1920×3 (where 3 corresponds to R, G, and B)=5760, and the number of gate bus lines is m=1080. The controller 12 controls the display signal supplied to the display signal line 3 so that its polarity is reversed between adjacent display signal lines 3. That is, the polarities of the display signal of the display signal line 3-1 and the display signal line 3-2 are the reverse of each other, that of lines 3-2 and 3-3 are the reverse of each other, and that of lines 3-3 and 3-4 are also the reverse of each other.

### First Embodiment

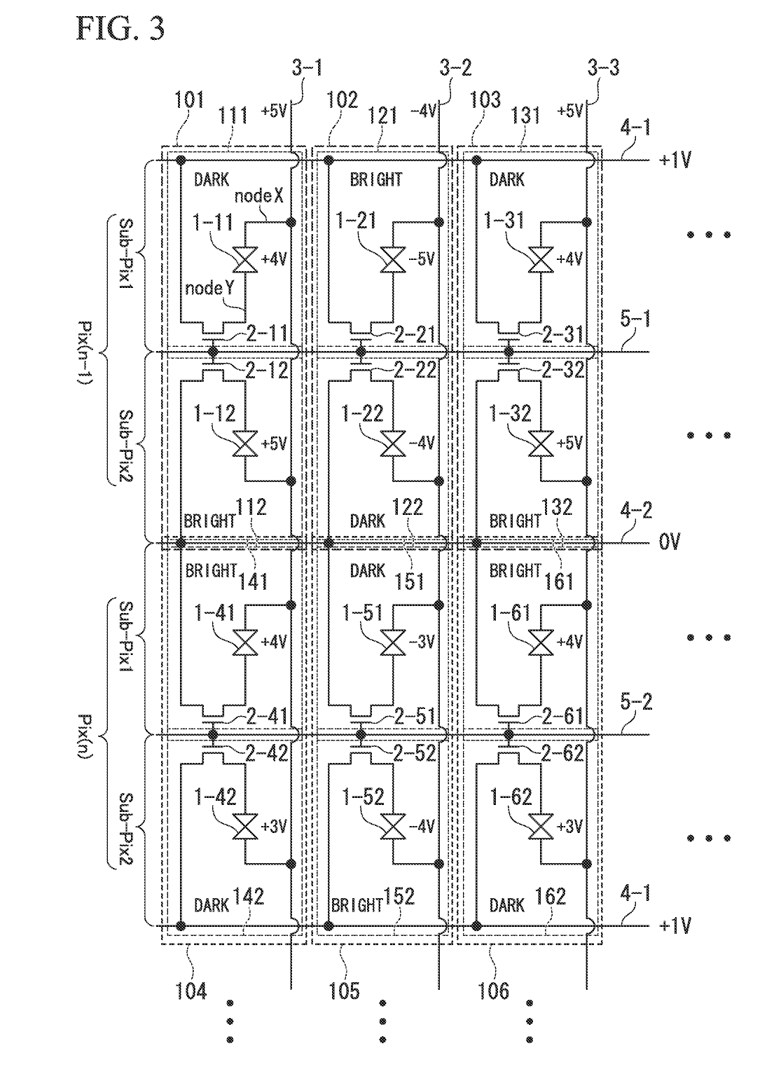

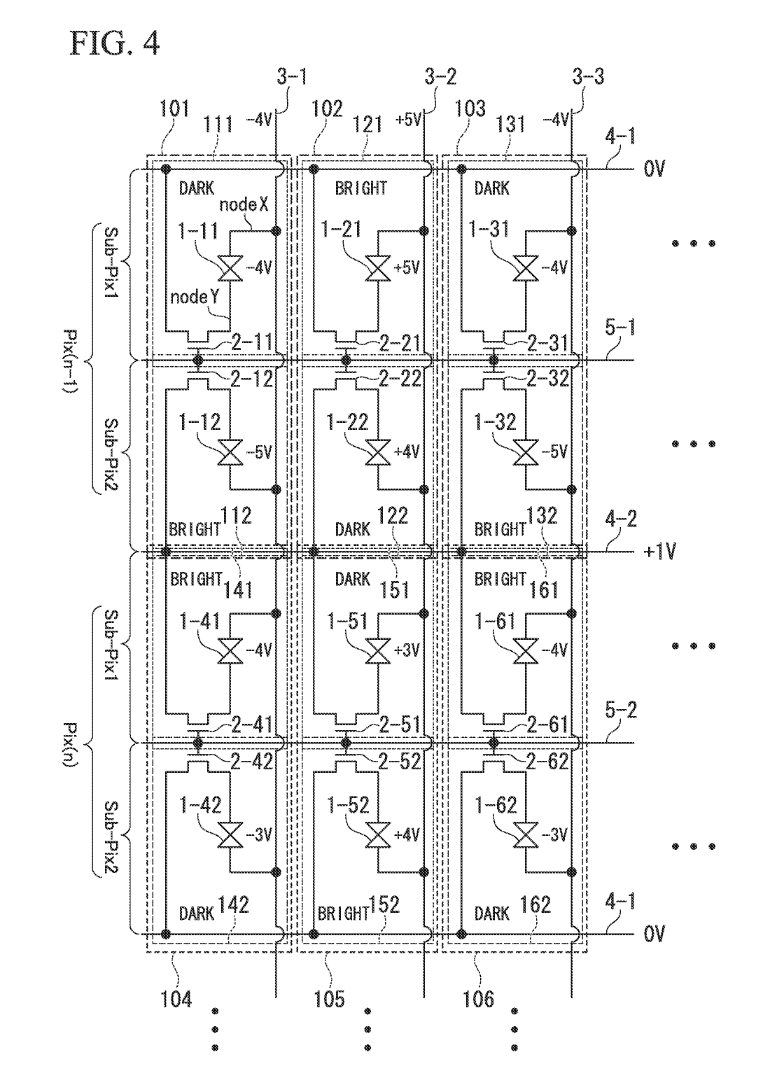

FIG. 3 is an equivalent circuit describing the operation at the Lth frame of the liquid crystal display device having pixels (Pix(n−1), Pix(n)) that have two sub-pixels (Sub-Pix1, Sub-Pix2) in the first embodiment. FIG. 4 is an equivalent circuit describing the operation at the (L+1) th frame of the liquid crystal display device according to the first embodiment having pixels (Pix(n−1), Pix (n)) that have two sub-pixels (Sub-Pix1, Sub-Pix2). One frame is, for example, in the case of a liquid crystal display device driven by 60-Hz, 1/60 s. As shown in FIG. 3, the liquid crystal display device according to the first embodiment has pixels 101 to 106. Each of the pixels 101 to 106 further has two sub-pixels. The pixels 101 and 102 are disposed so as to be adjacent in the row direction. The pixel 101 has, with respect to the column direction from the reference potential trunk line 4-1, the sub-pixel 111 and the sub-pixel 112, disposed in that sequence. The pixel 102 has, with respect to the column direction from the reference potential trunk line 4-1, the sub-pixel 121 and the sub-pixel 122, disposed in that sequence. The pixel 104 and the pixel 105, which are disposed so as to be adjacent in the row direction, are disposed in linear symmetry with the pixel 101 and the pixel 102, with respect to a reference potential trunk line 4-2. The pixel 104 has, with respect to the column direction from the reference potential trunk line 4-1, the sub-pixel 142 and the sub-pixel 141, disposed in that sequence. The pixel 105 has, with respect to the column direction from the reference potential trunk line 4-1, the sub-pixel 152 and the sub-pixel 151, disposed in that sequence. The pixel 103 and the pixel 106 are the same as the above. In the embodiment of the present invention, sub-pixel means each of the plurality of pixels in which one pixel is divided. In a liquid crystal display device that performs an RGB color display, for example, the pixel 101 corresponds to R, the pixel 102 corresponds to G, and the pixel 103 corresponds to B.

Additionally, each sub-pixel is constituted by a liquid crystal element 1 and a switching element 2, and a part of a stripe-shaped transparent electrode 13 opposing thereof. The liquid crystal element is constituted by a liquid crystal material that is sandwiched between one display electrode and the stripe-shaped transparent electrode 13, this being represented as an electrical capacitance in an electrical equivalent circuit. In FIG. 3, for example, the sub-pixel 111 has the liquid crystal element 1-11 and the switching element 2-11, and the sub-pixel 112 has the liquid crystal element 1-12 and the switching element 2-12. The display electrode 11 and the stripe-shaped transparent electrode 13 opposing thereof, in FIG. 3, are equivalently expressed as the electrical connecting parts to the liquid crystal elements 1-11 and 1-12.

The constitution of the sub-pixel 111 and sub-pixel 112 of the pixel 101 will first be described. The gate terminals of the switching element 2-11 and the switching element 2-12 are connected to a common scanning line 5-1. The source terminal of the switching element 2-11 is connected the reference potential trunk line 4-1. The drain terminal of the switching element 2-11 is connected to one end of the liquid crystal element 1-11, which has a capacitive component, via the display electrode 11. The other end of the liquid crystal element 1-11 is connected to a display signal line (first display signal line) 3-1, via the transparent electrode 13. That is, the liquid crystal element 1-11 is sandwiched between the transparent electrode 13 and the electrode 11. The source terminal of the switching element 2-12 is connected to the reference potential trunk line 4-2. The drain terminal of the switching element 2-12 is connected to one end of the liquid crystal element 1-12, via the display electrode 11. The other end of the liquid crystal element 1-12 is connected to the display signal line 3-1, via the transparent electrode 13.

Next, the constitution of the sub-pixels 121 and 122 of the pixel 102 will be described. The gate terminals of the switching element 2-21 and the switching element 2-22 are connected to the common scanning line 5-1. The source terminal of the switching element 2-21 is connected to the reference potential trunk line 4-1. The drain terminal of the switching element 2-21 is connected to one end of the liquid crystal element 1-21, via the display electrode 11. The other end of the liquid crystal element 1-21 is connected to the display signal line (second display signal line) 3-2, via the transparent electrode 13. The source terminal of the switching element 2-22 is connected to the reference potential trunk line 4-2. The drain terminal of the switching element 2-22 is connected to one end of the liquid crystal element 1-22, via the display electrode 11. The other end of the liquid crystal element 1-22 is connected to the display signal line 3-2, via the transparent electrode 13.

Next, the constitution of the sub-pixel 141 and sub-pixel 142 of the pixel 104 will next be described. The gate terminals of the switching elements 2-41 and 2-42 are connected to a common scanning line 5-2. The source terminal of the switching element 2-42 is connected to the reference potential trunk line 4-1. The drain terminal of the switching element 2-42 is connected to one end of liquid crystal element 1-42, via the display electrode 11. The other end of the liquid crystal element 1-42 is connected to the display signal line 3-1, via the transparent electrode 13. The source terminal of the switching element 2-41 is connected to the reference potential trunk line 4-2. The drain terminal of the switching element 2-41 is connected to one end of the liquid crystal element 1-41, via the display electrode 11. The other end of the liquid crystal element 1-41 is connected to the display signal line 3-1, via the transparent electrode 13. Next, the constitution of the sub-pixels 151 and 152 of the pixel 105 will be described. The gate terminals of the switching element 2-51 and the switching element 2-52 are connected to the common scanning line 5-2. The source terminal of the switching element 2-52 is connected to the reference potential trunk line 4-1. The drain terminal of the switching element 2-52 is connected to one end of the liquid crystal element 1-52, via the display electrode 11. The other end of the liquid crystal element 1-52 is connected to the display signal line 3-2, via the transparent electrode 13. The source terminal of the switching element 2-51 is connected to the reference potential trunk line 4-2. The drain terminal of the switching element 2-51 is connected to one end of the liquid crystal element 1-51, via the display electrode 11. The other end of the liquid crystal element 1-51 is connected to the display signal line 3-2, via the transparent electrode 13. The pixel 103 and the pixel 106 are the same as the above.

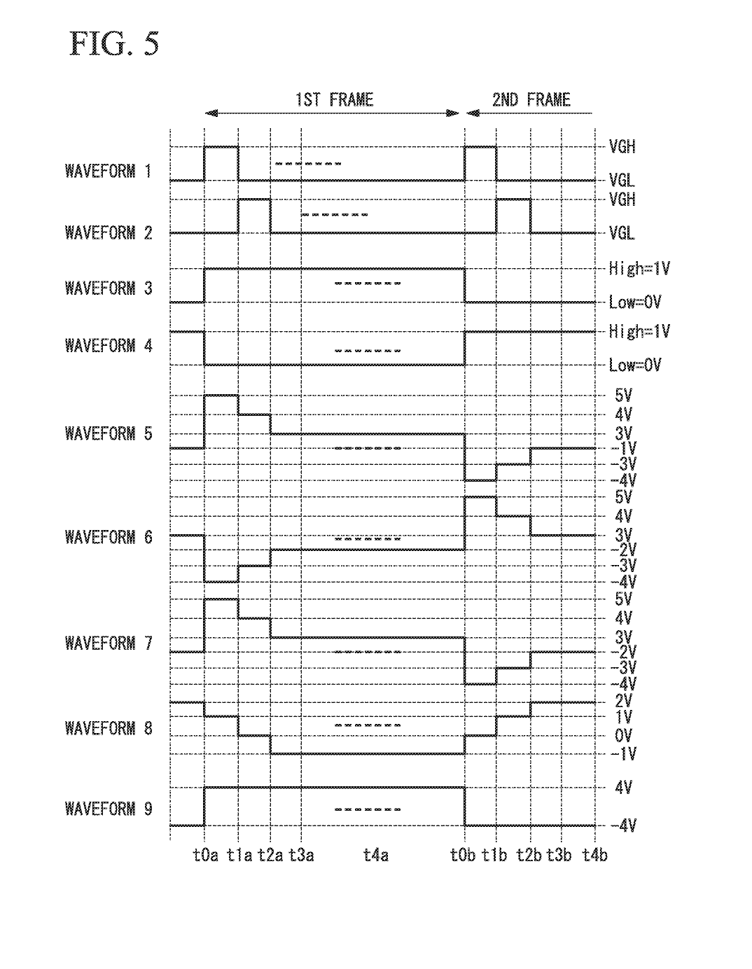

Next, the operation of the liquid crystal display device will be described, using FIG. 3 and FIG. 5. FIG. 5 is a timing diagram of the liquid crystal display device of the first embodiment at the Lth frame and at the (L+1) th frame. The operation of each sub-pixel of the pixels 101 to 106 at the Lth frame (where L is a natural number 1 or larger) will be described.

In FIG. 5, the horizontal axis represents time, and the vertical axis represents electrical potential. The waveform 1 in FIG. 5 shows the time variations of the potential on the scanning line 5-1. The waveform 2 in FIG. 5 shows the time variations of the potential on the scanning line 5-2. The waveform 3 in FIG. 5 shows the time variations of the potential on the reference potential trunk line 4-1. The waveform 4 in FIG. 5 shows the time variations of the potential on the reference potential trunk line 4-2. The waveform 5 in FIG. 5 shows the time variations of the potential on the display signal line 3-1. The waveform 6 in FIG. 5 shows the time variations of the potential on the display signal line 3-2. The waveform 7 in FIG. 5 shows the time variations of the potential on the node X. The waveform 8 in FIG. 5 shows the time variations of the potential on the node Y. The waveform 9 in FIG. 5 shows the time variations of the potential between the node X and the node Y (voltage applied to Sub-pix1).

The controller 12 controls the potential on the reference potential trunk line 4-1 to +1 V, and controls the potential on the reference potential trunk line 4-2 to 0 V (waveforms 3 and 4 in FIG. 5 at time t0a). That is, the controller 12 controls the magnitude of the potential to a relationship in which the potential on the reference potential trunk line 4-1 is larger than that on the reference potential trunk line 4-2. Next, the controller 12 controls the scanning line 5-1 to the high level between times t0a to t1a (time period during rewriting of one pixel), thus placing the switching elements 2-11 to 2-12, 2-21 to 2-22, and 2-31 to 2-32 into the on state. The period during which the output of the scanning line 5-1 is high is set in accordance with the total number of the reference potential trunk lines 3 used in the liquid crystal display device. In a liquid crystal display device that accommodates full HD, for example, the period corresponds to 1/(60×1080) s. In FIG. 3, the controller 12 supplies from the display signal line 3-1 +5 V to the pixel 101 in the first row, and +4 V to the pixel 104 in the second row, and from the display signal line 3-2 supplies −4 V to the pixel 102 in the first row, and −3 V to the pixel 105 in the second row. In the case of displaying from the zero tone to the maximum tone, the range of the signal is, for example, a potential of +5 V to +1 V on the positive polarity side and −5 V to −1 V on the negative polarity side. This signal level may be adjusted to the characteristics of the liquid crystal element to be used. The signal levels on the display signal line 3-1 and the display signal line 3-2 shown in FIG. 5 are the signal levels indicating one example of operation.

Additionally, the controller 12 controls the scanning line 5-2 to the high level between times t1a to t2a, thus placing the switching elements 2-41 to 2-42, 2-51 to 2-52, and 2-61 to 2-62 into the on state.

As an example, in the case of a transmission-type liquid crystal display device in which a backlight (not shown) is disposed below the first substrate 10, the controller 12 controls the light transmissivity of each sub-pixel so as to control the luminance (tone rendering). Alternatively, in the case of a transmission-type liquid crystal display device, the controller 12 controls the light reflectivity of each sub-pixel so as to control the luminance (tone rendering).

The operation of the sub-pixel 111 and the sub-pixel 112 of the pixel 101 will be first described. The controller 12 supplies +5 V from the display signal line 3-1 to the node X of the liquid crystal element 1-11. During the time period t0a to t1a, the switching element 2-11 is set to on by the controller 12 from the scanning line 5-1, and +1 V is applied to the node Y of the liquid crystal element 1-11 from the reference potential trunk line 4-1. For this reason, the potential difference between +5 V on the display signal line 3-1 and +1V on the reference potential trunk line 4-1, this being +4 V, is generated at the liquid crystal element 1-11. That is, this corresponds to writing a potential difference of +4 V into the liquid crystal element 1-11 (equivalent electrical capacitance). A low-level signal is applied from the scanning line 5-1, and after time t1a, at which the switching element 2-11 switches to off, the liquid crystal element 1-11 holds the potential difference of +4 V until the next frame, L+1. During the time period t0a to t1a, the switching elements 2-41 to 2-42 connected to the pixel 104 in the second row continue to hold the potential difference, because of the off state as shown in FIG. 5. Additionally, during the time period t0a to t1a, the switching element 2-12 is turned on, and the potential difference between +5 V on the display signal line 3-1 and 0 V on the reference potential trunk line 4-2, this being +5V, is generated at the liquid crystal element 1-12 (equivalent electrical capacitance). As a result, in the luminance of the sub-pixels 111 to 112 are displayed with the sub-pixel 112, having a large potential difference, displayed with a higher luminance than the sub-pixel 111. For this reason, the sub-pixel 111 is displayed dark, and the sub-pixel 112 is displayed bright.

The controller 12 supplies to the display signal line 3-3 a display signal having the same polarity as the display signal line 3-1. For this reason, during the time period Ma to t1a, the potential difference of +4 V is generated at the liquid crystal element 1-31 (equivalent electrical capacitance) of the sub-pixel 131 of the pixel 103, the same as the sub-pixel 111. Also, the potential difference of +5 V is generated at the liquid crystal element 1-32 (equivalent electrical capacitance) of the sub-pixel 132, the same as the sub-pixel 112. For this reason, the sub-pixel 131 is displayed dark, and the sub-pixel 132 is displayed bright.

Next, the operation of the sub-pixel 121 and the sub-pixel 122 of the pixel 102 will be described. During the time period t0a to t1a, the switching elements 2-21 and 2-22 are turned on. For this reason, the potential difference between −4 V on the display signal line 3-2 and +1 V on the reference potential trunk line 4-1, this being −5 V, is generated at the liquid crystal element 1-21 (equivalent electrical capacitance). Also, the potential difference between −4 V on the display signal line 3-2 and 0 V on the reference potential trunk line 4-2, this being −4 V, is generated at the liquid crystal element 1-22 (equivalent electrical capacitance). As a result, in the luminance of the sub-pixels 121 to 122, the sub-pixel 122 is displayed dark, and the sub-pixel 121 is displayed bright.

Next, the operation of the sub-pixel 141 and the sub-pixel 142 of the pixel 104 will be described. During the time period t1a to t2a, the switching elements 2-41 and 2-42 are turned on. For this reason, the potential difference between +4 V on the display signal line 3-1 and 0 V on the reference potential trunk line 4-2, this being +4 V, is generated at the liquid crystal element 1-41 (equivalent electrical capacitance). Also, the potential difference between +4 V on the display signal line 3-1 and +1 V on the reference potential trunk line 4-1, this being +3 V, is generated at the liquid crystal element 1-42 (equivalent electrical capacitance). As a result, in the luminance of the sub-pixels 141 to 142, the sub-pixel 142 is displayed dark, and the sub-pixel 141 is displayed bright.

During the time period t1a to t2a, the potential difference of +4 V is generated at the liquid crystal element 1-61 (equivalent electrical capacitance) of the sub-pixel 161 of the pixel 106. Also, the potential difference of +3 V is generated at the liquid crystal element 1-62 (equivalent electrical capacitance) of the sub-pixel 162. As a result, the sub-pixel 162 is displayed dark, and the sub-pixel 161 is displayed bright.

Next, the operation of the sub-pixel 151 and the sub-pixel 152 of the pixel 105 will be described. During the time period t1a to t2a, the switching elements 2-51 and 2-52 are turned on. For this reason, the potential difference between −3 V on the display signal line 3-2 and 0 V on the reference potential trunk line 4-2, this being −3 V, is generated at the liquid crystal element 1-51 (equivalent electrical capacitance). Also, the potential difference between −3 V on the display signal line 3-2 and +1 V on the reference potential trunk line 4-1, this being −4 V, is generated at the liquid crystal element 1-52 (equivalent electrical capacitance). As a result, in the luminance of the sub-pixels 151 to 152, the sub-pixel 151 is displayed dark, and the sub-pixel 152 is displayed bright.

Next, the operation at the (L+1) th frame will be described, using FIG. 4 and FIG. 5. FIG. 5 shows the timing diagram of the (L+1) th frame after the time t0b. During the vertical return interval, the controller 12 switches the polarity of the potentials on the display signal lines 3-1 to 3-3 to the polarity that is the reverse of the polarity in the Lth frame.

The controller 12 switches the potential on the reference potential trunk line 4-1 from +1 V to 0 V, and switches the potential on the reference potential trunk line 4-2 from 0 V to +1 V (waveforms 3 and 4 in FIG. 5, at time t0b). That is, the controller 12 switches the magnitude of the potentials from the relationship in which the potential on the reference potential trunk line 4-1 is larger than that of the reference potential trunk line 4-2 to the relationship in which the potential on the reference potential trunk line 4-2 is larger than that of the reference potential trunk line 4-1. This control also means switching the potential on the reference potential trunk lines 4-1 to 4-2 for each frame, and alternating both potentials for each frame. The switching of the potential on the reference potential trunk line 4-2 to the inverse phase with respect to the reference potential trunk line 4-1 means alternately exchanging the potentials for each frame such that, at the time of Lth frame, the potential on the reference potential trunk line 4-1 is +1 V and, the potential on the reference potential trunk line 4-2 is 0 V, and at the time of (L+1) th frame, the potential on the reference potential trunk line 4-1 is 0 V and, the potential on the reference potential trunk line 4-2 is +1 V.

Next, the controller 12 controls the scanning line 5-1 to the high level between times t0b to t1b, thus placing the switching elements 2-11 to 2-12, 2-21 to 2-22, and 2-31 to 2-32 into the on state. For this reason, the controller 12 supplies a signal of −4 V to the pixel 101 in the first row from the display signal line 3-1, and supplies a signal of +5 V to the pixel 102 in the first row from the display signal line 3-2. Additionally, the controller 12 controls the scanning line 5-2 to the high level between times t1b to t2b, thus placing the switching elements 2-41 to 2-42, 2-51 to 2-52, and 2-61 to 2-62 into the on state. For this reason, the controller 12 supplies a signal of −3 V to the pixel 104 in the second row from the display line 3-1, and supplies a signal of +4 V to the pixel 105 in the second row from the display signal line 3-2. The switching of each switching element to the on state and potential difference generated in each liquid crystal element will be described below.

Next, the operation of the sub-pixel 111 and the sub-pixel 112 of the pixel 101 will be described. During the time period Ma to t1a, the potential difference between −4 V on the display signal line 3-1 and 0 V on the reference potential trunk line 4-1, this being −4 V, is generated at the liquid crystal element 1-11. Also, the potential difference between −4 V on the display signal line 3-1 and +1 V on the reference potential trunk line 4-2, this being −5 V, is generated at the liquid crystal element 1-12. As a result, in the luminance of the sub-pixels 111 to 112, the sub-pixel 111 is displayed dark, and the sub-pixel 112 is displayed bright.

The controller 12 supplies to the display signal line 3-3 a display signal having the same polarity as the display signal line 3-1. For this reason, during the time period t0b to t1b, a potential difference of −4 V is generated at the liquid crystal element 1-31 of the sub-pixel 131 of the pixel 103, and a potential difference of −5 V is generated at the liquid crystal element 1-32 of the sub-pixel 132. For this reason, the sub-pixel 131 is displayed dark, and the sub-pixel 132 is displayed bright.

Next, the operation of the sub-pixel 121 and the sub-pixel 122 of the pixel 102 will be described. During the time period t0b to t1b, the potential difference between +5 V on the display signal line 3-2 and 0 V on the reference potential trunk line 4-1, this being +5 V, is generated at the liquid crystal element 1-21. Also, the potential difference between +5 V on the display signal line 3-2 and +1 V on the reference potential trunk line 4-2, this being +4 V, is generated at the liquid crystal element 1-22. As a result, in the luminance of the sub-pixels 121 to 122, the sub-pixel 122 is displayed dark, and the sub-pixel 121 is displayed bright.

Next, the operation of the sub-pixel 141 and the sub-pixel 142 of the pixel 104 will be described. During the time period t1b to t2b, the potential difference between −3 V on the display signal line 3-1 and +1 V on the reference potential trunk line 4-2, this being −4 V, is generated at the liquid crystal element 1-41. Also, the potential difference between −3 V on the display signal line 3-1 and 0 V on the reference potential trunk line 4-1, this being −3 V, is generated at the liquid crystal element 1-42. As a result, in the luminance of the sub-pixels 141 to 142, the sub-pixel 142 is displayed dark, and the sub-pixel 141 is displayed bright.

During the time period t1b to t2b, a potential difference of −4 V is generated at the liquid crystal element 1-62 of the sub-pixel 162 of the pixel 106, and the potential difference of −3 V is generated at the liquid crystal element 1-61 of the sub-pixel 161. As a result, the sub-pixel 162 is displayed dark, and the sub-pixel 161 is displayed bright.

Next, the operation of the sub-pixel 151 and the sub-pixel 152 of the pixel 105 will be described. During the time period t1b to t2b, the potential difference between +4 V on the display signal line 3-2 and +1 V on the reference potential trunk line 4-2, this being +3 V, is generated at the liquid crystal element 1-51. Also, the potential difference between +4 V on the display signal line 3-2 and 0 V on the reference potential trunk line 4-1, this being +4 V, is generated at the liquid crystal element 1-52. As a result, in the luminance of the sub-pixels 151 to 152, the sub-pixel 151 is displayed dark, and the sub-pixel 152 is displayed bright.

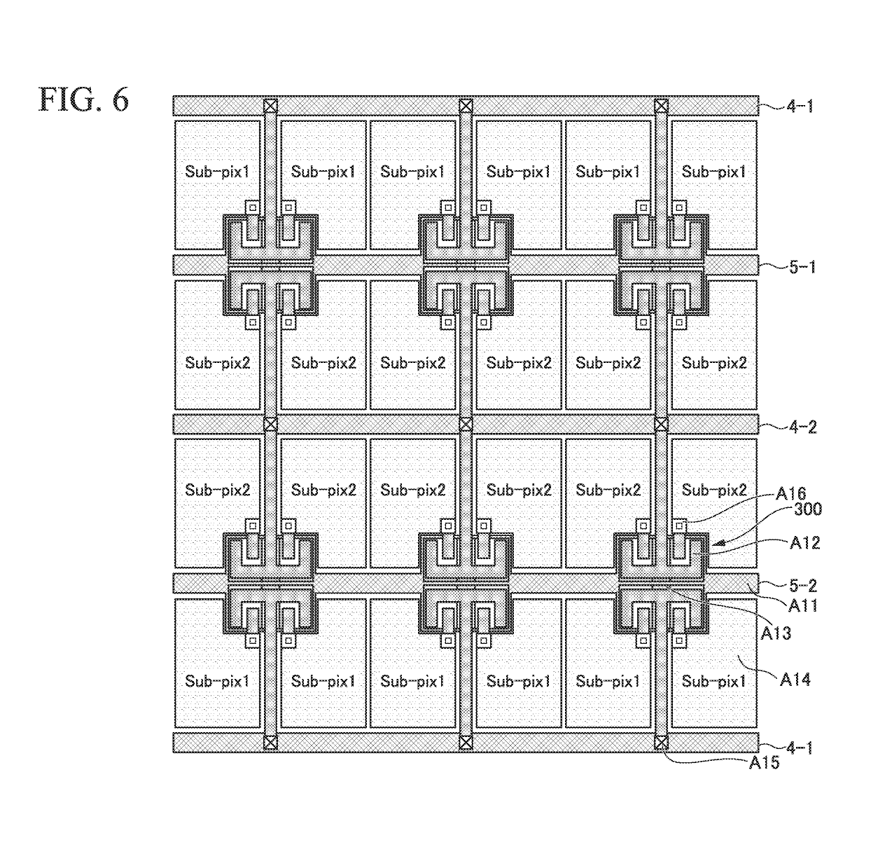

FIG. 6 is a drawing describing a layout example on a first substrate 10 to which the first embodiment is applied. In a TFT part 300 as shown in FIG. 6, regions with the same hatching as shown in a region A11 indicate first electrodes (gate electrodes). Regions with the same hatching as shown in a region A12 indicate second electrodes (source electrodes, drain electrodes). Regions with the same hatching as shown in a region A13 indicate semiconductor layers (silicon layers). Regions with the same hatching as shown in a region A14 indicate third electrodes (pixel electrodes). The part shown as the region A15 indicates a contact between the first electrode and the second electrode. The part shown as the region A16 indicates a contact between a second electrode and a third electrode.

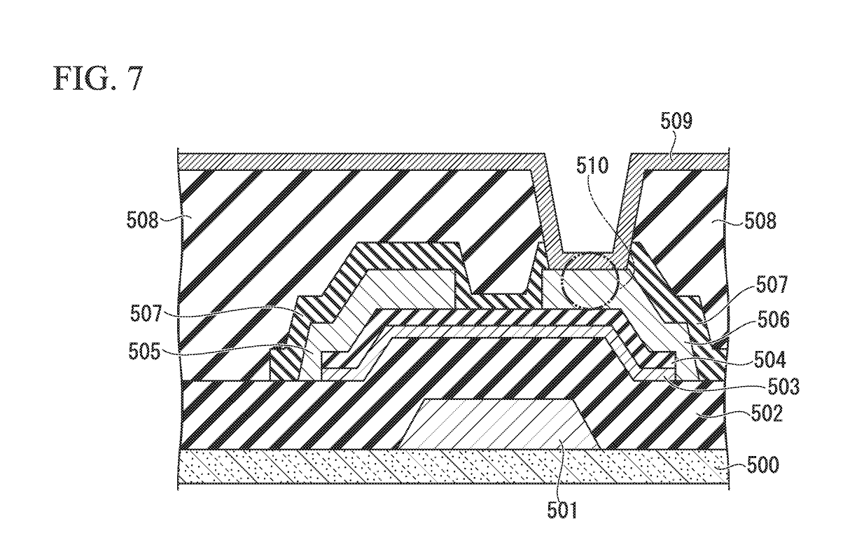

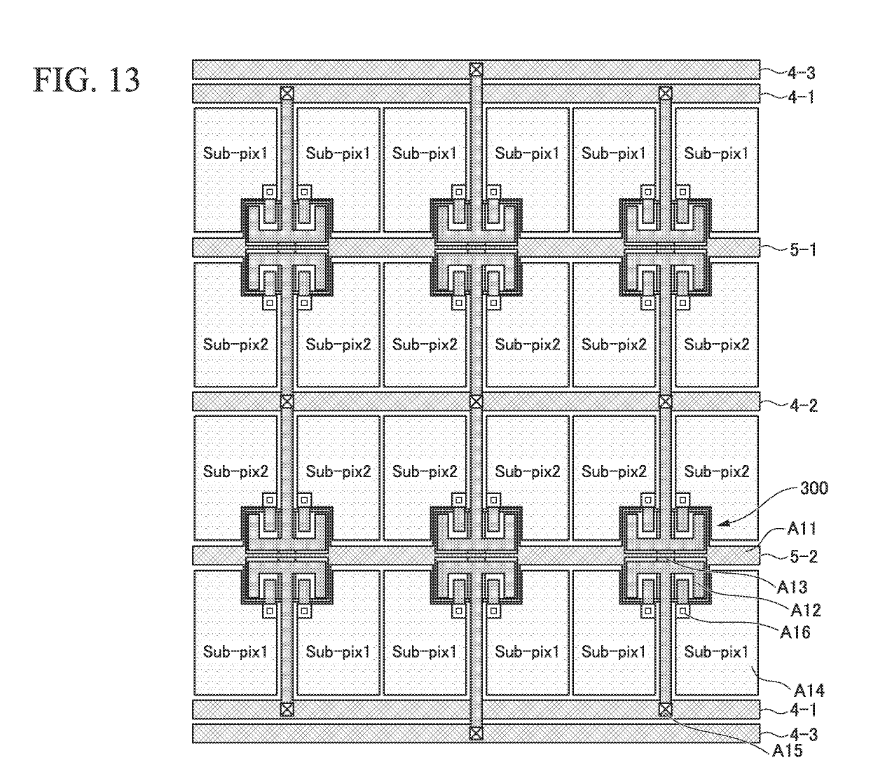

As an example of TFTs illustrated in FIG. 6 and FIG. 13 and described later, a cross-sectional view of an amorphous silicon TFT currently used in general liquid crystal televisions is shown in FIG. 7. This TFT has constitution in which a glass substrate 500, a gate electrode 501, a gate insulating film 502, an amorphous silicon layer 503 (region A13 in FIG. 6 and FIG. 13), an n⁺ amorphous silicon layer 504, a source electrode 505 (region A12 in FIG. 6 and FIG. 13) a drain electrode 506 (region A13 in FIG. 6 and FIG. 13), a protective film 507, a planarization film 508, and a pixel electrode 509 (region A14 in FIG. 6 and FIG. 13) are sequentially laminated. In FIG. 7, the pixel electrode 509 and the drain electrode 506 are electrically connected in a contact region 510 (region A16 in FIG. 6 and FIG. 13).

A flexible substrate such as a stainless substrate may be used as the glass substrate 500. A transparent amorphous oxide semiconductor, typically such as polysilicon, a microcrystal silicon, or IGZO (indium zinc complex oxide) may be used as the amorphous silicon layer 503. In the case in which a transparent amorphous oxide semiconductor is used as the amorphous silicon layer 503, however, there may be no n⁺ amorphous silicon layer.

In FIG. 6, the transparent electrode 13, to which the display signal lines 3-1 to 3-3 are connected, is above the opposing second substrate 20. For this reason, the reference potential trunk lines 4-1 to 4-3, the scanning lines 5-1 to 5-2, the switching elements 2, and the display electrodes 11 are formed over the first substrate 10.

In FIG. 6, each pixel has Sub-pix1 and Sub-pix2. In each sub-pixel, the gate terminal of each switching element 2 is connected to the scanning line 5-1 or 5-2. The source terminal of the switching element 2 of the sub-pixel Sub-pix1 is connected to the reference potential trunk line 4-1. The drain terminal of the switching element 2 of the sub-pixel Sub-pix1 is connected to one end of the liquid crystal element 1 via the display electrode 11. The other end of the liquid crystal element 1 is connected to a display signal line 3, via the transparent electrode 13. The source terminal of the switching element 2 of the sub-pixel Sub-pix2 is connected to the reference potential trunk line 4-2. The drain terminal of the switching element 2 of the sub-pixel Sub-pix2 is connected to one end of the liquid crystal element 1, via the display electrode 11. The other end of the liquid crystal element 1 is connected to the display signal line 3, via the transparent electrode 13.

In the present embodiment, although an example such as switching the potential on the reference potential trunk lines 4-1 to 4-3 for each frame has been described, the switching may be done for each pixel selection period. The pixel selection period is, for example, in the case of a display device driven by 60-Hz with a Full HD resolution (having 1080 scanning lines), every 1/60/1080 s. Additionally, if the pixel selection period is defined as 1H, the potential may be switched every 2 kH (where k is an integer of one or larger).

As described above, it is possible to cause generation of different potential differences between equivalent electrical capacitances of each of the liquid crystal elements of the two sub-pixels of each pixel, thereby obtaining a liquid crystal display device having a multipixel opposing matrix constitution. Also, because there is need to change the potential on each of the reference potential trunk lines 4-1 to 4-2 only one time for one frame, a display device having low electrical power consumption can be achieved.

### Second Embodiment

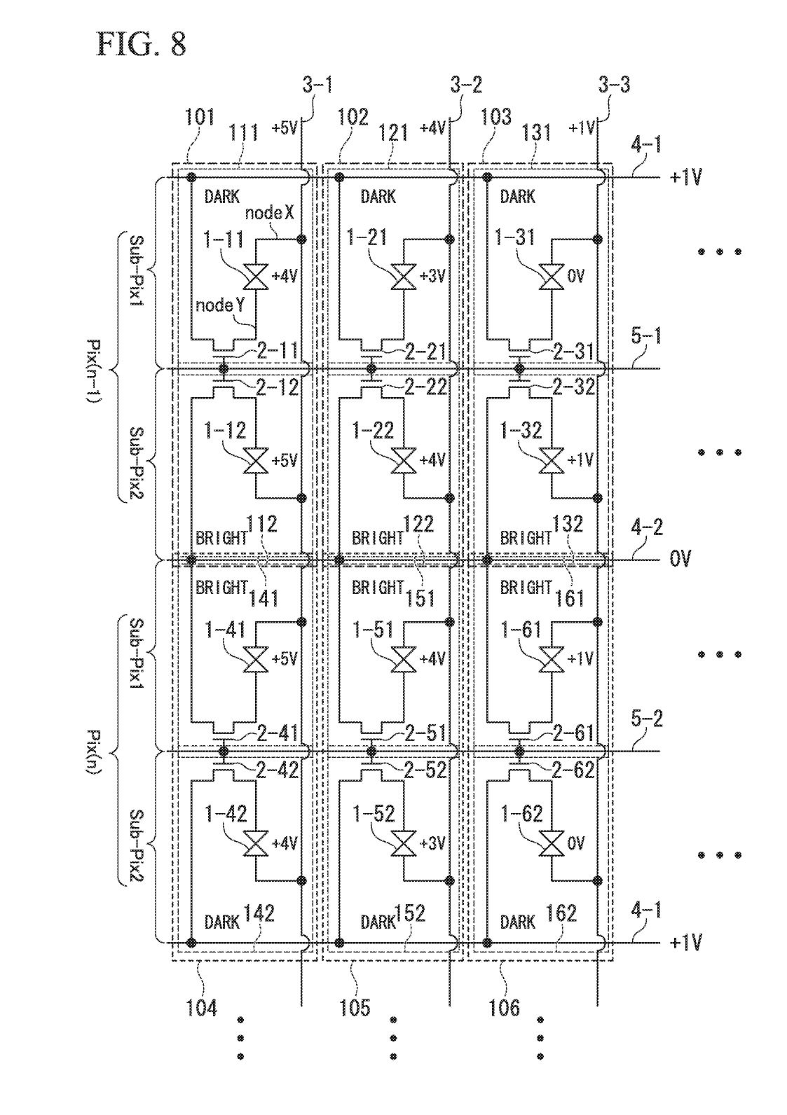

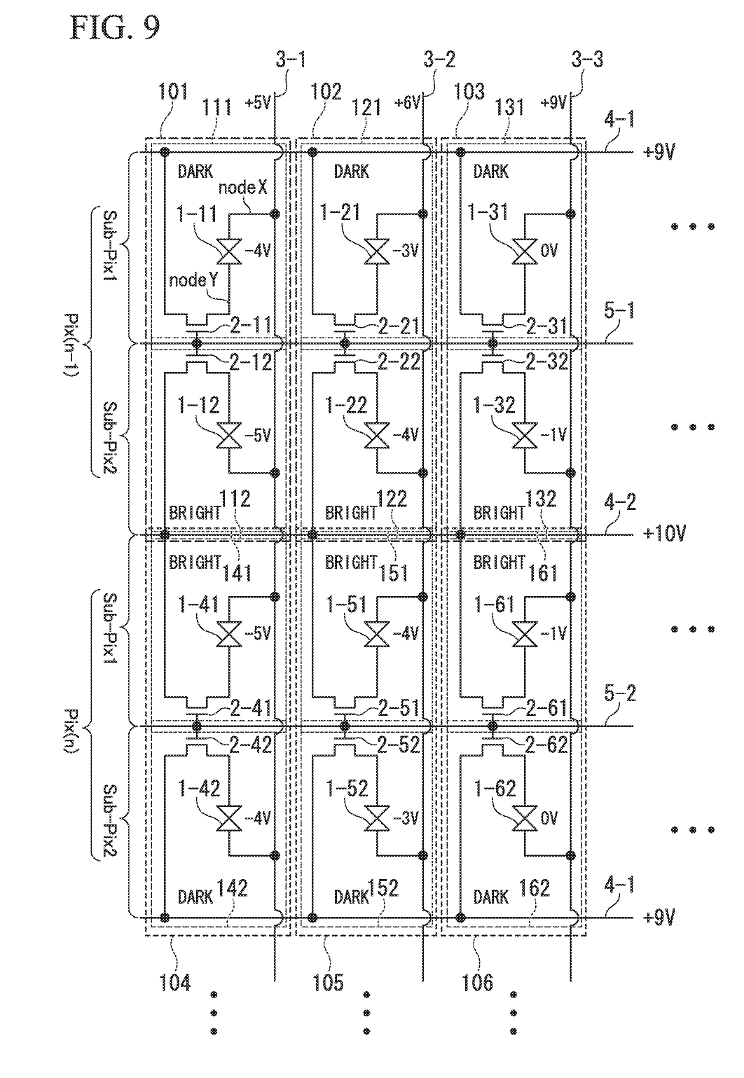

The second embodiment is another embodiment of a liquid crystal display device that is constituted so that one pixel is made up of two sub-pixels. FIG. 8 is an equivalent circuit describing the operation at the Lth frame of the liquid crystal display device of the second embodiment having pixels (Pix(n−1), Pix(n)) that have two sub-pixels (Sub-Pix1, Sub-Pix2). FIG. 9 is an equivalent circuit describing the operation at the (L+1) th frame of the liquid crystal display device of the second embodiment having pixels (Pix(n−1), Pix(n)) that have two sub-pixels (Sub-Pix1, Sub-Pix2). The circuit constitution is the same as the first embodiment, as shown in FIG. 8.

The operation at the Lth frame (where L is a natural number 1 or larger) of each sub-pixel of the pixels 101 to 106 will be described using FIG. 8. The controller 12 controls the reference potential trunk line 4-1 to +1 V, and controls the reference potential trunk line 4-2 to 0 V. Next, the controller 12 controls the scanning line 5-1 to the high level, thus placing the switching elements 2-11 to 2-12, 2-21 to 2-22, and 2-31 to 2-32 into the on state. The controller 12 supplies a signal of +5 V (maximum tone) to the pixel 101 in the first row from the display signal line 3-1, supplies a signal of +4 V (half-tone) to the pixel 102 in the first row from the display signal line 3-2, and supplies a signal of +1 V (minimum-tone) to the pixel 103 in the first row from the display signal line 3-3. That is, with +5 V, which is the signal potential that displays maximum tone as the center, a potential of +1 V to +5V is allocated on the positive polarity side, and +5 V to +9 V is allocated on the negative polarity side. Additionally, ±4 V of voltage amplitude about the center of +5 V is added to the reference potential trunk line 4-1, and ±5 V of voltage amplitude about the center of +5 V is added to the reference potential trunk line 4-2.

Also, the controller 12 controls the scanning line 5-2 to the high level, thus placing the switching elements 2-41 to 2-42, 2-51 to 2-52, and 2-61 to 2-62 into the on state. The controller 12 supplies a signal of +5 V (maximum tone) to the pixel 104 in the second row from the display signal line 3-1, supplies a signal of +4 V (half tone) to the pixel 105 in the second row from the display signal line 3-2, and supplies a signal of +1 V (minimum tone) to the pixel 106 in the second row from the display signal line 3-3. The signal levels on the display signal lines 3-1 to 3-3 shown in FIG. 8 are signal levels showing one example of operation. The switching of each switching element to the on state and potential difference generated in each liquid crystal element will be described below.

The operation of the sub-pixel 111 and the sub-pixel 112 of the pixel 101 will be described. During the time period in which the switching element 2-11 is in the on state, the potential difference between +5 V on the display signal line 3-1 and +1 V on the reference potential trunk line 4-1, this being +4 V, is generated at the liquid crystal element 1-11. Also, during the time period in which the switching element 2-12 is in the on state, the potential difference between +5 V on the display signal line 3-1 and +0 V on the reference potential trunk line 4-2, this being +5 V, is generated at the liquid crystal element 1-12. As a result, in the luminance of the sub-pixels 111 to 112, the sub-pixel 111 is displayed dark, and the sub-pixel 112 is displayed bright.

Next, the operation of the sub-pixel 121 and the sub-pixel 122 of the pixel 102 will be described. During the time period in which the switching element 2-21 is in the on state, the potential difference between +4 V on the display signal line 3-2 and +1 V on the reference potential trunk line 4-1, this being +3 V, is generated at the liquid crystal element 1-21. Also, during the time period in which the switching element 2-22 is in the on state, the potential difference between +4 V on the display signal line 3-2 and 0 V on the reference potential trunk line 4-2, this being +4 V, is generated at the liquid crystal element 1-22. As a result, in the luminance of the sub-pixels 121 to 122, the sub-pixel 121 is displayed dark, and the sub-pixel 122 is displayed bright.

Next, the operation of the sub-pixel 131 and the sub-pixel 132 of the pixel 103 will be described. During the time period in which the switching element 2-31 is in the on state, the potential difference between +1 V on the display signal line 3-3 and +1 V on the reference potential trunk line 4-1, this being 0 V, is generated at the liquid crystal element 1-31. Also, during the time period in which the switching element 2-32 is in the on state, the potential difference between +1 V on the display signal line 3-3 and 0 V on the reference potential trunk line 4-2, this being +1 V, is generated at the liquid crystal element 1-32. As a result, in the luminance of the sub-pixels 131 to 132, the sub-pixel 131 is displayed dark, and the sub-pixel 132 is displayed bright.

Next, the operation of the sub-pixel 141 and the sub-pixel 142 of the pixel 104 will be described. During the time period in which the switching element 2-41 is in the on state, the potential difference between +5 V on the display signal line 3-1 and 0 V on the reference potential trunk line 4-2, this being +5 V, is generated at the liquid crystal element 1-41. Also, during the time period in which the switching element 2-42 is in the on state, the potential difference between +5 V on the display signal line 3-1 and +1 V on the reference potential trunk line 4-1, this being +4 V, is generated at the liquid crystal element 1-42. As a result, in the luminance of the sub-pixels 141 to 142, the sub-pixel 142 is displayed dark, and the sub-pixel 141 is displayed bright.

Next, the operation of the sub-pixel 151 and the sub-pixel 152 of the pixel 105 will be described. During the time period in which the switching element 2-51 is in the on state, the potential difference between +4 V on the display signal line 3-2 and 0 V on the reference potential trunk line 4-2, this being +4 V, is generated at the liquid crystal element 1-51. Also, during the time period in which the switching element 2-52 is in the on state, the potential difference between +4 V on the display signal line 3-2 and +1 V on the reference potential trunk line 4-1, this being +3 V, is generated at the liquid crystal element 1-52. As a result, in the luminance of the sub-pixels 151 to 152, the sub-pixel 152 is displayed dark, and the sub-pixel 151 is displayed bright.

Next, the operation of the sub-pixel 161 and the sub-pixel 162 of the pixel 106 will be described. During the time period in which the switching element 2-61 is in the on state, the potential difference between +1 V on the display signal line 3-3 and 0 V on the reference potential trunk line 4-2, this being +1 V, is generated at the liquid crystal element 1-61. Also, during the time period in which the switching element 2-62 is in the on state, the potential difference between +1 V on the display signal line 3-3 and +1 V on the reference potential trunk line 4-1, this being 0 V, is generated at the liquid crystal element 1-62. As a result, in the luminance of the sub-pixels 161 to 162, the sub-pixel 162 is displayed dark, and the sub-pixel 161 is displayed bright.

Next, the operation at the (L+1) th frame will be described, using FIG. 9. The controller 12 switches the reference potential trunk line 4-1 from +1 V to +9 V, switches the reference potential trunk line 4-2 from 0 V to +10 V, and switches the reference potential trunk line 4-3 from +1 V to +9 V. Next, the controller 12 controls the scanning line 5-1 to the high level, thus placing the switching elements 2-11 to 2-12, 2-21 to 2-22, and 2-31 to 2-32 into the on state. The controller 12 supplies a signal of +5 V (maximum tone) to the pixel 101 in the first row from the display signal line 3-1, supplies a signal of +6 V (half-tone) to the pixel 102 in the first row from the display signal line 3-2, and supplies a signal of +9 V (minimum tone) to the pixel 103 in the first row from the display signal line 3-3. Additionally, the controller 12 controls the scanning line 5-2 to the high level, thus placing the switching elements 2-41 to 2-42, 2-51 to 2-52, and 2-61 to 2-62 into the on state. Additionally, the controller 12 supplies a signal of +5 V (maximum tone) to the pixel 104 in the second row from the display signal line 3-1, supplies a signal of +6 V (half tone) to the pixel 104 in the second row from the display signal line 3-2, and supplies a signal of +9 V (minimum-tone) to the pixel 106 in the second row from the display signal line 3-3. The switching of each switching element to the on state and potential difference generated in each liquid crystal element will be described below.

The operation of the sub-pixel 111 and the sub-pixel 112 of the pixel 101 will be described. During the time period in which the switching element 2-11 is in the on state, the potential difference between +5 V on the display signal line 3-1 and +9 V on the reference potential trunk line 4-1, this being −4 V, is generated at the liquid crystal element 1-11. Also, during the time period in which the switching element 2-12 is in the on state, the potential difference between +5 V on the display signal line 3-1 and +10 V on the reference potential trunk line 4-2, this being −5 V, is generated at the liquid crystal element 1-12. As a result, in the luminance of the sub-pixels 111 to 112, the sub-pixel 111 is displayed dark, and the sub-pixel 112 is displayed bright.

Next, the operation of the sub-pixel 121 and the sub-pixel 122 of the pixel 102 will be described. During the time period in which the switching element 2-21 is in the on state, the potential difference between +6 V on the display signal line 3-2 and +9 V on the reference potential trunk line 4-1, this being −3 V, is generated at the liquid crystal element 1-21. Also, during the time period in which the switching element 2-22 is in the on state, the potential difference between +6 V on the display signal line 3-2 and 10 V on the reference potential trunk line 4-2, this being −4 V, is generated at the liquid crystal element 1-22. As a result, in the luminance of the sub-pixels 121 to 122, the sub-pixel 121 is displayed dark, and the sub-pixel 122 is displayed bright.

Next, the operation of the sub-pixel 131 and the sub-pixel 132 of the pixel 103 will be described. During the time period in which the switching element 2-31 is in the on state, the potential difference between +9 V on the display signal line 3-3 and +9 V on the reference potential trunk line 4-1, this being 0 V, is generated at the liquid crystal element 1-31. Also, during the time period in which the switching element 2-32 is in the on state, the potential difference between +9 V on the display signal line 3-3 and 10 V on the reference potential trunk line 4-2, this being −1 V, is generated at the liquid crystal element 1-32. As a result, in the luminance of the sub-pixels 131 to 132, the sub-pixel 131 is displayed dark, and the sub-pixel 132 is displayed bright.

Next, the operation of the sub-pixel 141 and the sub-pixel 142 of the pixel 104 will be described. During the time period in which the switching element 2-41 is in the on state, the potential difference between +5 V on the display signal line 3-1 and +10 V on the reference potential trunk line 4-2, this being −5 V, is generated at the liquid crystal element 1-41. Also, during the time period in which the switching element 2-42 is in the on state, the potential difference between +5 V on the display signal line 3-1 and +9 V on the reference potential trunk line 4-1, this being −4 V, is generated at the liquid crystal element 1-42. As a result, in the luminance of the sub-pixels 141 to 142, the sub-pixel 142 is displayed dark, and the sub-pixel 141 is displayed bright.

Next, the operation of the sub-pixel 151 and the sub-pixel 152 of the pixel 105 will be described. During the time period in which the switching element 2-51 is in the on state, the potential difference between +6 V on the display signal line 3-2 and +10 V on the reference potential trunk line 4-2, this being −4 V, is generated at the liquid crystal element 1-51. Also, during the time period in which the switching element 2-52 is in the on state, the potential difference between +6 V on the display signal line 3-2 and +9 V on the reference potential trunk line 4-1, this being −3 V, is generated at the liquid crystal element 1-52. As a result, in the luminance of the sub-pixels 151 to 152, the sub-pixel 152 is displayed dark, and the sub-pixel 151 is displayed bright.

Next, the operation of the sub-pixel 161 and the sub-pixel 162 of the pixel 106 will be described. During the time period in which the switching element 2-61 is in the on state, the potential difference between +9 V on the display signal line 3-3 and +10 V on the reference potential trunk line 4-2, this being −1 V, is generated at the liquid crystal element 1-61. Also, during the time period in which the switching element 2-62 is in the on state, the potential difference between +9 V on the display signal line 3-3 and +9 V on the reference potential trunk line 4-1, this being 0 V, is generated at the liquid crystal element 1-62. As a result, in the luminance of the sub-pixels 161 to 162, the sub-pixel 162 is displayed dark, and the sub-pixel 161 is displayed bright.

In the present embodiment, although the example such as switching the potential on the reference potential trunk lines 4-1 to 4-3 for each frame have been described, the switching may be done for each pixel selection period. The pixel selection period is, for example, in the case of a display device driven by 60-Hz with a Full HD resolution (having 1080 scanning lines), every 1/60/1080 s. Additionally, if the pixel selection period is defined as 1H, the potential may be switched every 2 kH (where k is an integer of one or larger).

As described above, it is possible to cause generation of different potential differences between equivalent electrical capacitances of each of the liquid crystal elements of the two sub-pixels of one pixel, thereby obtaining a liquid crystal display device having a multipixel opposing matrix constitution. Also, according to the second embodiment, as shown in FIG. 8 and FIG. 9, the sequences in the row directions of bright pixels (of two sub-pixels, the one having a larger absolute value of the potential differences applied to both ends of the liquid crystal element) and of dark pixels (of two sub-pixels, the one having a smaller absolute value of the potential differences applied to both ends of the liquid crystal element) can be disposed in parallel with respect to the scanning line 5-1. For this reason, in addition to the effect of the first embodiment, the display characteristics can be improved.

### Third Embodiment

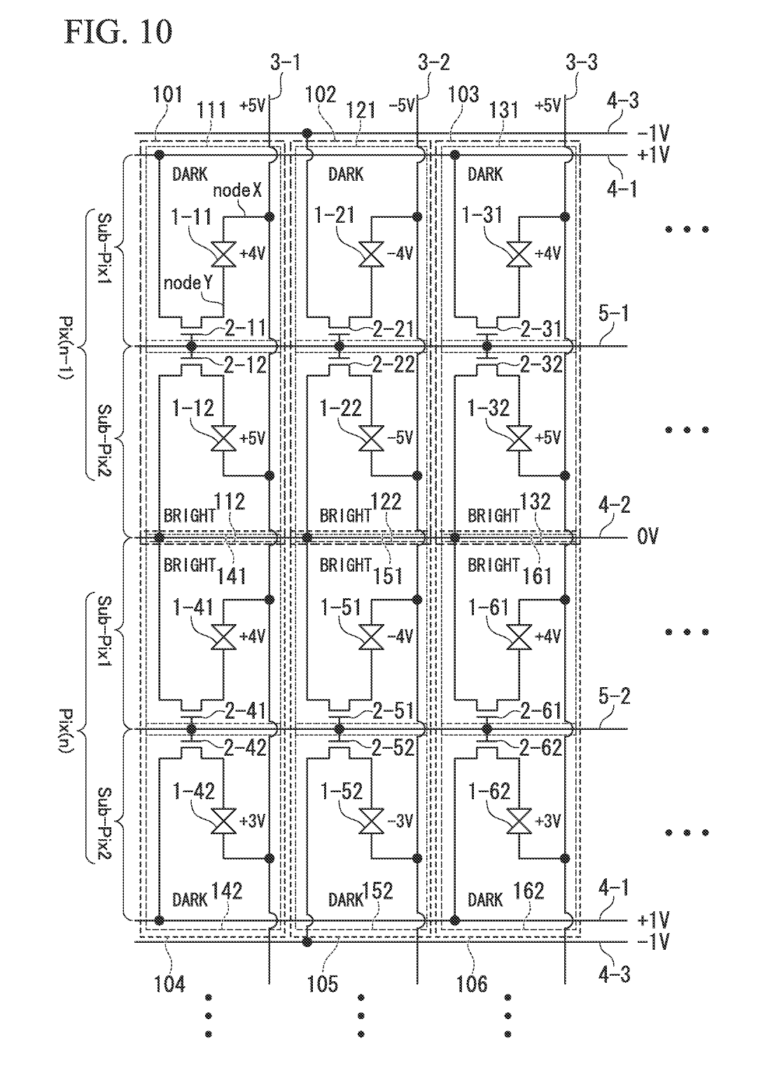

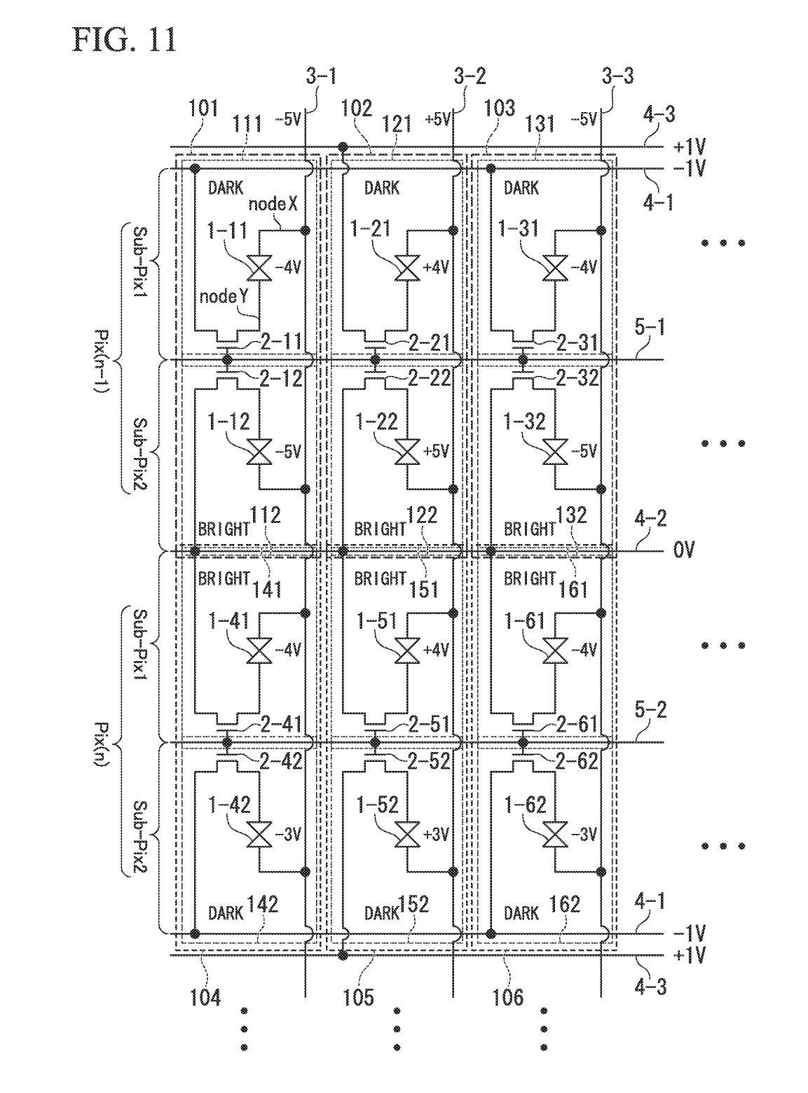

The third embodiment is another embodiment of a liquid crystal display device, which is constituted so that one pixel is made up of two sub-pixels. FIG. 10 is an equivalent circuit describing the operation at the Lth frame of the liquid crystal display device of the third embodiment having pixels (Pix(n−1), Pix(n)) that have two sub-pixels (Sub-Pix1, Sub-Pix2). FIG. 11 is an equivalent circuit describing the operation at the (L+1) th frame of the liquid crystal display device of the third embodiment having pixels (Pix(n−1), Pix(n)) that have two sub-pixels (Sub-Pix1, Sub-Pix2). As shown in FIG. 10, the liquid crystal display device in the third embodiment has pixels 101 to 106. Each of the pixels 101 to 106 further has two sub-pixels. The pixels 101 and 102 are disposed so as to be adjacent in the row direction. The pixel 101 has, with respect to the column direction from the reference potential trunk line 4-1, the sub-pixel 111 and the sub-pixel 112, disposed in that sequence. The pixel 102 has, with respect to the column direction from the reference potential trunk line (first reference potential trunk line) 4-1, the sub-pixel 121 and the sub-pixel 122, disposed in that sequence. The pixels 104 and 105, which are disposed so as to be adjacent in the row direction, are disposed in linear symmetry with the pixel 101 and the pixel 102, with respect to the reference potential trunk line (second reference potential trunk line) 4-2.

The pixel 104 has, with respect to the column direction from the reference potential trunk line 4-1, the sub-pixel 142 and the sub-pixel 141, disposed in that sequence. The pixel 105 has, with respect to the column direction from the reference potential trunk line 4-1, the sub-pixel 152 and the sub-pixel 151, disposed in that sequence. The pixel 103 and the pixel 106 have the same constitution as noted above.

The constitutions of the sub-pixel 111 and the sub-pixel 112 of the pixel 101 are the same as in the first embodiment.

Next, the constitution of the sub-pixels 121 and 122 of the pixel 102 will be described. The gate terminals of the switching element 2-21 and the switching element 2-22 are connected to the common scanning line 5-1. The source terminal of the switching element 2-21 is connected to the reference potential trunk line (first reference potential trunk line) 4-3. The drain terminal of the switching element 2-21 is connected to one end of the liquid crystal element 1-21, via the display electrode 11. The other end of the liquid crystal element 1-21 is connected to the display signal line (second display signal line) 3-2, via the transparent electrode 13. The source terminal of the switching element 2-22 is connected to the reference potential trunk line 4-2. The drain terminal of the switching element 2-22 is connected to one end of the liquid crystal element 1-22, via the display electrode 11. The other end of the liquid crystal element 1-22 is connected to the display signal line 3-2, via the transparent electrode 13.

The constitutions of the sub-pixel 141 and the sub-pixel 142 of the pixel 104 are the same as in the first embodiment.

Next, the constitution of the sub-pixels 151 and 152 of the pixel 105 will be described. The gate terminals of the switching element 2-51 and the switching element 2-52 are connected to the common scanning line 5-2. The source terminal of the switching element 2-52 is connected to the reference potential trunk line 4-3. The drain terminal of the switching element 2-52 is connected to one end of the liquid crystal element 1-52, via the display electrode 11. The other end of the liquid crystal element 1-52 is connected to the display signal line 3-2, via the transparent electrode 13. The source terminal of the switching element 2-51 is connected to the reference potential trunk line 4-2. The drain terminal of the switching element 2-51 is connected to one end of the liquid crystal element 1-51, via the display electrode 11. The other end of the liquid crystal element 1-51 is connected to the display signal line 3-2, via the transparent electrode 13. The constitutions of the pixel 103 and the pixel 106 are the same as the above.

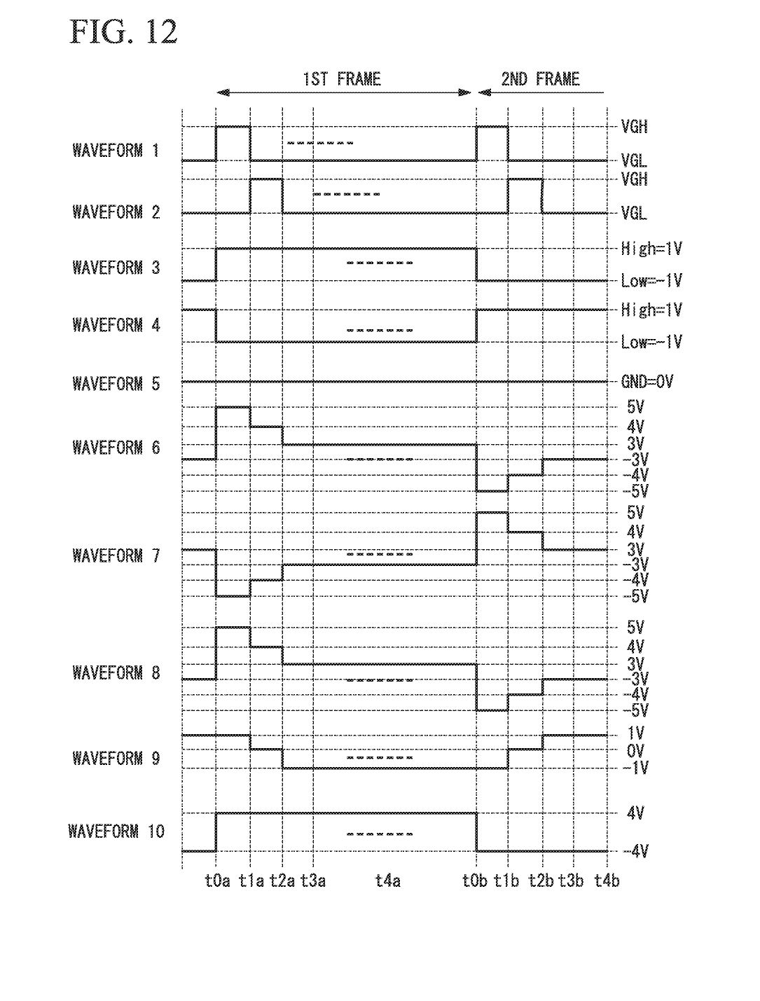

Next, the operation of the liquid crystal display device will be described, using FIG. 10 and FIG. 12. FIG. 12 is a timing diagram of the liquid crystal display device of the third embodiment at the Lth frame and at the (L+1) th frame. The operation of each sub-pixel of the pixels 101 to 106 at the Lth frame (where L is a natural number 1 or larger) will be described.

In FIG. 12, the horizontal axis represents time, and the vertical axis represents electrical potential. The waveform 1 in FIG. 12 shows the time variations of the potential on the scanning line 5-1. The waveform 2 in FIG. 12 shows the time variations of the potential on the scanning line 5-2. The waveform 3 in FIG. 12 shows the time variations of the potential on the reference potential trunk line 4-1. The waveform 4 in FIG. 12 shows the time variations of the potential on the reference potential trunk line 4-2. The waveform 5 in FIG. 12 shows the time variations of the potential on the reference potential trunk line 4-3. The waveform 6 in FIG. 12 shows the time variations of the potential on the display signal line 3-1. The waveform 7 in FIG. 12 shows the time variations of the potential on the display signal line 3-2. The waveform 8 in FIG. 12 shows the time variations of the potential on the node X. The waveform 9 in FIG. 12 shows the time variations of the potential on the node Y. The waveform 10 in FIG. 12 shows the time variations of the potential between the node X and the node Y (voltage applied to Sub-pix1).

The controller 12 controls the reference potential trunk line 4-1 to +1 V, controls the potential on the reference potential trunk line 4-2 to 0 V, and controls the potential on the reference potential trunk line 4-3 to −1 V (waveforms 3 to 5 in FIG. 12 at time t0a). That is, the controller 12 controls the magnitude of the potential to the relationship in which the potential on the reference potential trunk line 4-1 is larger than that on the reference potential trunk line 4-2 and the potential on the reference potential trunk line 4-2 is larger than that on the reference potential trunk line 4-3.

Next, the controller 12 controls the scanning line 5-1 to the high level between times t0a to t1a, thus placing the switching elements 2-11 to 2-12, 2-21 to 2-22, and 2-31 to 2-32 into the on state. For this reason, the controller 12 supplies a signal of +5 V to the pixel 101 in the first row from the display signal line 3-1, and supplies a signal of −5 V to the pixel 102 in the first row from the display signal line 3-2. The range of the signal on each display signal line 3-1 to 3-3 is, for example, +5 V to +1 V on the positive polarity side and −5 V to −1 V on the negative polarity side. Additionally, the controller 12 controls the scanning line 5-2 to the high level between times t1b to t2b, thus placing the switching elements 2-41 to 2-42, 2-51 to 2-52, and 2-61 to 2-62 into the on state. For this reason, the controller 12 supplies from the display signal line 3-1a signal of +4 V to the pixel 104 in the second row, and supplies from the display signal line 3-2a signal of −4 V to the pixel 105 in the second row. The signal levels on the display signal lines 3-1 and 3-2 shown in FIG. 12 show one example of operation. The switching of each switching element to the on state and potential difference generated in each liquid crystal element will be described below.

The operation of the sub-pixel 111 and the sub-pixel 112 of the pixel 101 is the same as in the first embodiment at the Lth frame. For this reason, during the time period t0a to t1a, a potential difference of +4 V is generated at the liquid crystal element 1-11 of the sub-pixel 111, and a potential difference of +5 V is generated at the liquid crystal element 1-12 of the sub-pixel 112. For this reason, the sub-pixel 112, having a large potential difference, is displayed with a higher luminance than the sub-pixel 111. For this reason, the sub-pixel 111 is displayed dark, and the sub-pixel 112 is displayed bright.

The controller 12 supplies to the display signal line 3-3 a display signal of the same polarity as for the display signal line 3-1. For this reason, during the time period Ma. to t1a, a potential difference of +4 V is generated at the liquid crystal element 1-31 of the sub-pixel 131 of the pixel 103, and a potential difference of +5 V is generated at the liquid crystal element 1-32 of the sub-pixel 132. For this reason, the sub-pixel 131 is displayed dark, and the sub-pixel 132 is displayed bright.

Next, the operation of the sub-pixel 121 and the sub-pixel 122 of the pixel 102 will be described. During the time period t0a to t1a, the potential difference between −5 V on the display signal line 3-2 and −1 V on the reference potential trunk line 4-3, this being −4 V, is generated at the liquid crystal element 1-21. Also, during the time period Ma to t1a, the potential difference between −5 V on the display signal line 3-2 and 0 V on the reference potential trunk line 4-2, this being −5 V, is generated at the liquid crystal element 1-22. As a result, in the luminance of the sub-pixels 121 to 122, the sub-pixel 121 is displayed dark, and the sub-pixel 122 is displayed bright.

The operation of the sub-pixel 141 and the sub-pixel 142 of the pixel 104 is the same as in the first embodiment at the Lth frame. For this reason, during the time period t1b to t2b, a potential difference of +4 V is generated at the liquid crystal element 1-41 of the sub-pixel 141, and a potential difference of +3 V is generated at the liquid crystal element 1-42 of the sub-pixel 142. For this reason, in the luminance of the sub-pixels 141 to 142, the sub-pixel 142 is displayed dark, and the sub-pixel 141 is displayed bright.

Also, during the time period t1b to t2b, a potential difference of +4 V is generated at the liquid crystal element 1-62 of the sub-pixel 162 of the pixel 106, and a potential difference of +3 V is generated at the liquid crystal element 1-61 of the sub-pixel 161. For this reason, the sub-pixel 162 is displayed dark, and the sub-pixel 161 is displayed bright.

Next, the operation of the sub-pixel 151 and the sub-pixel 152 of the pixel 105 will be described. During the time period t1b to t2b, the potential difference between −4 V on the display signal line 3-2 and 0 V on the reference potential trunk line 4-2, this being −4 V, is generated at the liquid crystal element 1-51 (equivalent electrical capacitance). Also, during the time period t1b to t2b, the potential difference between −4 V on the display signal line 3-2 and −1 V on the reference potential trunk line 4-3, this being −3 V, is generated at the liquid crystal element 1-52 (equivalent electrical capacitance). As a result, in the luminance of the sub-pixels 151 to 152, the sub-pixel 152 is displayed dark, and the sub-pixel 151 is displayed bright.

Next, the operation at the (L+1) th frame will be described, using FIG. 11 and FIG. 12. FIG. 12 shows the timing diagram of the (L+1) th frame after the time t0b. During the vertical return interval, the controller 12 switches the polarity of the potentials on the display signal lines 3-1 to 3-3 to the polarity that is the reverse of the polarity in the Lth frame. The controller 12 switches the reference potential trunk line 4-1 from +1 V to −1 V, and switches the reference potential trunk line 4-3 from −1 V to +1 V (FIG. 12, time t0b). That is, the controller 12 switches the potential on the reference potential trunk lines 4-1 and 4-2 for each frame, and also alternates both potentials for each frame. That is, controller 12 switches magnitude of the potential from the relationship in which the potential on the reference potential trunk line 4-1 is larger than that of the reference potential trunk line 4-2 and also the potential on the reference potential trunk line 4-2 is larger than that of the reference potential trunk line 4-3, to the relationship in which the potential on the reference potential trunk line 4-3 is larger than that of the reference potential trunk line 4-2 and also the potential on the reference potential trunk line 4-2 is larger than that of the reference potential trunk line 4-1.

Next, the controller 12 controls the scanning line 5-1 to the high level between times t0b to t1b, thus placing the switching elements 2-11 to 2-12, 2-21 to 2-22, and 2-31 to 2-32 into the on state. For this reason, the controller 12 supplies a signal of −5 V to the pixel 101 in the first row from the display signal line 3-1, and supplies a signal of +5 V to the pixel 102 in the first row from the display signal line 3-2. Additionally, the controller 12 controls the scanning line 5-2 to the high level between times t1b to t2b, thus placing the switching elements 2-41 to 2-42, 2-51 to 2-52, and 2-61 to 2-62 into the on state. For this reason, the controller 12 supplies a signal of −4 V to the pixel 104 in the second row from the display signal line 3-1, and supplies a signal of +4 V to the pixel 105 in the second row from the display signal line 3-2. The switching of each switching element to the on state and potential difference generated in each liquid crystal element will be described below.

The operation of the sub-pixel 111 and the sub-pixel 112 of the pixel 101 will be described. During the time period t0b to t1b, the potential difference between −5 V on the display signal line 3-1 and −1 V on the reference potential trunk line 4-1, this being −4 V, is generated at the liquid crystal element 1-11. Also, during the time period t0b to t1b, the potential difference between −5 V on the display signal line 3-1 and 0 V on the reference potential trunk line 4-2, this being −5 V, is generated at the liquid crystal element 1-12. As a result, in the luminance of the sub-pixels 111 to 112, in accordance with the potential differences, the sub-pixel 111 is displayed dark, and the sub-pixel 112 is displayed bright.

The controller 12 supplies to the display signal line 3-3 a display signal having the same polarity as for the display signal line 3-1. For this reason, during the time period t0b to t1b, a potential difference of −4 V is generated at the liquid crystal element 1-31 of the sub-pixel 131 of the pixel 103, and a potential difference of −5 V is generated at the liquid crystal element 1-32 of the sub-pixel 132. For this reason, the sub-pixel 131 is displayed dark, and the sub-pixel 132 is displayed bright.

Next, the operation of the sub-pixel 121 and the sub-pixel 122 of the pixel 102 will be described. During the time period t0b to t1b, the potential difference between +5 V on the display signal line 3-2 and +1 V on the reference potential trunk line 4-3, this being +4 V, is generated at the liquid crystal element 1-21. Also, during the time period t0b to t1b, the potential difference between +5 V on the display signal line 3-2 and 0 V on the reference potential trunk line 4-2, this being +5 V, is generated at the liquid crystal element 1-22. As a result, in the luminance of the sub-pixels 121 to 122, in accordance with the potential differences, the sub-pixel 121 is displayed dark, and the sub-pixel 122 is displayed bright.

Next, the operation of the sub-pixel 141 and the sub-pixel 142 of the pixel 104 will be described. During the time period t1b to t2b, the potential difference between −4 V on the display signal line 3-1 and 0 V on the reference potential trunk line 4-2, this being −4 V, is generated at the liquid crystal element 1-41. Also, during the time period t1b to t2b, the potential difference between −4 V on the display signal line 3-1 and −1 V on the reference potential trunk line 4-1, this being −3 V, is generated at the liquid crystal element 1-42. As a result, in the luminance of the sub-pixels 141 to 142, in accordance with the potential differences, the sub-pixel 142 is displayed dark, and the sub-pixel 141 is displayed bright.

During the time period t1b to t2b, a potential difference of −4 V is generated at the liquid crystal element 1-62 of the sub-pixel 162 of the pixel 106, and a potential difference of −3 V is generated at the liquid crystal element 1-61 of the sub-pixel 161. For this reason, the sub-pixel 162 is displayed dark, and the sub-pixel 161 is displayed bright.

Next, the operation of the sub-pixel 151 and the sub-pixel 152 of the pixel 105 will be described. During the time period t1b to t2b, the potential difference between +4 V on the display signal line 3-2 and 0 V on the reference potential trunk line 4-2, this being +4 V, is generated at the liquid crystal element 1-51. Also, during the time period t1b to t2b, the potential difference between +4 V on the display signal line 3-2 and +1 V on the reference potential trunk line 4-3, this being +3 V, is generated at the liquid crystal element 1-52. As a result, in the luminance of the sub-pixels 151 to 152, in accordance with the potential differences, the sub-pixel 152 is displayed dark, and the sub-pixel 151 is displayed bright.

FIG. 13 is a drawing describing a layout example on a first substrate 10 to which the third embodiment is applied. In a TFT part 300 as shown in FIG. 13, regions with the same hatching as shown in a region A11 indicate first electrodes (gate electrodes). Regions with the same hatching as shown in a region A12 indicate second electrodes (source electrodes, drain electrodes). Regions with the same hatching as shown in a region A13 indicate a semiconductor layer (silicon layers). Regions with the same hatching as shown in a region A14 indicate third electrodes (pixel electrodes). The part shown in a region A15 indicates a contact between the first electrode and the second electrode. The part shown in a region A16 indicates a contact between the second electrode and the third electrode.

In FIG. 13, the transparent electrode 13, to which the display signal lines 3-1 to 3-3 are connected, is above the opposing second substrate 20. For this reason, the reference potential trunk lines 4-1 to 4-3, the scanning lines 5-1 to 5-2, the switching elements 2, and the display electrodes 11 are formed over the first substrate 10.

In FIG. 13, each pixel has Sub-pix 1 and Sub-pix2. In each sub-pixel, the gate terminal of each switching element 2 is connected to the scanning line 5-1 or 5-2. The source terminal of the switching element 2 of the sub-pixel Sub-pix1 is connected to the reference potential trunk line 4-1 or the reference potential trunk line 4-3. The drain terminal of the switching element 2 of the sub-pixel Sub-pix1 is connected to one end of the liquid crystal element 1 via the display electrode 11. The other end of the liquid crystal element 1 is connected to a display signal line 3, via the transparent electrode 13. The source terminal of the switching element 2 of the sub-pixel Sub-pix2 is connected to the reference potential trunk line 4-2. The drain terminal of the switching element 2 of the sub-pixel Sub-pix2 is connected to one end of the liquid crystal element 1, via the display electrode 11. The other end of the liquid crystal element 1 is connected to the display signal line 3, via the transparent electrode 13.

In the present embodiment, although an example such as switching the potential on the reference potential trunk lines 4-1 to 4-3 for each frame has been described, the switching may be done for each the pixel selection period. The pixel selection period is, for example, in the case of a display device driven by 60-Hz with a Full HD resolution (having 1080 scanning lines), every 1/60/1080 s. Additionally, if the pixel selection period is defined as 1H, the potential may be switched every 2 kH (where k is an integer of one or larger).

As described above, it is possible to cause generation of different potential difference between equivalent electrical capacitances of each liquid crystal element of two sub-pixels of each pixel, thereby obtaining a liquid crystal display device having a multipixel opposing matrix constitution. Also, according to the third embodiment, as shown in FIG. 10 and FIG. 11, the sequences in the row directions of bright pixels (of two sub-pixels, the one having a larger absolute value of the potential differences applied to both ends of the liquid crystal element) and of dark pixels (of two sub-pixels, the one having a smaller absolute value of the potential differences applied to both ends of the liquid crystal element) can be disposed in parallel with respect to the scanning line 5-1. For this reason, similar to the second embodiment, the display characteristics can be improved. Also, because there is need to change the potential on each reference trunk line 4-1 and 4-3 only one time for one frame, a display device having low electrical power consumption can be achieved.

### Fourth Embodiment

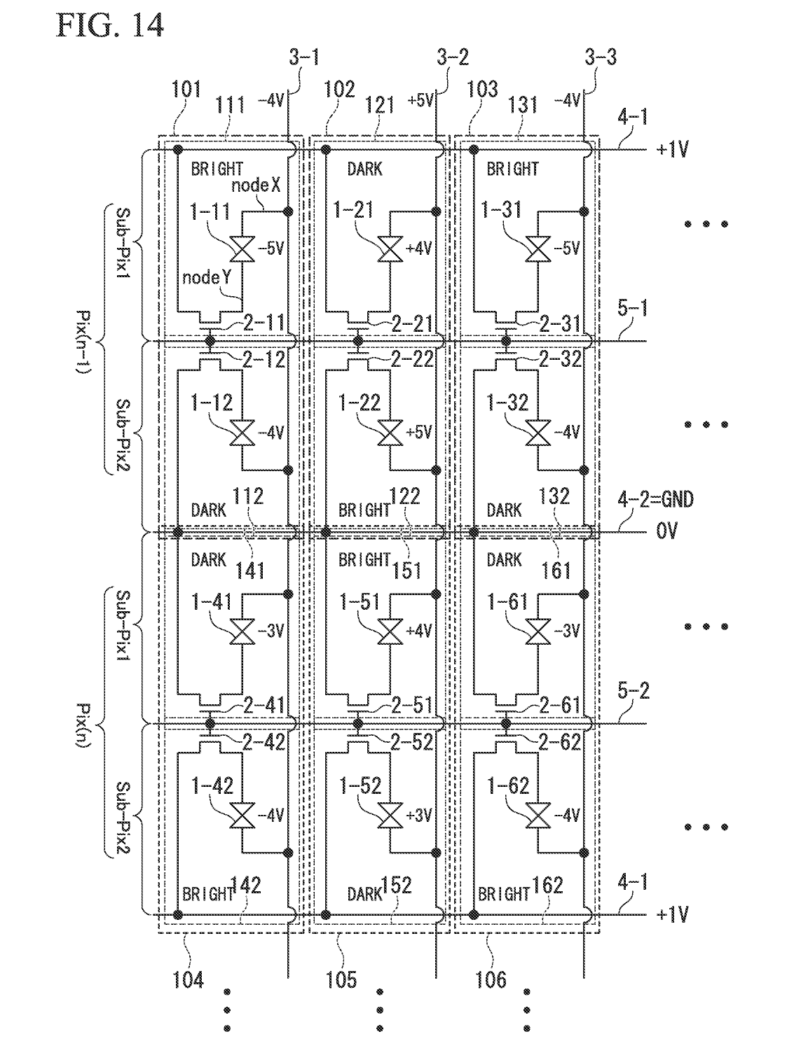

The fourth embodiment is another embodiment of a liquid crystal display device, which is constituted so that one pixel is made up of two sub-pixels. FIG. 14 is an equivalent circuit describing the operation at the (L+1) th frame of the liquid crystal display device of the second embodiment having pixels (Pix(n−1), Pix(n)) that have two sub-pixels (Sub-Pix1, Sub-Pix2). The constitution of the fourth embodiment is the same as the first embodiment, and the operation at the time of the Lth frame is the same as at the Lth frame in the first embodiment of FIG. 3.

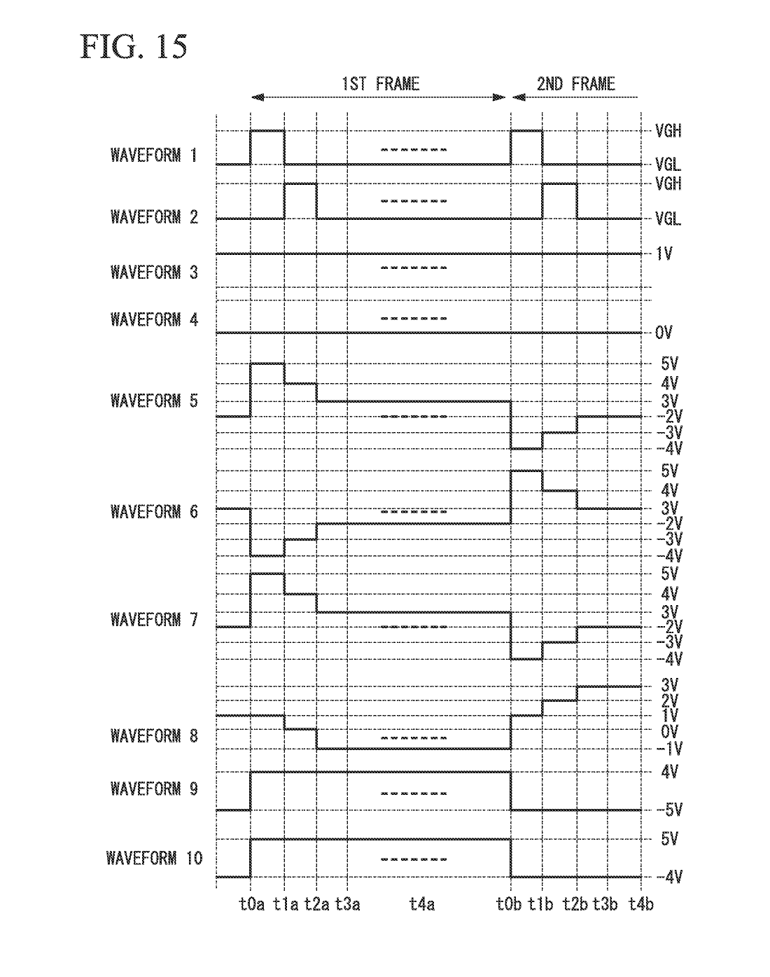

Next, the operation at the (L+1) th frame will be described, using FIG. 14 and FIG. 15. FIG. 15 is a timing diagram of the liquid crystal display device at the Lth frame and at the (L+1) th frame in the fourth embodiment. FIG. 15 shows the timing diagram of the (L+1) th frame after the time t0b.

In FIG. 15, the horizontal axis represents time, and the vertical axis represents electrical potential. The waveform 1 in FIG. 15 shows the time variations of the potential on the scanning line 5-1. The waveform 2 in FIG. 15 shows the time variations of the potential on the scanning line 5-2. The waveform 3 in FIG. 15 shows the time variations of the potential on the reference potential trunk line 4-1. The waveform 4 in FIG. 15 shows the time variations of the potential on the reference potential trunk line 4-2. The waveform 5 in FIG. 15 shows the time variations of the potential on the display signal line 3-1. The waveform 6 in FIG. 15 shows the time variations of the potential on the display signal line 3-2. The waveform 7 in FIG. 15 shows the time variations of the potential on the node X. The waveform 8 in FIG. 15 shows the time variations of the potential on the node Y. The waveform 9 in FIG. 15 shows the time variations of the potential between the node X and the node Y (voltage applied to Sub-pix 1). The waveform 10 in FIG. 15 shows the time variations of the voltage applied to the liquid crystal of sub-pix2).

During the vertical return interval, the controller 12 switches the polarity of the potentials on the display signal lines 3-1 to 3-3 to the polarity that is the reverse of the polarity in the Lth frame. Next, the controller 12 controls the scanning line 5-1 to the high level between times t0b to t1b, thus placing the switching elements 2-11 to 2-12, 2-21 to 2-22, and 2-31 to 2-32 into the on state. For this reason, the controller 12 supplies a signal of −4 V to the pixel 101 in the first row from the display signal line 3-1, and supplies a signal of +5 V to the pixel 102 in the first row from the display signal line 3-2. The range of each display signal line 3-11 to 3-13 is, for example, a potential of +5 V to +1 V on the positive polarity side and −5 V to −1 V on the negative polarity side. Additionally, the controller 12 controls the scanning line 5-2 to the high level between times t1b to t2b, thus placing the switching elements 2-41 to 2-42, 2-51 to 2-52, and 2-61 to 2-62 into the on state. For this reason, the controller 12 supplies a signal of −3 V to the pixel 104 in the second row from the display signal line 3-1, and supplies a signal of +4 V to the pixel 105 in the second row from the display signal line 3-2.

The signal levels on the display signal lines 3-1 and 3-2 shown in FIG. 15 are signal levels showing one example of operation. The switching of each switching element to the on state and potential difference generated in each liquid crystal element will be described below.

The operation of the sub-pixel 111 and the sub-pixel 112 of the pixel 101 will be described. During the time period t0b to t1b, the potential difference between −4 V on the display signal line 3-1 and +1 V on the reference potential trunk line 4-1, this being −5 V, is generated at the liquid crystal element 1-11. Also, during the time period t0b to t1b, the potential difference between −4 V on the display signal line 3-1 and 0 V on the reference potential trunk line 4-2, this being −4 V, is generated at the liquid crystal element 1-12. As a result, in the luminance of the sub-pixels 111 to 112, in accordance with the potential difference, the sub-pixel 112 is displayed dark, and the sub-pixel 111 is displayed bright.

The controller 12 supplies to the display signal line 3-3 a display signal having the same polarity as for the display signal line 3-1. For this reason, during the time period t0b to t1b, a potential difference of −5 V is generated at the liquid crystal element 1-31 of the sub-pixel 131 of the pixel 103, and a potential difference of −4 V is generated at the liquid crystal element 1-32 of the sub-pixel 132. For this reason, the sub-pixel 132 is displayed dark, and the sub-pixel 131 is displayed bright.

Next, the operation of the sub-pixel 121 and the sub-pixel 122 of the pixel 102 will be described. During the time period t0b to t1b, the potential difference between +5 V on the display signal line 3-2 and +1 V on the reference potential trunk line 4-1, this being +4 V, is generated at the liquid crystal element 1-21. Also, during the time period t0b to t1b, the potential difference between +5 V on the display signal line 3-2 and 0 V on the reference potential trunk line 4-2, this being +5 V, is generated at the liquid crystal element 1-22. As a result, in the luminance of the sub-pixels 121 to 122, in accordance with the potential difference, the sub-pixel 121 is displayed dark, and the sub-pixel 122 is displayed bright.

Next, the operation of the sub-pixel 141 and the sub-pixel 142 of the pixel 104 will be described. During the time period t1b to t2b, the potential difference between −3 V on the display signal line 3-1 and 0 V on the reference potential trunk line 4-2, this being −3 V, is generated at the liquid crystal element 1-41. Also, during the time period t1b to t2b, the potential difference between −3 V on the display signal line 3-1 and +1 V on the reference potential trunk line 4-1, this being −4 V, is generated at the liquid crystal element 1-42. As a result, in the luminance of the sub-pixels 141 to 142, in accordance with the potential difference, the sub-pixel 141 is displayed dark, and the sub-pixel 142 is displayed bright.

During the time period t1b to t2b, the potential difference of −3 V is generated at the liquid crystal element 1-61 of the sub-pixel 161 of the pixel 106, and the potential difference of −4 V is generated at the liquid crystal element 1-62 of the sub-pixel 162. For this reason, the sub-pixel 162 is displayed dark, and the sub-pixel 161 is displayed bright.

Next, the operation of the sub-pixel 151 and the sub-pixel 152 of the pixel 105 will be described. During the time period t1b to t2b, the potential difference between +4 V on the display signal line 3-2 and 0 V on the reference potential trunk line 4-2, this being +4 V, is generated at the liquid crystal element 1-51. Also, during the time period t1b to t2b, the potential difference between +4 V on the display signal line 3-2 and +1 V on the reference potential trunk line 4-1, this being +3 V, is generated at the liquid crystal element 1-52. As a result, in the luminance of the sub-pixels 151 to 152, in accordance with the potential difference, the sub-pixel 152 is displayed dark, and the sub-pixel 151 is displayed bright.

As described above, it is possible to cause generation of different potential differences between equivalent electrical capacitances of each of the liquid crystal elements of the two sub-pixels of one pixel, thereby obtaining a liquid crystal display device having a multipixel opposing matrix constitution. Also, because there is no need to change the potential on each reference potential trunk lines 4-1 to 4-2 for each frame, it is possible to set a constant (DC) potential, thereby enabling a display device having a low electrical power consumption.

### Fifth Embodiment

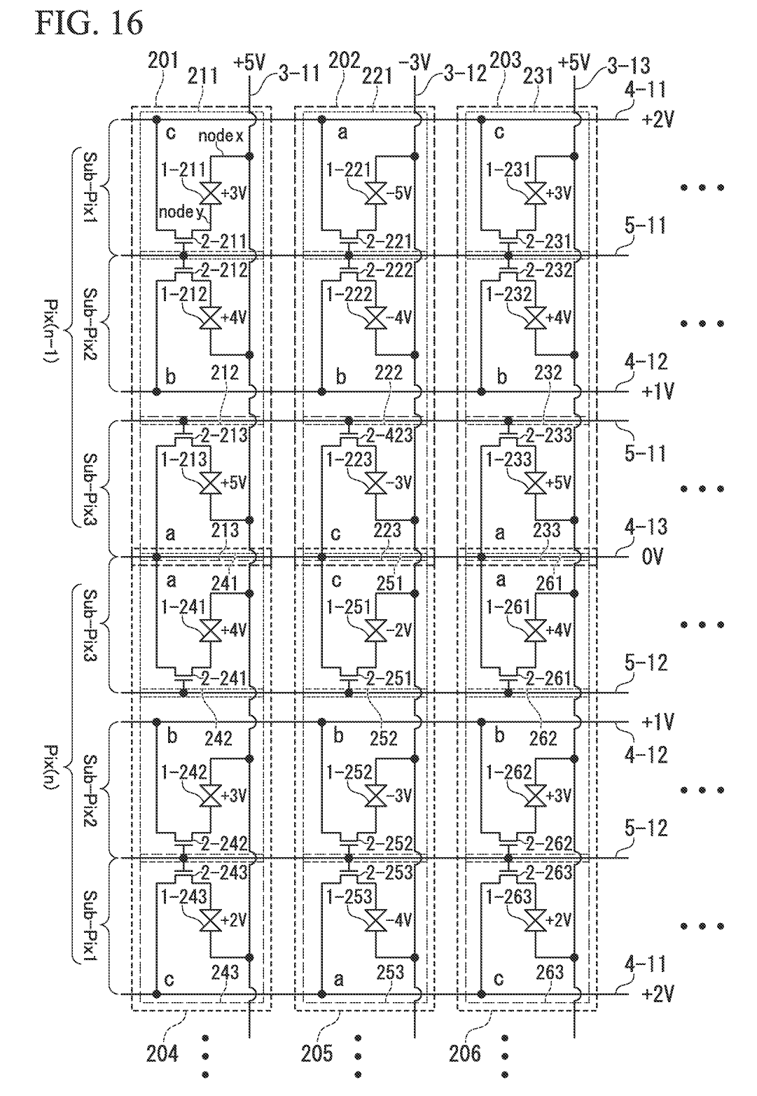

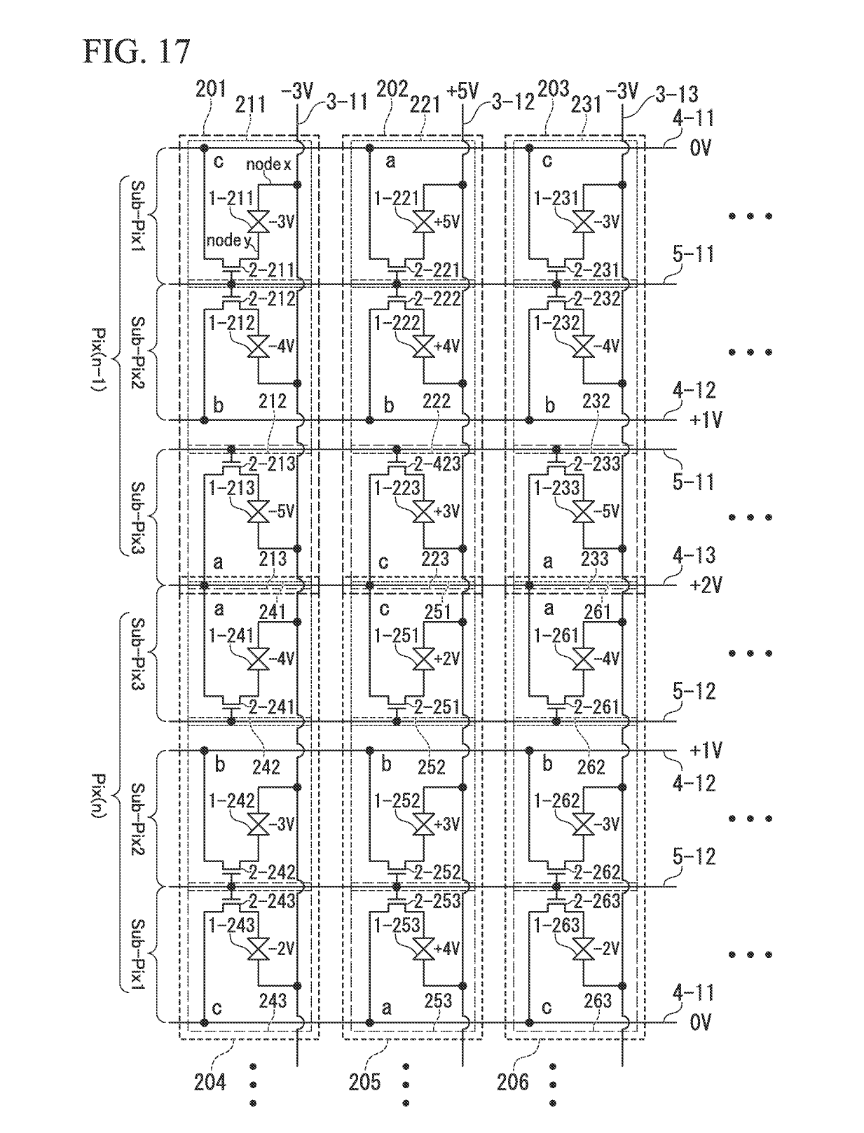

A liquid crystal display device in a fifth embodiment is constituted so that one pixel (Pix(n−1), Pix(n)) is made up of three sub-pixels (Sub-Pix1, Sub-Pix2, Sub-Pix3). FIG. 16 is an equivalent circuit describing the operation at the Lth frame of the liquid crystal display device of the fifth embodiment having three sub-pixels. FIG. 17 is an equivalent circuit describing the operation at the (L+1) th frame of the liquid crystal display device of the fifth embodiment having pixels (Pix(n−1), Pix(n)) that have three sub-pixels (Sub-Pix1, Sub-Pix2, Sub-Pix3). As shown in FIG. 16, the liquid crystal display device of the fifth embodiment has pixels 201 to 206. Each of the pixels 201 to 206 has three sub-pixels, respectively. The pixels 201 and 202 are disposed so as to be adjacent in the row direction. The pixel 201 has, with respect to the column direction, the sub-pixel 211, the sup-pixel 212 and the sub-pixel 213, disposed in that sequence. The pixel 202 has, with respect to the column direction, the sub-pixel 221, the sub-pixel 222 and the sub-pixel 223, disposed in that sequence. The pixels 204 and 205, which are disposed so as to be adjacent in the row direction, are disposed in linear symmetry with the pixel 201 and the pixel 202, with respect to the reference potential trunk line 4-12. The pixel 204 has, with respect to the column direction, the sub-pixel 243, the sub-pixel 242 and the sub-pixel 241 disposed in that sequence. The pixel 205 has, with respect to the column direction, the sub-pixel 253, the sub-pixel 252 and the sub-pixel 251 disposed in that sequence. The constitutions of the pixel 203 and the pixel 206 are the same as the above.

First, the constitution of the sub-pixels 211, 212, and 213 of the pixel 201 will be described. The gate terminals of the switching element 2-211, the switching element 2-212 and the switching element 2-213 are connected to the common scanning line 5-11. The source terminal of the switching element 2-211 is connected to the reference potential trunk line 4-11. The drain terminal of the switching element 2-211 is connected to one end of the liquid crystal element 1-211, via the display electrode 11. The other end of the liquid crystal element 1-211 is connected to the display signal line (first display signal line) 3-11, via the transparent electrode 13. The source terminal of the switching element 2-212 is connected to the reference potential trunk line 4-12. The drain terminal of the switching element 2-212 is connected to one end of the liquid crystal element 1-212, via the display electrode 11. The other end of the liquid crystal element 1-212 is connected to the display signal line 3-11, via the transparent electrode 13. The source terminal of the switching element 2-213 is connected to the reference potential trunk line 4-13. The drain terminal of the switching element 2-113 is connected to one end of the liquid crystal element 1-213, via the display electrode 11. The other end of the liquid crystal element 1-213 is connected to the display signal line 3-11, via the transparent electrode 13.

Next, the constitution of the sub-pixels 221, 222, and 223 of the pixel 202 will be described. The gate terminals of the switching element 2-221, the switching element 2-222 and the switching element 2-223 are connected to the common scanning line 5-11. The source terminal of the switching element 2-221 is connected to the reference potential trunk line 4-11. The drain terminal of the switching element 2-221 is connected to one end of the liquid crystal element 1-221, via the display electrode 11. The other end of the liquid crystal element 1-221 is connected to the display signal line (second display signal line) 3-12, via the transparent electrode 13. The source terminal of the switching element 2-222 is connected to the reference potential trunk line 4-12. The drain terminal of the switching element 2-222 is connected to one end of the liquid crystal element 1-222, via the display electrode 11. The other end of the liquid crystal element 1-222 is connected to the display signal line 3-12, via the transparent electrode 13. The source terminal of the switching element 2-223 is connected to the reference potential trunk line 4-13. The drain terminal of the switching element 2-123 is connected to one end of the liquid crystal element 1-223, via the display electrode 11. The other end of the liquid crystal element 1-223 is connected to the display signal line 3-12, via the transparent electrode 13.

Next, the constitution of the sub-pixels 241, 242 and 243 of the pixel 204 will be described. The gate terminals of the switching elements 2-241, 2-242, and 2-243 are connected to the common scanning line 5-12. The source terminal of the switching element 2-241 is connected to the reference potential trunk line 4-13. The drain terminal of the switching element 2-241 is connected to one end of the liquid crystal element 1-241, via the display electrode 11. The other end of the liquid crystal element 1-241 is connected to the display signal line 3-11, via the transparent electrode 13. The source terminal of the switching element 2-242 is connected to the reference potential trunk line 4-12. The drain terminal of the switching element 2-242 is connected to one end of the liquid crystal element 1-242, via the display electrode 11. The other end of the liquid crystal element 1-242 is connected to the display signal line 3-11, via the transparent electrode 13. The source terminal of the switching element 2-243 is connected to the reference potential trunk line 4-11. The drain terminal of the switching element 2-243 is connected to one end of the liquid crystal element 1-243, via the display electrode 11. The other end of the liquid crystal element 1-243 is connected to the display signal line 3-11, via the transparent electrode 13.

Next, the constitution of the sub-pixels 251, 252, and 253 of the pixel 205 will be described. The gate terminals of the switching elements 2-251, 2-252, and 2-253 are connected to the common scanning line 5-12. The source terminal of the switching element 2-251 is connected to the reference potential trunk line 4-13. The drain terminal of the switching element 2-251 is connected to one end of the liquid crystal element 1-251, via the display electrode 11. The other end of the liquid crystal element 1-251 is connected to the display signal line 3-12, via the transparent electrode 13. The source terminal of the switching element 2-252 is connected to the reference potential trunk line 4-12. The drain terminal of the switching element 2-252 is connected to one end of the liquid crystal element 1-252, via the display electrode 11. The other end of the liquid crystal element 1-252 is connected to the display signal line 3-12, via the transparent electrode 13. The source terminal of the switching element 2-253 is connected to the reference potential trunk line 4-11. The drain terminal of the switching element 2-253 is connected to one end of the liquid crystal element 1-253, via the display electrode 11. The other end of the liquid crystal element 1-253 is connected to the display signal line 3-12, via the transparent electrode 13. The constitutions of the pixels 203 and 206 are the same as the above.

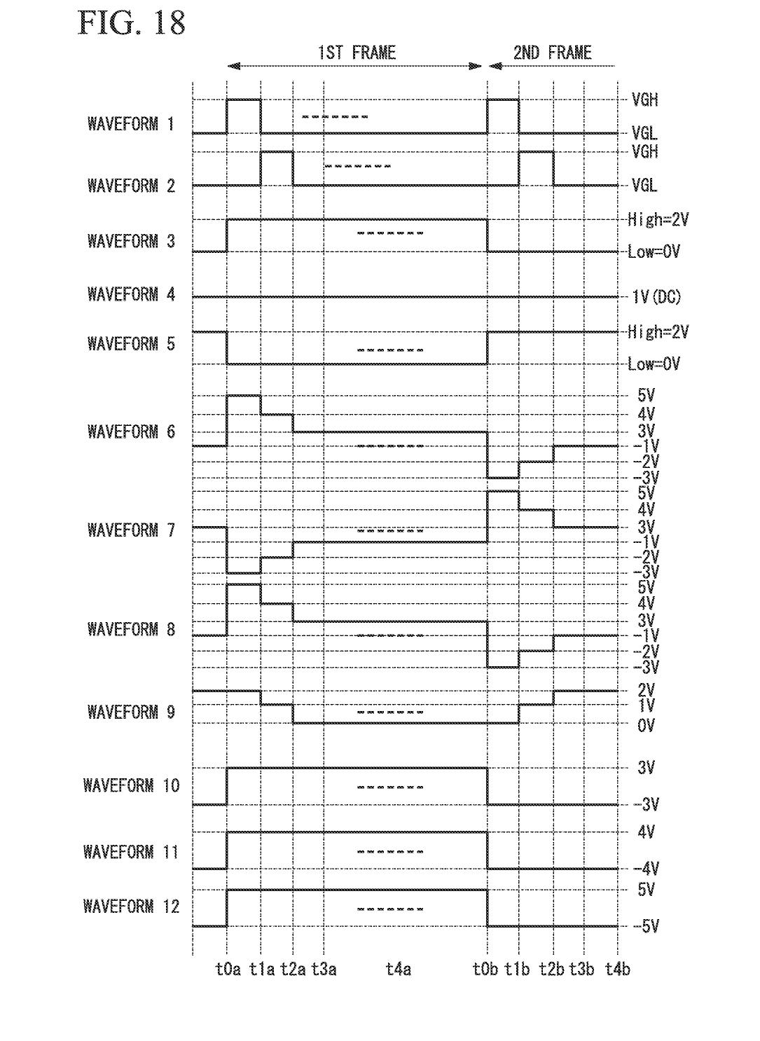

Next, the operation of the liquid crystal display device will be described, using FIG. 16 and FIG. 18. FIG. 18 is a timing diagram of the liquid crystal display device at the Lth frame and at the (L+1) th frame in the fifth embodiment.

The operation of each sub-pixel of the pixels 201 to 206 at the Lth frame (where L is a natural number 1 or larger) will first be described. The controller 12 controls the reference potential trunk line 4-11 to +2 V, controls the potential trunk line 4-12 to +1 V, and controls the reference potential trunk line 4-13 to 0 V (FIG. 18 at time t0a). That is, the controller 12 controls the magnitude of the potential to the relationship in which the potential on the reference potential trunk line 4-11 is larger than that on the reference potential trunk line 4-12, and the potential on the reference potential trunk line 4-12 is larger than that on the reference potential trunk line 4-13 (reference potential trunk line 4-11>reference potential trunk line 4-12>reference potential trunk line 4-13).

Next, the controller 12 controls the scanning line 5-11 to the high level between times Ma to t1a, thus placing the switching elements 2-211 to 2-213, 2-221 to 2-223, and 2-231 to 2-233 into the on state. For this reason, the controller 12 supplies signals of +5 V to the pixel 201 and the pixel 203 in the first row from the display signal line 3-11 and the display signal line 3-13, and supplies a signal of −3 V to the pixel 202 in the first row from the display signal line 3-2. The range of the signal on each display signal line 3-11 to 3-13 is, for example, +5 V to +1 V on the positive polarity side and −5 V to −1 V on the negative polarity side. Additionally, the controller 12 controls the scanning line 5-12 to the high level between times t1a to t2a, thus placing the switching elements 2-241 to 2-243, 2-251 to 2-253, and 2-261 to 2-263 into the on state. For this reason, the controller 12 supplies signals of +4 V to the pixel 204 and the pixel 206 in the second row from the display signal lines 3-11 and 3-13, and supplies a signal of −2 V to the pixel 205 in the second row from the display signal line 3-2. The signal levels on the display signal lines 3-1 and 3-2 shown in FIG. 18 are signal levels showing one example of operation. The switching of each switching element to the on state and potential difference generated in each liquid crystal element will be described below.

The operation of the sub-pixel 211 to the sub-pixel 213 of the pixel 201 will be described. During the time period t0a to t1a, the potential difference between −5 V on the display signal line 3-11 and +2 V on the reference potential trunk line 4-11, this being +3 V, is generated at the liquid crystal element 1-211 (equivalent electrical capacitance). Also, during the time period t0a to t1a, the potential difference between +5 V on the display signal line 3-11 and +1 V on the reference potential trunk line 4-12, this being +4 V, is generated at the liquid crystal element 1-212 (equivalent electrical capacitance). Additionally, during the time period t0a to t1a, the potential difference between +5 V on the display signal line 3-11 and 0 V on the reference potential trunk line 4-13, this being +5 V, is generated at the liquid crystal element 1-213 (equivalent electrical capacitance). As a result, in the luminance of the sub-pixels 211 to 213, in accordance with the potential difference, the luminance of the sub-pixel 213 is higher than that of the sub-pixel 212, and also the luminance of the sub-pixel 212 is higher than that of the sub-pixel 211. In FIG. 16 and FIG. 17, the symbols a, b, and c represent the sequence of luminances, in which the luminance of a is higher than that of b, and also the luminance of b is higher than that of c (a>b>c).

The controller 12 supplies to the display signal line 3-13 a display signal having the same polarity as for the display signal line 3-11. For this reason, during the time period Ma to t1a, a potential difference of +3 V is generated at the liquid crystal element 1-231 (equivalent electrical capacitance) of the sub-pixel 231 of the pixel 203. Also, a potential difference of +4 V is generated at the liquid crystal element 1-232 (equivalent electrical capacitance) of the sub-pixel 232. Also, a potential difference of +5 V is generated at the liquid crystal element 1-233 (equivalent electrical capacitance) of the sub-pixel 233. For this reason, in the luminance of the sub-pixel 231 to 233, in accordance with the potential difference, the luminance of the sub-pixel 233 is higher than that of the sub-pixel 232, and also the luminance of the sub-pixel 232 is higher than that of the sub-pixel 231.

Next, the operation of the sub-pixel 221 to the sub-pixel 223 of the pixel 202 will be described. During the time period t0a to t1a, the potential difference between −3 V on the display signal line 3-12 and +2 V on the reference potential trunk line 4-11, this being −5 V, is generated at the liquid crystal element 1-221 (equivalent electrical capacitance). Also, during the time period t0a to t1a, the potential difference between −3 V on the display signal line 3-12 and +1 V on the reference potential trunk line 4-12, this being −4 V, is generated at the liquid crystal element 1-222 (equivalent electrical capacitance). Additionally, during the time period t0a to t1a, the potential difference between −3 V on the display signal line 3-12 and 0 V on the reference potential trunk line 4-13, this being −3 V, is generated at the liquid crystal element 1-223 (equivalent electrical capacitance). As a result, in the luminance of the sub-pixels 221 to 223, in accordance with the potential difference, the luminance of the sub-pixel 221 is higher than that of the sub-pixel 222, and also the luminance of the sub-pixel 222 is higher than that of the sub-pixel 223.

Next, the operation of the sub-pixel 241 to the sub-pixel 243 of the pixel 204 will be described. During the time period t1a to t2a, the potential difference between +4 V on the display signal line 3-11 and 0 V on the reference potential trunk line 4-13, this being +4 V, is generated at the liquid crystal element 1-241 (equivalent electrical capacitance). Also, during the time period t1a to t2a, the potential difference between +4 V on the display signal line 3-11 and +1 V on the reference potential trunk line 4-12, this being +3 V, is generated at the liquid crystal element 1-242 (equivalent electrical capacitance). Additionally, during the time period t1a to t2a, the potential difference between +4 V on the display signal line 3-11 and +2 V on the reference potential trunk line 4-11, this being +2 V, is generated at the liquid crystal element 1-243 (equivalent electrical capacitance). As a result, in the luminance of the sub-pixels 241 to 243, in accordance with the potential difference, the luminance of the sub-pixel 241 is higher than that of the sub-pixel 242, and also the luminance of the sub-pixel 242 is higher than that of the sub-pixel 243.

The controller 12 supplies to the display signal line 3-13 a display signal having the same polarity as for the display signal line 3-11. For this reason, during the time period t 1a to t2a, a potential difference of +4 V is generated at the liquid crystal element 1-261 (equivalent electrical capacitance) of the sub-pixel 261 of the pixel 206. Also, a potential difference of +3 V is generated at the liquid crystal element 1-262 (equivalent electrical capacitance) of the sub-pixel 262. Also, a potential difference of +5 V is generated at the liquid crystal element 1-263 (equivalent electrical capacitance) of the sub-pixel 263. For this reason, in the luminance of the sub-pixel 261 to 263, in accordance with the potential difference, the luminance of the sub-pixel 261 is higher than that of the sub-pixel 262, and also the luminance of the sub-pixel 262 is higher than that of the sub-pixel 263.

Next, the operation of the sub-pixel 251 to the sub-pixel 253 of the pixel 205 will be described. During the time period t1a to t2a, the potential difference between −2 V on the display signal line 3-12 and 0 V on the reference potential trunk line 4-13, this being −2 V, is generated at the liquid crystal element 1-251 (equivalent electrical capacitance). Also, during the time period t1a to t2a, the potential difference between −2 V on the display signal line 3-12 and +1 V on the reference potential trunk line 4-12, this being −3 V, is generated at the liquid crystal element 1-252 (equivalent electrical capacitance). Additionally, during the time period t1a to t2a, the potential difference between −2 V on the display signal line 3-12 and +2 V on the reference potential trunk line 4-11, this being −4 V, is generated at the liquid crystal element 1-253 (equivalent electrical capacitance). As a result, in the luminance of the sub-pixels 251 to 253, in accordance with the potential difference, the luminance of the sub-pixel 253 is higher than that of the sub-pixel 252, and also the luminance of the sub-pixel 252 is higher than that of the sub-pixel 251.

Next, the operation at (L+1) th frame will be described, using FIG. 17 and FIG. 18. FIG. 18 shows the timing diagram of the (L+1) th frame after the time t0b.

In FIG. 18, the horizontal axis represents time, and the vertical axis represents electrical potential. The waveform 1 in FIG. 18 shows the time variations of the potential on the scanning line 5-11. The waveform 2 in FIG. 18 shows the time variations of the potential on the scanning line 5-12. The waveform 3 in FIG. 18 shows the time variations of the potential on the reference potential trunk line 4-11. The waveform 4 in FIG. 18 shows the time variations of the potential on the reference potential trunk line 4-12. The waveform 5 in FIG. 18 shows the time variations of the potential on the reference potential trunk line 4-13. The waveform 6 in FIG. 18 shows the time variations of the potential on the display signal line 3-11. The waveform 7 in FIG. 18 shows the time variations of the potential on the display signal line 3-12. The waveform 8 in FIG. 18 shows the time variations of the potential on the node X. The waveform 9 in FIG. 18 shows the time variations of the potential on the node Y. The waveform 10 in FIG. 18 shows the time variations of the potential between the node X and the node Y (voltage applied to Sub-pix1). The waveform 11 in FIG. 18 shows the time variations of the voltage applied to the liquid crystal of sub-pix2. The waveform 12 in FIG. 18 shows the time variations of the voltage applied to the liquid crystal of sub-pix3.

During the vertical return interval, the controller 12 switches the polarity of the potentials on the display signal lines 3-11 to 3-13 to the polarity that is the reverse of the polarity in the Lth frame. Additionally, the controller 12 switches the potential on the reference potential trunk line 4-11 from +2 V to 0 V, and switches the potential on the reference potential trunk line 4-13 from 0 V to +2 V. That is, controller 12 switches the magnitude of the potential from the relationship in which the potential on the reference potential trunk line 4-11 is larger than that of the reference potential trunk line 4-12 and also the potential on the reference potential trunk line 4-12 is larger than that of the reference potential trunk line 4-13, to the relationship in which the potential on the reference potential trunk line 4-13 is larger than that of the reference potential trunk line 4-12 and also the potential on the reference potential trunk line 4-12 is larger than that of the reference potential trunk line 4-11.

Next, the controller 12 controls the scanning line 5-11 to the high level between times t0b to t1b, thus placing the switching elements 2-211 to 2-213, 2-221 to 2-223, and 2-231 to 2-233 into the on state. For this reason, the controller 12 supplies signals of −3 V to the pixel 201 and pixel 203 in the first row from the display signal lines 3-11 and 3-13, and supplies a signal of +5 V to the pixel 202 in the first row from the display signal line 3-12. Additionally, the controller 12 controls the scanning line 5-12 to the high level between times t1b to t2b, thus placing the switching elements 2-241 to 2-243, 2-251 to 2-253, and 2-261 to 2-263 into the on state. For this reason, the controller 12 supplies signals of −2 V to the pixel 204 and the pixel 206 in the second row from the display signal lines 3-11 and 3-13, and supplies a signal of +4 V to the pixel 205 in the second row from the display signal lines 3-12. On state of each switching element and potential difference generated in each liquid crystal element will be described below. The switching of each switching element to the on state and potential difference generated in each liquid crystal element will be described below.

The operation of the sub-pixel 211 to the sub-pixel 213 of the pixel 201 will be described. During the time period t0b to t1b, the potential difference between −3 V on the display signal line 3-11 and 0 V on the reference potential trunk line 4-11, this being −3 V, is generated at the liquid crystal element 1-211. Also, during the time period t0b to t1b, the potential difference between −3 V on the display signal line 3-11 and +1 V on the reference potential trunk line 4-12, this being −4 V, is generated at the liquid crystal element 1-212. Additionally, during the time period t0b to t1b, the potential difference between −3 V on the display signal line 3-11 and +2 V on the reference potential trunk line 4-13, this being −5 V, is generated at the liquid crystal element 1-213. As a result, in the luminance of the sub-pixels 211 to 213, in accordance with the potential differences, the luminance of the sub-pixel 213 is higher than that of the sub-pixel 212, and also the luminance of the sub-pixel 212 is higher than that of the sub-pixel 211.

The controller 12 supplies to the display signal line 3-13 a display signal having the same polarity as for the display signal line 3-11. For this reason, during the time period t0b to t1b, a potential difference of −3 V is generated at the liquid crystal element 1-231 of the sub-pixel 231 of the pixel 203. Also, a potential difference of −4 V is generated at the liquid crystal element 1-232 of the sub-pixel 232. Also, a potential difference of −5 V is generated at the liquid crystal element 1-233 of the sub-pixel 232. For this reason, in the luminance of the sub-pixel 231 to 233, in accordance with the potential difference, the luminance of the sub-pixel 233 is higher than that of the sub-pixel 232, and also the luminance of the sub-pixel 232 is higher than that of the sub-pixel 231.

Next, the operation of the sub-pixel 221 to the sub-pixel 223 of the pixel 202 will be described. During the time period t0b to t1b, the potential difference between +5 V on the display signal line 3-12 and 0 V on the reference potential trunk line 4-11, this being +5 V, is generated at the liquid crystal element 1-221. Also, during the time period t0b to t1b, the potential difference between +5 V on the display signal line 3-12 and +1 V on the reference potential trunk line 4-12, this being +4 V, is generated at the liquid crystal element 1-222. Additionally, during the time period t0b to t1b, the potential difference between +5 V on the display signal line 3-12 and +2 V on the reference potential trunk line 4-13, this being +3 V, is generated at the liquid crystal element 1-223. As a result, in the luminance of the sub-pixels 221 to 223, in accordance with the potential difference, the luminance of the sub-pixel 221 is higher than that of the sub-pixel 222, and also the luminance of the sub-pixel 222 is higher than that of the sub-pixel 223.

Next, the operation of the sub-pixel 241 to the sub-pixel 243 of the pixel 204 will be described. During the time period t1b to t2b, the potential difference between −2 V on the display signal line 3-11 and +2 V on the reference potential trunk line 4-13, this being −4 V, is generated at the liquid crystal element 1-241. Also, during the time period t1b to t2b, the potential difference between −2 V on the display signal line 3-11 and +1 V on the reference potential trunk line 4-12, this being −3 V, is generated at the liquid crystal element 1-242. Additionally, during the time period t1b to t2b, the potential difference between −2 V on the display signal line 3-11 and 0 V on the reference potential trunk line 4-11, this being −2 V, is generated at the liquid crystal element 1-243. As a result, in the luminance of the sub-pixels 241 to 243, in accordance with the potential difference, the luminance of the sub-pixel 241 is higher than that of the sub-pixel 242, and also the luminance of the sub-pixel 242 is higher than that of the sub-pixel 243.

The controller 12 supplies to the display signal line 3-13 a display signal having the same polarity as for the display signal line 3-11. For this reason, during the time period t1b to t2b, a potential difference of −4 V is generated at the liquid crystal element 1-261 of the sub-pixel 261 of the pixel 206. Also, a potential difference of −3 V is generated at the liquid crystal element 1-262 of the sub-pixel 262. Also, a potential difference of −2 V is generated at the liquid crystal element 1-263 of the sub-pixel 233. For this reason, in the luminance of the sub-pixel 261 to 263, in accordance with the potential difference, the luminance of the sub-pixel 261 is higher than that of the sub-pixel 262, and also the luminance of the sub-pixel 262 is higher than that of the sub-pixel 263.

Next, the operation of the sub-pixel 251 to the sub-pixel 253 of the pixel 205 will be described. During the time period t1b to t2b, the potential difference between +4 V on the display signal line 3-12 and +2 V on the reference potential trunk line 4-13, this being +2 V, is generated at the liquid crystal element 1-251. Also, during the time period t1b to t2b, the potential difference between +4 V on the display signal line 3-12 and +1 V on the reference potential trunk line 4-12, this being +3 V, is generated at the liquid crystal element 1-252. Additionally, during the time period t1b to t2b, the potential difference between +4 V on the display signal line 3-12 and 0 V on the reference potential trunk line 4-11, this being +4 V, is generated at the liquid crystal element 1-253. As a result, in the luminance of the sub-pixels 251 to 253, in accordance with the potential difference, the luminance of the sub-pixel 253 is higher than that of the sub-pixel 252, and also the luminance of the sub-pixel 252 is higher than that of the sub-pixel 251.

In the present embodiment, although an example such as switching the potential on the reference potential trunk lines 4-11 to 4-13 for each frame has been described, the switching may be done for each pixel selection period. The pixel selection period is, for example, in the case of a display device driven by 60-Hz with a Full HD resolution (having 1080 scanning lines), every 1/60/1080 s. Additionally, if the pixel selection period is defined as 1H, the potential may be switched every 2 kH (where k is an integer of one or larger).

As described above, it is possible to cause generation of different potential differences between equivalent electrical capacitances of each liquid crystal element of three sub-pixels of one pixel, thereby obtaining a liquid crystal display device having a multipixel opposing matrix constitution. Also, because there is need to change the potential on each reference trunk line 4-11 and 4-13 only one time for one frame, a display device having low electrical power consumption can be achieved.

### Sixth Embodiment

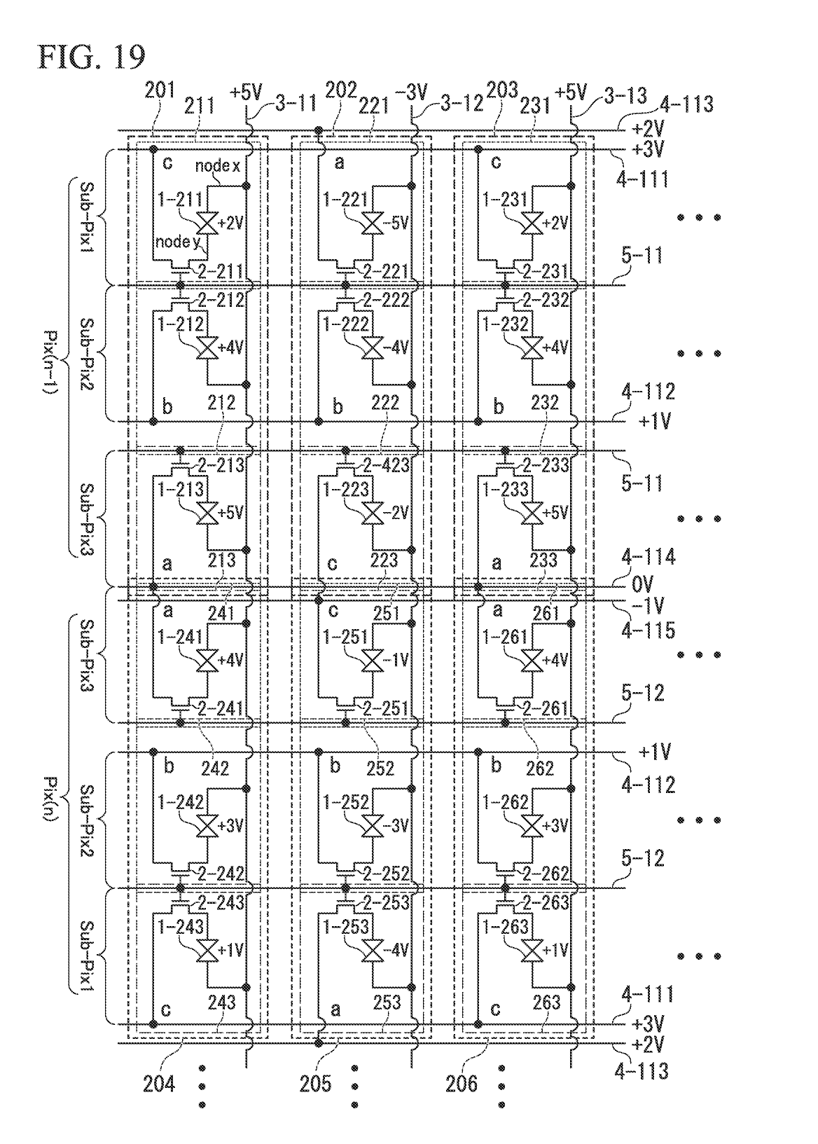

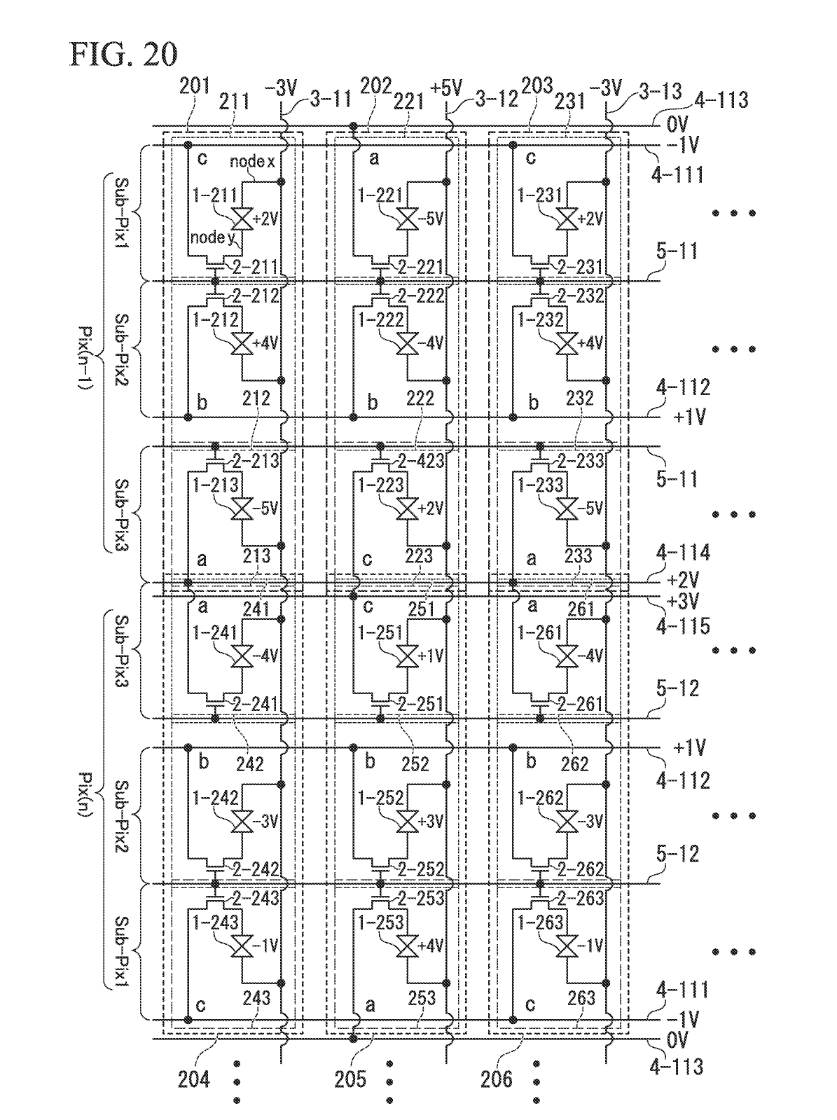

The sixth embodiment is another embodiment of a liquid crystal display device, which is constituted so that one pixel is made up of three sub-pixels. FIG. 19 is an equivalent circuit describing the operation at the Lth frame of the liquid crystal display device of the sixth embodiment having pixels (Pix(n−1), Pix(n)) that have three sub-pixels (Sub-Pix1, Sub-Pix2, Sub-Pix3). FIG. 20 is an equivalent circuit describing the operation at the (L+1) th frame of the liquid crystal display device of the sixth embodiment having pixel (Pix(n−1), Pix(n)) that have three sub-pixels (Sub-Pix1, Sub-Pix2, Sub-Pix3).

First, the constitution of the sub-pixels 211, 212 and 213 of the pixel 201 will be described. The gate terminals of the switching element 2-211, the switching element 2-212 and the switching element 2-213 are connected to the common scanning line 5-11. The source terminal of the switching element 2-211 is connected to the reference potential trunk line (first reference potential trunk line) 4-111. The drain terminal of the switching element 2-211 is connected to one end of the liquid crystal element 1-211, via the display electrode 11. The other end of the liquid crystal element 1-211 is connected to the display signal line (first display signal line) 3-11, via the transparent electrode 13. The source terminal of the switching element 2-212 is connected to the reference potential trunk line (second reference potential trunk line) 4-112. The drain terminal of the switching element 2-212 is connected to one end of the liquid crystal element 1-212, via the display electrode 11. The other end of the liquid crystal element 1-212 is connected to the display signal line 3-11, via the transparent electrode 13. Additionally, the source terminal of the switching element 2-213 is connected to the reference potential trunk line (third reference potential trunk line) 4-114. The drain terminal of the switching element 2-113 is connected to one end of the liquid crystal element 1-213, via the display electrode 11. The other end of the liquid crystal element 1-213 is connected to the display signal line 3-11, via the transparent electrode 13. The constitution of the pixel 203 is the same as the above.

Next, the constitution of the sub-pixels 221, 222, and 223 of the pixel 202 will be described. The gate terminals of the switching element 2-221, the switching element 2-222, and the switching element 2-223 are connected to the common scanning line 5-11. The source terminal of the switching element 2-221 is connected to the reference potential trunk line (first' reference potential trunk line) 4-113. The drain terminal of the switching element 2-221 is connected to one end of the liquid crystal element 1-221, via the display electrode 11. The other end of the liquid crystal element 1-221 is connected to the display signal line (second display signal line) 3-12, via the transparent electrode 13. The source terminal of the switching element 2-222 is connected to the reference potential trunk line (first reference potential trunk line) 4-112. The drain terminal of the switching element 2-222 is connected to one end of the liquid crystal element 1-222, via the display electrode 11. The other end of the liquid crystal element 1-222 is connected to the display signal line 3-12, via the transparent electrode 13. Additionally, the source terminal of the switching element 2-223 is connected to the reference potential trunk line (third' reference potential trunk line) 4-115. The drain terminal of the switching element 2-123 is connected to one end of the liquid crystal element 1-223, via the display electrode 11. The other end of the liquid crystal element 1-223 is connected to the display signal line 3-12, via the transparent electrode 13.

Next, the constitution of the sub-pixels 241, 242, and 243 of the pixel 204 will be described. The gate terminals of the switching elements 2-241, 2-242, and 2-243 are connected to the common scanning line 5-12. The source terminal of the switching element 2-241 is connected to the reference potential trunk line (third reference potential trunk line) 4-114. The drain terminal of the switching element 2-241 is connected to one end of the liquid crystal element 1-241, via the display electrode 11. The other end of the liquid crystal element 1-241 is connected to the display signal line 3-11, via the transparent electrode 13. The source terminal of the switching element 2-242 is connected to the reference potential trunk line (second reference potential trunk line) 4-112. The drain terminal of the switching element 2-242 is connected to one end of the liquid crystal element 1-242, via the display electrode 11. The other end of the liquid crystal element 1-242 is connected to the display signal line 3-11, via the transparent electrode 13. The source terminal of the switching element 2-243 is connected to the reference potential trunk line (first reference potential trunk line) 4-111. The drain terminal of the switching element 2-243 is connected to one end of the liquid crystal element 1-243, via the display electrode 11. The other end of the liquid crystal element 1-243 is connected to the display signal line 3-11, via the transparent electrode 13.

Next, the constitution of the sub-pixels 251, 252, and 253 of the pixel 205 will be described. The gate terminals of the switching elements 2-251, 2-252, and 2-253 are connected to the common scanning line 5-12. The source terminal of the switching element 2-251 is connected to the reference potential trunk line (third' reference potential trunk line) 4-115. The drain terminal of the switching element 2-251 is connected to one end of the liquid crystal element 1-251, via the display electrode 11. The other end of the liquid crystal element 1-251 is connected to the display signal line 3-12, via the transparent electrode 13. The source terminal of the switching element 2-252 is connected to the reference potential trunk line (second reference potential trunk line) 4-112. The drain terminal of the switching element 2-252 is connected to one end of the liquid crystal element 1-252, via the display electrode 11. The other end of the liquid crystal element 1-252 is connected to the display signal line 3-12, via the transparent electrode 13. Additionally, the source terminal of the switching element 2-253 is connected to the reference potential trunk line (first' reference potential trunk line) 4-113. The drain terminal of the switching element 2-253 is connected to one end of the liquid crystal element 1-253, via the display electrode 11. The other end of the liquid crystal element 1-253 is connected to the display signal line 3-12, via the transparent electrode 13. Constitutions of the pixels 206 are the same as the above.

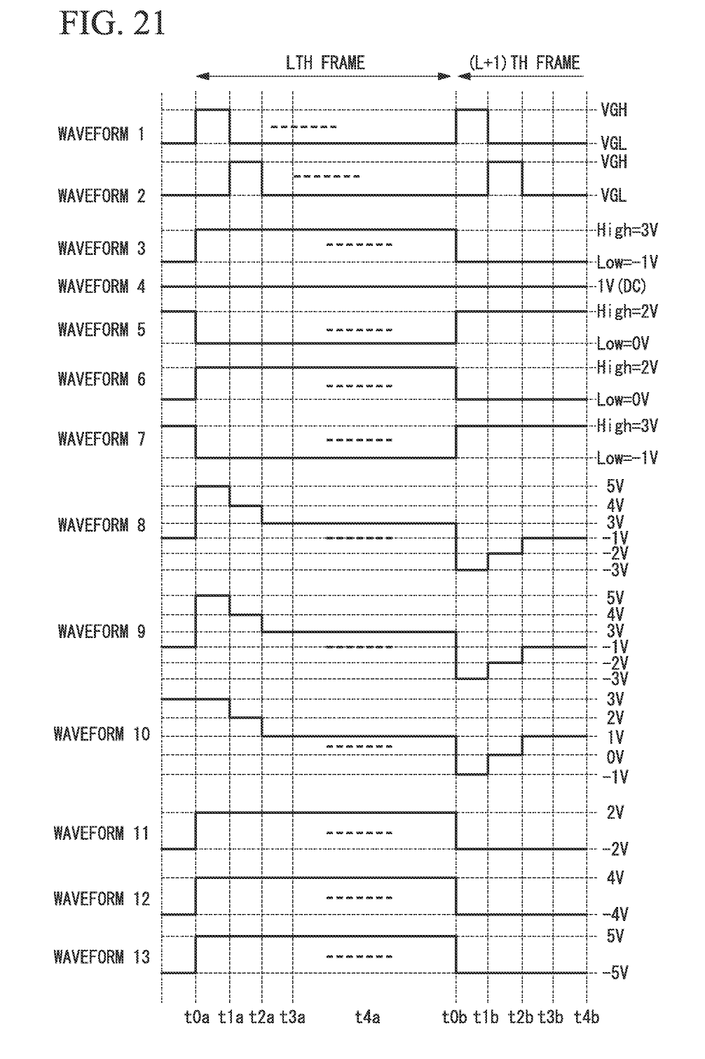

Next, the operation of the liquid crystal display device will be described, using FIG. 19 and FIG. 21. FIG. 21 is a timing diagram of the liquid crystal display device of the sixth embodiment at the Lth frame and at the (L+1) th frame.

The operation of each sub-pixel of the pixels 201 to 206 at the Lth frame (where L is a natural number 1 or larger) will be first described. The controller 12 controls the reference potential trunk line 4-111 to +3 V, controls the reference potential trunk line 4-112 to +1 V, controls the reference potential trunk line 4-113 to +2 V, controls the reference potential trunk line 4-114 to 0 V, and controls the reference potential trunk line 4-115 to −1 V (FIG. 21 at time t0a). That is, the controller 12 controls the magnitude of the potential to the relationship in which the potential on the reference potential trunk line (first reference potential trunk line) 4-111 is larger than that on the reference potential trunk line (second reference potential trunk line) 4-112 and also the potential on the reference potential trunk line (second reference potential trunk line) 4-112 is larger than that on the reference potential trunk line (third reference potential trunk line) 4-114. Additionally, the controller 12 controls the relationship in which the potential on the reference potential trunk line 4-111 is larger than that on the reference potential trunk line 4-113 and also the potential on the reference potential trunk line 4-114 is larger than that on the reference potential trunk line 4-115.

Next, the controller 12 controls the scanning line 5-11 to the high level between times t0a to t1a, thus placing the switching elements 2-211 to 2-213, 2-221 to 2-223, and 2-231 to 2-233 into the on state. For this reason, the controller 12 supplies signals of +5 V to the pixel 201 and the pixel 203 in the first row from the display signal lines 3-11 and 3-13, and supplies a signal of −3 V to the pixel 202 in the first row from the display signal line 3-12. The range of the signal on each display signal line 3-11 to 3-13 is, for example, +5 V to +1 V on the positive polarity side and −5 V to −1 V on the negative polarity side. Additionally, the controller 12 controls the scanning line 5-12 to the high level between times t1a to t2a, thus placing the switching elements 2-241 to 2-243, 2-251 to 2-253, and 2-261 to 2-263 into the on state. For this reason, the controller 12 supplies signals of +4 V to the pixels 204 and 206 in the second row from the display signal lines 3-11 and 3-13, and supplies a signal of −2 V to the pixel 205 in the second row from the display signal line 3-12. The signal levels on the display signal lines 3-11 and 3-12 shown in FIG. 21 are signal levels showing one example of operation. The switching of each switching element to the on state and potential difference generated in each liquid crystal element will be described below.

The operation of the sub-pixel 211 to the sub-pixel 213 of the pixel 201 will be described. During the time period t0a to t1a, the potential difference between +5 V on the display signal line 3-11 and +3 V on the reference potential trunk line 4-111, this being +2 V, is generated at the liquid crystal element 1-211. Also, during the time period t0a to t1a, the potential difference between +5 V on the display signal line 3-11 and +1 V on the reference potential trunk line 4-112, this being +4 V, is generated at the liquid crystal element 1-212. Additionally, during the time period t0a to t1a, the potential difference between +5 V on the display signal line 3-11 and 0 V on the reference potential trunk line 4-114, this being +5 V, is generated at the liquid crystal element 1-213. As a result, in the luminance of the sub-pixels 211 to 213, in accordance with the potential difference, the luminance of the sub-pixel 213 is higher than that of the sub-pixel 212, and also the luminance of the sub-pixel 212 is higher than that of the sub-pixel 211. In FIG. 19 and FIG. 20, the symbols a, b, and c represent the sequence of luminances, in which the luminance of a is higher than that of b, and also the luminance of b is higher than that of c (a>b>c).

The controller 12 supplies to the display signal line 3-13 a display signal having the same polarity as for the display signal line 3-11. For this reason, during the time period Ma to t1a, a potential difference of +2 V is generated at the liquid crystal element 1-231 of the sub-pixel 231 of the pixel 203. Also, a potential difference of +4 V is generated at the liquid crystal element 1-232 of the sub-pixel 232. Also, a potential difference of +5 V is generated at the liquid crystal element 1-233 of the sub-pixel 233. For this reason, in the luminance of the sub-pixel 231 to 233, in accordance with the potential difference, the luminance of the sub-pixel 233 is higher than that of the sub-pixel 232, and also the luminance of the sub-pixel 232 is higher than that of the sub-pixel 231.

Next, the operation of the sub-pixel 221 to the sub-pixel 223 of the pixel 202 will be described. During the time period t0a to t1a, the potential difference between −3 V on the display signal line 3-12 and +2 V on the reference potential trunk line 4-113, this being −5 V, is generated at the liquid crystal element 1-221. Also, during the time period t0a to t1a, the potential difference between −3 V on the display signal line 3-12 and +1 V on the reference potential trunk line 4-112, this being −4 V, is generated at the liquid crystal element 1-222. Additionally, during the time period t0a to t1a, the potential difference between −3 V on the display signal line 3-12 and −1 V on the reference potential trunk line 4-115, this being −2 V, is generated at the liquid crystal element 1-223. As a result, in the luminance of the sub-pixels 221 to 223, in accordance with the potential difference, the luminance of the sub-pixel 221 is higher than that of the sub-pixel 222, and also the luminance of the sub-pixel 222 is higher than that of the sub-pixel 223.

Next, the operation of the sub-pixel 241 to the sub-pixel 243 of the pixel 204 will be described. During the time period t1a to t2a, the potential difference between +4 V on the display signal line 3-11 and 0 V on the reference potential trunk line 4-114, this being +4 V, is generated at the liquid crystal element 1-241. Also, during the time period t1a to t2a, the potential difference between +4 V on the display signal line 3-11 and +1 V on the reference potential trunk line 4-112, this being +3 V, is generated at the liquid crystal element 1-242. Additionally, during the time period t1a to t2a, the potential difference between +4 V on the display signal line 3-11 and +3 V on the reference potential trunk line 4-111, this being +1 V, is generated at the liquid crystal element 1-243. As a result, in the luminance of the sub-pixels 241 to 243, in accordance with the potential difference, the luminance of the sub-pixel 241 is higher than that of the sub-pixel 242, and also the luminance of the sub-pixel 242 is higher than that of the sub-pixel 243.

The controller 12 supplies to the display signal line 3-13 a display signal having the same polarity as for the display signal line 3-11. For this reason, during the time period t 1a to t2a, a potential difference of +4 V is generated at the liquid crystal element 1-261 of the sub-pixel 261 of the pixel 206. Also, a potential difference of +3 V is generated at the liquid crystal element 1-262 of the sub-pixel 262. Also, a potential difference of +1 V is generated at the liquid crystal element 1-263 of the sub-pixel 263. For this reason, in the luminance of the sub-pixel 261 to 263, in accordance with the potential difference, the luminance of the sub-pixel 261 is higher than that of the sub-pixel 262, and also the luminance of the sub-pixel 262 is higher than that of the sub-pixel 263.

Next, the operation of the sub-pixel 251 to the sub-pixel 253 of the pixel 205 will be described. During the time period t1a to t2a, the potential difference between −2 V on the display signal line 3-12 and −1 V on the reference potential trunk line 4-115, this being −1 V, is generated at the liquid crystal element 1-251. Also, during the time period t1a to t2a, the potential difference between −2 V on the display signal line 3-12 and +1 V on the reference potential trunk line 4-112, this being −3 V, is generated at the liquid crystal element 1-252. Additionally, during the time period t1a to t2a, the potential difference between −2 V on the display signal line 3-12 and +2 V on the reference potential trunk line 4-113, this being −4 V, is generated at the liquid crystal element 1-253. As a result, in the luminance of the sub-pixels 251 to 253, in accordance with the potential difference, the luminance of the sub-pixel 253 is higher than that of the sub-pixel 252, and also the luminance of the sub-pixel 252 is higher than that of the sub-pixel 251.

Next, the operation at (L+1) th frame will be described, using FIG. 20 and FIG. 21. FIG. 21 shows the timing diagram of the (L+1) th frame after the time t0b.

In FIG. 21, the horizontal axis represents time, and the vertical axis represents electrical potential. The waveform 1 in FIG. 21 shows the time variations of the potential on the scanning line 5-11. The waveform 2 in FIG. 21 shows the time variations of the potential on the scanning line 5-12. The waveform 3 in FIG. 21 shows the time variations of the potential on the reference potential trunk line 4-111. The waveform 4 in FIG. 21 shows the time variations of the potential on the reference potential trunk line 4-112. The waveform 5 in FIG. 21 shows the time variations of the potential on the reference potential trunk line 4-113. The waveform 6 in FIG. 21 shows the time variations of the potential on the reference potential trunk line 4-114. The waveform 7 in FIG. 21 shows the time variations of the potential on the reference potential trunk line 4-115. The waveform 8 in FIG. 21 shows the time variations of the potential on the display signal line 3-11. The waveform 9 in FIG. 21 shows the time variations of the potential on the node X. The waveform 10 in FIG. 21 shows the time variations of the potential on the node Y. The waveform 11 in FIG. 21 shows the time variations of the potential between node X and the node Y (voltage applied to Sub-pix1). The waveform 12 in FIG. 21 shows the time variations of the voltage applied to the liquid crystal of sub-pix2. The waveform 13 in FIG. 21 shows the time variations of the voltage applied to the liquid crystal of sub-pix3.

During the vertical return interval, the controller 12 switches the polarity of the potentials on the display signal lines 3-11 to 3-13 to the polarity that is the reverse of the polarity in the Lth frame. Additionally, the controller 12 switches the potential on the reference potential trunk line 4-111 from +3 V to −1 V, switches the potential on the reference potential trunk line 4-113 from +2 V to 0 V, switches the potential on the reference potential trunk line 4-114 from 0 V to +2 V, and switches the potential on the reference potential trunk line 4-115 from −1 V to +3 V. That is, at the time of the Lth frame and the (L+1) the frame, the controller 12 switches the relationship between the magnitude of the potential between the reference potential trunk line (first reference potential trunk line) 4-111 and the reference potential trunk line (first' reference potential trunk line) 4-113 from the relationship in which the potential on the reference potential trunk line 4-111 is larger than that of the reference potential trunk line 4-113, to the relationship in which the potential on the reference potential trunk line 4-113 is larger than that of the reference potential trunk line 4-111. Also, at the time of the Lth frame and the (L+1)the frame, the controller 12 switches the relationship of the magnitude of the potential between the reference potential trunk line (third reference potential trunk line) 4-114 and the reference potential trunk line (third' reference potential trunk line) 4-115 from the relationship in which the potential on the reference potential trunk line 4-114 is larger than that of the reference potential trunk line 4-115, to the relationship in which the potential on the reference potential trunk line 4-115 is larger than that of the reference potential trunk line 4-114. Additionally, at the time of the Lth frame and the (L+1)the frame, the controller 12 controls the relationship of the magnitude of the potential between the reference potential trunk line (first reference potential trunk line) 4-111, the reference potential trunk line (second reference potential trunk line) 4-112 and the reference potential trunk line (third reference potential trunk line) 4-114 from the relationship in which the potential on the reference potential trunk line (first reference potential trunk line) 4-111 is larger than that of the reference potential trunk line (second reference potential trunk line) 4-112 and also the potential on the reference potential trunk line (second reference potential trunk line) 4-112 is larger than that of the reference potential trunk line (third reference potential trunk line) 4-114, to the relationship in which the potential on the reference potential trunk line (third reference potential trunk line) 4-114 is larger than that of the reference potential trunk line (second reference potential trunk line) 4-112 and further the potential on the reference potential trunk line (second reference potential trunk line) 4-112 is larger than that of the reference potential trunk line (first reference potential trunk line) 4-111.

Next, the controller 12 controls the scanning line 5-11 to the high level between times t0b to t1b, thus placing the switching elements 2-211 to 2-213, 2-221 to 2-223, and 2-231 to 2-233 into the on state. For this reason, the controller 12 supplies signals of −3 V to the pixels 201 and 203 in the first row from the display signal lines 3-11 and 3-13, and supplies a signal of +5 V to the pixel 202 in the first row from the display signal line 3-12. Additionally, the controller 12 controls the scanning line 5-12 to the high level between times t1b to t2b, thus placing the switching elements 2-241 to 2-243, 2-251 to 2-253, and 2-261 to 2-263 into the on state.

For this reason, the controller 12 supplies signals of −2 V to the pixels 204 and 206 in the second row from the display signal lines 3-11 and 3-13, and supplies a signal of +4 V to the pixel 205 in the second row from the display signal lines 3-12. The switching of each switching element to the on state and potential difference generated in each liquid crystal element will be described below.

The operation of the sub-pixel 211 to the sub-pixel 213 of the pixel 201 will be described. During the time period t0b to t1b, the potential difference between −3 V on the display signal line 3-11 and −1 V on the reference potential trunk line 4-111, this being −2 V, is generated at the liquid crystal element 1-211. Also, during the time period t0b to t1b, the potential difference between −3 V on the display signal line 3-11 and +1 V on the reference potential trunk line 4-112, this being −4 V, is generated at the liquid crystal element 1-212. Additionally, during the time period t0b to t1b, the potential difference between −3 V on the display signal line 3-11 and +2 V on the reference potential trunk line 4-114, this being −5 V, is generated at the liquid crystal element 1-213. As a result, in the luminance of the sub-pixels 211 to 213, in accordance with the potential differences, the luminance of the sub-pixel 213 is higher than that of the sub-pixel 212, and also the luminance of the sub-pixel 212 is higher than that of the sub-pixel 213.

The controller 12 supplies to the display signal line 3-13 a display signal having the same polarity as for the display signal line 3-11. For this reason, during the time period t0b to t1b, a potential difference of −3 V is generated at the liquid crystal element 1-231 of the sub-pixel 231 of the pixel 203. Also, a potential difference of −4 V is generated at the liquid crystal element 1-232 of the sub-pixel 232. Also, the potential difference of −6 V is generated at the liquid crystal element 1-233 of the sub-pixel 233. For this reason, in the luminance of the sub-pixel 231 to 233, in accordance with the potential difference, the luminance of the sub-pixel 233 is higher than that of the sub-pixel 232, and also the luminance of the sub-pixel 232 is higher than that of the sub-pixel 231.

Next, the operation of the sub-pixel 221 to the sub-pixel 223 of the pixel 202 will be described. During the time period t0b to t1b, the potential difference between +5 V on the display signal line 3-12 and 0 V on the reference potential trunk line 4-113, this being +5 V, is generated at the liquid crystal element 1-221. Also, during the time period t0b to t1b, the potential difference between +5 V on the display signal line 3-12 and +1 V on the reference potential trunk line 4-112, this being +4 V, is generated at the liquid crystal element 1-222. Additionally, during the time period t0b to t1b, the potential difference between +5 V on the display signal line 3-12 and +3 V on the reference potential trunk line 4-115, this being +2 V, is generated at the liquid crystal element 1-223. As a result, in the luminance of the sub-pixels 221 to 223, in accordance with the potential difference, the luminance of the sub-pixel 221 is higher than that of the sub-pixel 222, and also the luminance of the sub-pixel 222 is higher than that of the sub-pixel 223.

Next, the operation of the sub-pixel 241 to the sub-pixel 243 of the pixel 204 will be described. During the time period t1b to t2b, the potential difference between −2 V on the display signal line 3-11 and +2 V on the reference potential trunk line 4-115, this being −4 V, is generated at the liquid crystal element 1-241. Also, during the time period t1b to t2b, the potential difference between −2 V on the display signal line 3-11 and +1 V on the reference potential trunk line 4-112, this being −3 V, is generated at the liquid crystal element 1-242. Additionally, during the time period t1b to t2b, the potential difference between −2 V on the display signal line 3-11 and −1 V on the reference potential trunk line 4-111, this being −1 V, is generated at the liquid crystal element 1-243. As a result, in the luminance of the sub-pixels 241 to 243, in accordance with the potential difference, the luminance of the sub-pixel 241 is higher than that of the sub-pixel 242, and also the luminance of the sub-pixel 242 is higher than that of the sub-pixel 243.

The controller 12 supplies to the display signal line 3-13 a display signal having the same polarity as for the display signal line 3-11. For this reason, during the time period t1b to t2b, a potential difference of −5 V is generated at the liquid crystal element 1-261 of the sub-pixel 261 of the pixel 206. Also, a potential difference of −3 V is generated at the liquid crystal element 1-262 of the sub-pixel 262. Also, a potential difference of −2 V is generated at the liquid crystal element 1-263 of the sub-pixel 263. For this reason, in the luminance of the sub-pixel 261 to 263, in accordance with the potential difference, the luminance of the sub-pixel 261 is higher than that of the sub-pixel 262, and also the luminance of the sub-pixel 262 is higher than that of the sub-pixel 263.

Next, the operation of the sub-pixel 251 to the sub-pixel 253 of the pixel 205 will be described. During the time period t1b to t2b, the potential difference between +4 V on the display signal line 3-12 and +3 V on the reference potential trunk line 4-115, this being +1 V, is generated at the liquid crystal element 1-251. Also, during the time period t1b to t2b, the potential difference between +4 V on the display signal line 3-12 and +1 V on the reference potential trunk line 4-112, this being +3 V, is generated at the liquid crystal element 1-252. Additionally, during the time period t1b to t2b, the potential difference between +4 V on the display signal line 3-12 and 0 V on the reference potential trunk line 4-113, this being +4 V, is generated at the liquid crystal element 1-253. As a result, in the luminance of the sub-pixels 251 to 253, in accordance with the potential difference, the luminance of the sub-pixel 253 is higher than that of the sub-pixel 252, and also the luminance of the sub-pixel 252 is higher than that of the sub-pixel 251.

In the present embodiment, although an example such as switching the potential on the reference potential trunk lines 4-111 to 4-115 for each frame have been described, the switching may be done for each the pixel selection period. The pixel selection period is, for example, in the case of a display device driven by 60-Hz with a Full HD resolution (having 1080 scanning lines), every 1/60/1080 s. Additionally, if the pixel selection period is defined as 1H, the potential may be switched every 2 kH (where k is an integer of one or larger).

As described above, it is possible to cause generation different potential differences between equivalent electrical capacitances of each liquid crystal element of the three sub-pixels of one pixel, thereby obtaining a liquid crystal display device having a multipixel opposing matrix constitution. Also, because there is need to change the potential on each of the reference potential trunk lines 4-111 to 4-115 only one time for one frame a display device having low electrical power consumption can be achieved.

### Seventh Embodiment

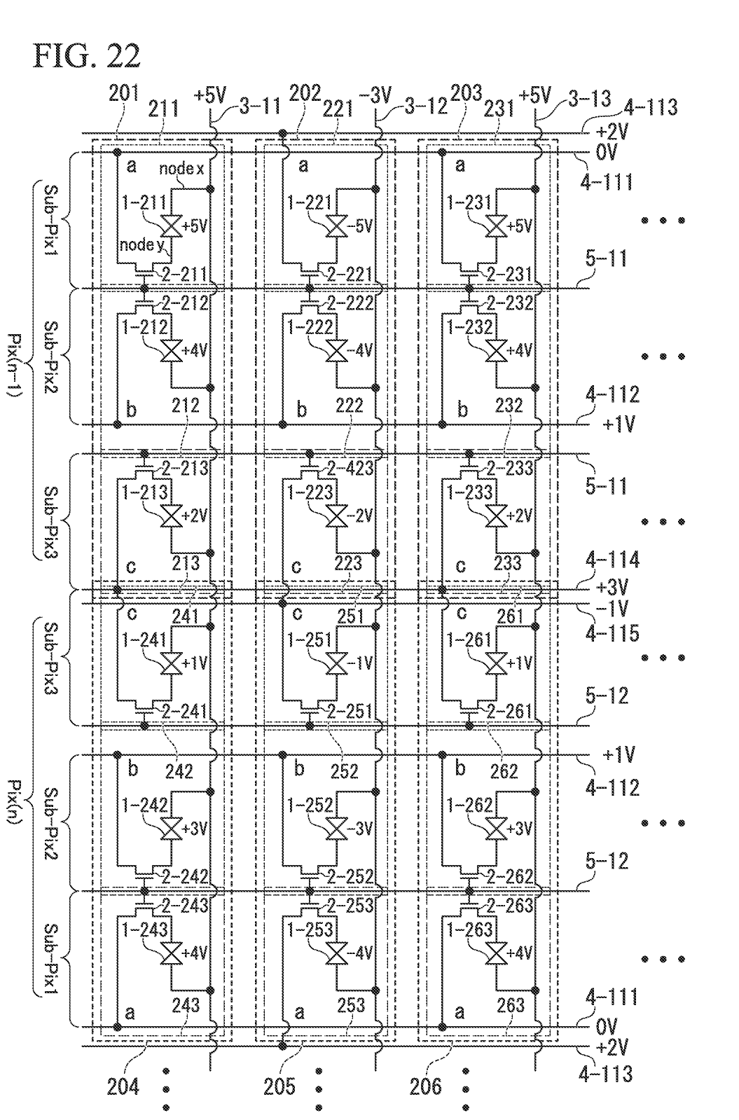

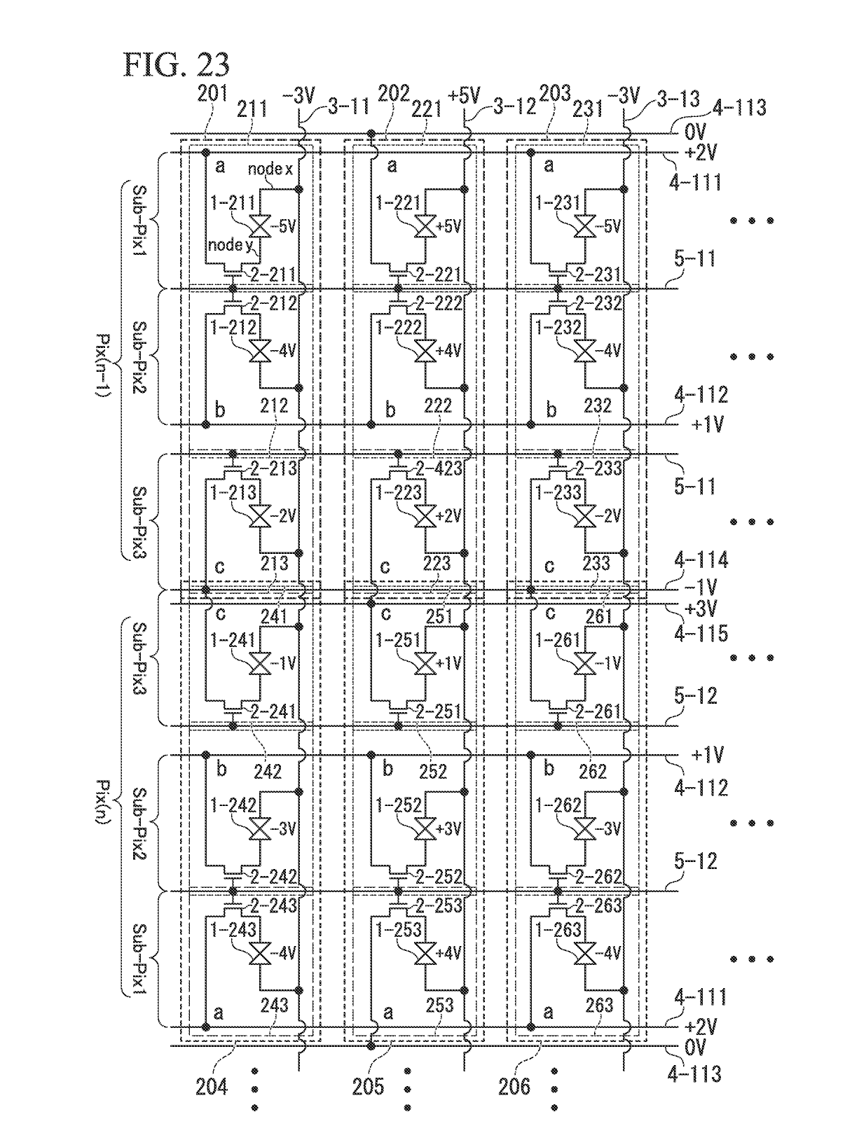

The seventh embodiment is another embodiment of a liquid crystal display device, which is constituted so that one pixel is made up of three sub-pixels. FIG. 22 is an equivalent circuit describing the operation at the Lth frame of the liquid crystal display device of the seventh embodiment having pixels (Pix(n−1), Pix(n)) that have three sub-pixels (Sub-Pix1, Sub-Pix2, Sub-Pix3). FIG. 23 is an equivalent circuit describing the operation at the (L+1) th frame of the liquid crystal display of the seventh embodiment device having pixels (Pix(n−1), Pix(n)) that have three sub-pixels (Sub-Pix1, Sub-Pix2, Sub-Pix3). The constitution is the same as in the sixth embodiment.

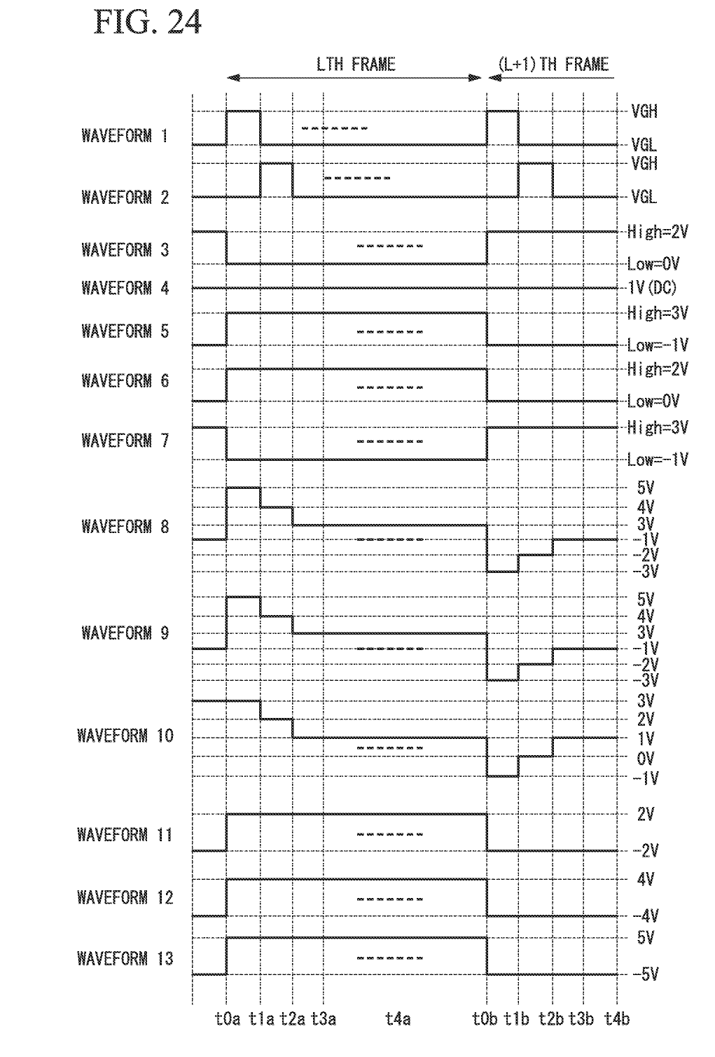

Next, the operation of the liquid crystal display device will be described, using FIG. 22 and FIG. 24. FIG. 24 is a timing diagram of the liquid crystal display device at the Lth frame and at the (L+1) th frame in the seventh embodiment.

The operation of each sub-pixel of the pixels 201 to 206 at the Lth frame (where L is a natural number 1 or larger) will be first described. The controller 12 controls the reference potential trunk line (first reference potential trunk line) 4-111 to 0 V, controls the reference potential trunk line (second reference potential trunk line) 4-112 to +1 V, controls the reference potential trunk line (first' reference potential trunk line) 4-113 to +2 V, controls the reference potential trunk line (third reference potential trunk line) 4-114 to +3 V, and controls the reference potential trunk line (third' reference potential trunk line) 4-115 to −1 V (FIG. 24 at time t0a). That is, the controller 12 controls the magnitude of the potential to the relationship in which the potential on the reference potential trunk line 4-113 is larger than that on the reference potential trunk line 4-111 and also the potential on the reference potential trunk line 4-114 is larger than that on the reference potential trunk line 4-115. Additionally, the controller 12 controls the relationship in which the potential on the reference potential trunk line 4-111 is larger than that on the reference potential trunk line 4-113 and also the potential on the reference potential trunk line 4-114 is larger than that on the reference potential trunk line 4-115.

Next, the controller 12 controls the scanning line 5-11 to the high level between times Ma to t1a, thus placing the switching elements 2-211 to 2-213, 2-221 to 2-223, and 2-231 to 2-233 into the on state. For this reason, the controller 12 supplies signals of +5 V to the pixel 201 and the pixel 203 in the first row from the display signal lines 3-11 and 3-13, and supplies a signal of −3 V to the pixel 202 in the first row from the display signal line 3-12. The range of the signal on each display signal line 3-11 to 3-13 is, for example, +5 V to +1 V on the positive polarity side and −5 V to −1 V on the negative polarity side. Additionally, the controller 12 controls the scanning line 5-12 to the high level between times t1a to t2a, thus placing the switching elements 2-241 to 2-243, 2-251 to 2-253, and 2-261 to 2-263 into the on state. For this reason, the controller 12 supplies signals of +4 V to the pixels 204 and 206 in the second row from the display signal lines 3-11 and 3-13, and supplies a signal of −2 V to the pixel 205 in the second row from the display signal line 3-12. The signal levels on the display signal line 3-11 and display signal line 3-12 shown in FIG. 24 are signal levels showing one example of operation. The switching of each switching element to the on state and potential difference generated in each liquid crystal element will be described below.

The operation of the sub-pixel 211 to the sub-pixel 213 of the pixel 201 will be described. During the time period t0a to t1a, the potential difference between +5 V on the display signal line 3-11 and 0 V on the reference potential trunk line 4-111, this being +5 V, is generated at the liquid crystal element 1-211. Also, during the time period t0a to t1a, the potential difference between +5 V on the display signal line 3-11 and +1 V on the reference potential trunk line 4-112, this being +4 V, is generated at the liquid crystal element 1-212. Additionally, during the time period t0a to t1a, the potential difference between +5 V on the display signal line 3-11 and +3 V on the reference potential trunk line 4-114, this being +2 V, is generated at the liquid crystal element 1-213. As a result, in the luminance of the sub-pixels 211 to 213, in accordance with the potential difference, the luminance of the sub-pixel 211 is higher than that of the sub-pixel 212, and also the luminance of the sub-pixel 212 is higher than that of the sub-pixel 213. In FIG. 22 and FIG. 23, the symbols a, b, and c represent the sequence of luminances, in which the luminance of a is higher than that of b, and also the luminance of b is higher than that of c (a>b>c).

The controller 12 supplies to the display signal line 3-13 a display signal having the same polarity as for the display signal line 3-11. For this reason, during the time period Ma to t1a, a potential difference of +5 V is generated at the liquid crystal element 1-231 of the sub-pixel 231 of the pixel 203. Also, a potential difference of +4 V is generated at the liquid crystal element 1-232 of the sub-pixel 232. Also, a potential difference of −2 V is generated at the liquid crystal element 1-233 of the sub-pixel 233. For this reason, in the luminance of the sub-pixel 231 to 233, in accordance with the potential difference, the luminance of the sub-pixel 231 is higher than that of the sub-pixel 232, and also the luminance of the sub-pixel 232 is higher than that of the sub-pixel 233.

Next, the operation of the sub-pixel 221 to the sub-pixel 223 of the pixel 202 will be described. During the time period t0a to t1a, the potential difference between −3 V on the display signal line 3-12 and +2 V on the reference potential trunk line 4-113, this being −5 V, is generated at the liquid crystal element 1-221. Also, during the time period t0a to t1a, the potential difference between −3 V on the display signal line 3-12 and +1 V on the reference potential trunk line 4-112, this being −3 V, is generated at the liquid crystal element 1-222. Additionally, during the time period t0a to t1a, the potential difference between −3 V on the display signal line 3-12 and −1 V on the reference potential trunk line 4-115, this being −2 V, is generated at the liquid crystal element 1-223. As a result, in the luminance of the sub-pixels 221 to 223, in accordance with the potential difference, the luminance of the sub-pixel 221 is higher than that of the sub-pixel 222, and also the luminance of the sub-pixel 222 is higher than that of the sub-pixel 223.

Next, the operation of the sub-pixel 241 to the sub-pixel 243 of the pixel 204 will be described. During the time period t1a to t2a, the potential difference between +4 V on the display signal line 3-11 and +3 V on the reference potential trunk line 4-114, this being +1 V, is generated at the liquid crystal element 1-241. Also, during the time period t1a to t2a, the potential difference between +4 V on the display signal line 3-11 and +1 V on the reference potential trunk line 4-112, this being +3 V, is generated at the liquid crystal element 1-242. Additionally, during the time period t1a to t2a, the potential difference between +4 V on the display signal line 3-11 and 0 V on the reference potential trunk line 4-111, this being +4 V, is generated at the liquid crystal element 1-243. As a result, in the luminance of the sub-pixels 241 to 243, in accordance with the potential difference, the luminance of the sub-pixel 243 is higher than that of the sub-pixel 242, and also the luminance of the sub-pixel 242 is higher than that of the sub-pixel 241.

The controller 12 supplies to the display signal line 3-13 a display signal having the same polarity as for the display signal line 3-11. For this reason, during the time period t 1a to t2a, a potential difference of +1 V is generated at the liquid crystal element 1-261 of the sub-pixel 261 of the pixel 206. Also, a potential difference of +3 V is generated at the liquid crystal element 1-262 of the sub-pixel 262. Also, a potential difference of +4 V is generated at the liquid crystal element 1-263 of the sub-pixel 263. For this reason, in the luminance of the sub-pixel 261 to 263, in accordance with the potential difference, the luminance of the sub-pixel 263 is higher than that of the sub-pixel 262, and also the luminance of the sub-pixel 262 is higher than that of the sub-pixel 261.

Next, the operation of the sub-pixel 251 to the sub-pixel 253 of the pixel 205 will be described. During the time period t1a to t2a, the potential difference between −2 V on the display signal line 3-12 and −1 V on the reference potential trunk line 4-115, this being −1 V, is generated at the liquid crystal element 1-251. Also, during the time period t1a to t2a, the potential difference between −2 V on the display signal line 3-12 and +1 V on the reference potential trunk line 4-112, this being −3 V, is generated at the liquid crystal element 1-252. Additionally, during the time period t1a to t2a, the potential difference between −2 V on the display signal line 3-12 and +3 V on the reference potential trunk line 4-113, this being −4 V, is generated at the liquid crystal element 1-253. As a result, in the luminance of the sub-pixels 251 to 253, in accordance with the potential difference, the luminance of the sub-pixel 253 is higher than that of the sub-pixel 252, and also the luminance of the sub-pixel 252 is higher than that of the sub-pixel 251.

Next, the operation at (L+1) th frame will be described, using FIG. 23 and FIG. 24. FIG. 24 shows the timing diagram of the (L+1) th frame after the time t0b.

In FIG. 24, the horizontal axis represents time, and the vertical axis represents electrical potential. The waveform 1 in FIG. 24 shows the time variations of the potential on the scanning line 5-11. The waveform 2 in FIG. 24 shows the time variations of the potential on the scanning line 5-12. The waveform 3 in FIG. 24 shows the time variations of the potential on the reference potential trunk line 4-111. The waveform 4 in FIG. 24 shows the time variations of the potential on the reference potential trunk line 4-112. The waveform 5 in FIG. 24 shows the time variations of the potential on the reference potential trunk line 4-113. The waveform 6 in FIG. 24 shows the time variations of the potential on the reference potential trunk line 4-114. The waveform 7 in FIG. 24 shows the time variations of the potential on the reference potential trunk line 4-115. The waveform 8 in FIG. 24 shows the time variations of the potential on the display signal line 3-11. The waveform 9 in FIG. 24 shows the time variations of the potential on the node X. The waveform 10 in FIG. 24 shows the time variations of the potential on the node Y. The waveform 11 in FIG. 24 shows the time variations of the potential between node X and the node Y (voltage applied to Sub-pix1). The waveform 12 in FIG. 24 shows the time variations of the voltage applied to the liquid crystal of sub-pix2. The waveform 13 in FIG. 24 shows the time variations of the voltage applied to the liquid crystal of sub-pix3.

During the vertical return interval, the controller 12 switches the polarity of the potentials on the display signal lines 3-11 to 3-13 to the polarity that is the reverse of the polarity in the Lth frame. Additionally, the controller 12 switches the potential on the reference potential trunk line 4-111 from 0 V to +2 V, switches the potential on the reference potential trunk line 4-113 from +2 V to 0 V, switches the potential on the reference potential trunk line 4-114 from +3 V to 0 V, and switches the potential on the reference potential trunk line 4-115 from −1 V to +3 V. That is, the controller 12 switches the relationship of the magnitude of the potential between the reference potential trunk line 4-111 and the reference potential trunk line 4-113 from the relationship in which the potential on the reference potential trunk line 4-113 is larger than that of the reference potential trunk line 4-111, to the relationship in which the potential on the reference potential trunk line 4-111 is larger than that of the reference potential trunk line 4-113. Also, at the time of the Lth frame and the (L+1)the frame, the controller 12 switches the relationship of the magnitude of the potential between the reference potential trunk line 4-114 and the reference potential trunk line 4-115 from the relationship in which the potential on the reference potential trunk line 4-114 is larger than that of the reference potential trunk line 4-115, to the relationship in which the potential on the reference potential trunk line 4-115 is larger than that of the reference potential trunk line 4-114. Additionally, when signals that have the positive polarity and the negative polarity are supplied from the display signal lines 3-1 to 3-3 to each of the liquid crystal elements, for the purpose of achieving uniform absolute value of the potential difference generated for each frame in each of liquid crystal elements, the potential on the reference potential trunk line 4-2 is switched for each frame.

Next, the controller 12 controls the scanning line 5-11 to the high level between times t0b to t1b, thus placing the switching elements 2-211 to 2-213, 2-221 to 2-223, and 2-231 to 2-233 into the on state. For this reason, the controller 12 supplies signals of −3 V to the pixel 201 and pixel 203 in the first row from the display signal lines 3-11 and 3-13, and supplies a signal of +5 V to the pixel 202 in the first row from the display signal line 3-12. Additionally, the controller 12 controls the scanning line 5-12 to the high level between times t1b to t2b, thus placing the switching elements 2-241 to 2-243, 2-251 to 2-253, and 2-261 to 2-263 into the on state.

For this reason, the controller 12 supplies signals of −2 V to the pixel 204 and pixel 206 in the second row from the display signal line 3-11 and display signal line 3-13, and supplies a signal of +4 V to the pixel 205 in the second row from the display signal lines 3-12. The switching of each switching element to the on state and potential difference generated in each liquid crystal element will be described below.

The operation of the sub-pixel 211 to the sub-pixel 213 of the pixel 201 will be described. During the time period t0b to t1b, the potential difference between −3 V on the display signal line 3-11 and +2 V on the reference potential trunk line 4-111, this being −5 V, is generated at the liquid crystal element 1-211. Also, during the time period t0b to t1b, the potential difference between −3 V on the display signal line 3-11 and +1 V on the reference potential trunk line 4-112, this being −4 V, is generated at the liquid crystal element 1-212. Additionally, during the time period t0b to t1b, the potential difference between −3 V on the display signal line 3-11 and −1 V on the reference potential trunk line 4-114, this being −2 V, is generated at the liquid crystal element 1-213. As a result, in the luminance of the sub-pixels 211 to 213, in accordance with the potential differences, the luminance of the sub-pixel 211 is higher than that of the sub-pixel 212, and also the luminance of the sub-pixel 212 is higher than that of the sub-pixel 213.

The controller 12 supplies to the display signal line 3-13 a display signal having the same polarity as for the display signal line 3-11. For this reason, during the time period t0b to t1b, a potential difference of −5 V is generated at the liquid crystal element 1-231 of the sub-pixel 231 of the pixel 203. Also, a potential difference of −4 V is generated at the liquid crystal element 1-232 of the sub-pixel 232. Also, a potential difference of −2 V is generated at the liquid crystal element 1-233 of the sub-pixel 233. For this reason, in the luminance of the sub-pixel 231 to 233, in accordance with the potential difference, the luminance of the sub-pixel 231 is higher than that of the sub-pixel 232, and also the luminance of the sub-pixel 232 is higher than that of the sub-pixel 233.

Next, the operation of the sub-pixel 221 to the sub-pixel 223 of the pixel 202 will be described. During the time period t0b to t1b, the potential difference between +5 V on the display signal line 3-12 and 0 V on the reference potential trunk line 4-113, this being +5 V, is generated at the liquid crystal element 1-221. Also, during the time period t0b to t1b, the potential difference between +5 V on the display signal line 3-12 and +1 V on the reference potential trunk line 4-112, this being +4 V, is generated at the liquid crystal element 1-222. Additionally, during the time period t0b to t1b, the potential difference between +5 V on the display signal line 3-12 and +3 V on the reference potential trunk line 4-115, this being +2 V, is generated at the liquid crystal element 1-223. As a result, in the luminance of the sub-pixels 221 to 223, in accordance with the potential difference, the luminance of the sub-pixel 221 is higher than that of the sub-pixel 222, and also the luminance of the sub-pixel 222 is higher than that of the sub-pixel 223.

Next, the operation of the sub-pixel 241 to the sub-pixel 243 of the pixel 204 will be described. During the time period t1b to t2b, the potential difference between −2 V on the display signal line 3-11 and −1 V on the reference potential trunk line 4-114, this being −1 V, is generated at the liquid crystal element 1-241. Also, during the time period t1b to t2b, the potential difference between −2 V on the display signal line 3-11 and +1 V on the reference potential trunk line 4-112, this being −3 V, is generated at the liquid crystal element 1-242. Additionally, during the time period t1b to t2b, the potential difference between −2 V on the display signal line 3-11 and +2 V on the reference potential trunk line 4-111, this being −4 V, is generated at the liquid crystal element 1-243. As a result, in the luminance of the sub-pixels 241 to 243, in accordance with the potential difference, the luminance of the sub-pixel 243 is higher than that of the sub-pixel 242, and also the luminance of the sub-pixel 242 is higher than that of the sub-pixel 241.

The controller 12 supplies to the display signal line 3-13 a display signal having the same polarity as for the display signal line 3-11. For this reason, during the time period t1b to t2b, a potential difference of −1 V is generated at the liquid crystal element 1-261 of the sub-pixel 261 of the pixel 206. Also, a potential difference of −3 V is generated at the liquid crystal element 1-262 of the sub-pixel 262. Also, a potential difference of +4 V is generated at the liquid crystal element 1-263 of the sub-pixel 233. For this reason, in the luminance of the sub-pixel 261 to 263, in accordance with the potential difference, the luminance of the sub-pixel 263 is higher than that of the sub-pixel 262, and also the luminance of the sub-pixel 262 is higher than that of the sub-pixel 261.

Next, the operation of the sub-pixel 251 to the sub-pixel 253 of the pixel 205 will be described. During the time period t1b to t2b, the potential difference between +4 V on the display signal line 3-12 and +3 V on the reference potential trunk line 4-115, this being +1 V, is generated at the liquid crystal element 1-251. Also, during the time period t1b to t2b, the potential difference between +4 V on the display signal line 3-12 and +1 V on the reference potential trunk line 4-112, this being +3 V, is generated at the liquid crystal element 1-252. Additionally, during the time period t1b to t2b, the potential difference between +4 V on the display signal line 3-12 and 0 V on the reference potential trunk line 4-113, this being +4 V, is generated at the liquid crystal element 1-253. As a result, in the luminance of the sub-pixels 251 to 253, in accordance with the potential difference, the luminance of the sub-pixel 253 is higher than that of the sub-pixel 252, and also the luminance of the sub-pixel 252 is higher than that of the sub-pixel 251.

In the present embodiment, although an example such as switching the potential on the reference potential trunk lines 4-111 to 4-115 for each frame has been described, the switching may be done for each pixel selection period. The pixel selection period is, for example, in the case of a display device driven by 60-Hz with a Full HD resolution (having 1080 scanning lines), every 1/60/1080 s. Additionally, if the pixel selection period is defined as 1H, the potential may be switched every 2 kH (where k is an integer of one or larger).

As described above, it is possible to cause generation of different potential differences between equivalent electrical capacitances of each of the liquid crystal element of three sub-pixels of each pixel, thereby obtaining a liquid crystal display device having a multipixel opposing matrix constitution. Also, according to the seventh embodiment, as shown in FIG. 22 and FIG. 23, the sequences in the row directions of bright pixels (of two sub-pixels, the one having a larger absolute value of the potential differences applied to both ends of the liquid crystal element) and of dark pixels (of two sub-pixels, the one having a smaller absolute value of the potential differences applied to both ends of the liquid crystal element) can be disposed in parallel with respect to the scanning line 5-11. For this reason, in addition to the effect of the second embodiment, the display characteristics can be improved. Also, because there is need to change the potential on each of the reference potential trunk lines 4-111 and 4-115 only one time for one frame, a display device having low electrical power consumption can be achieved.

### Eighth Embodiment

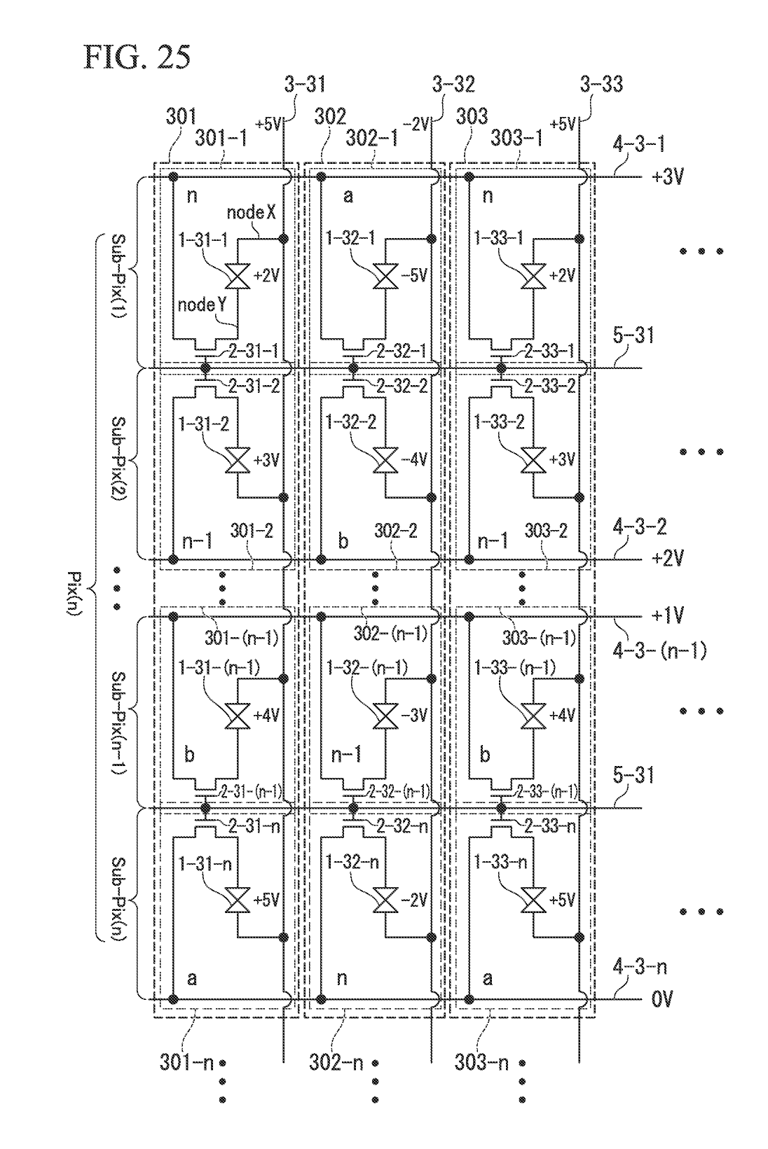

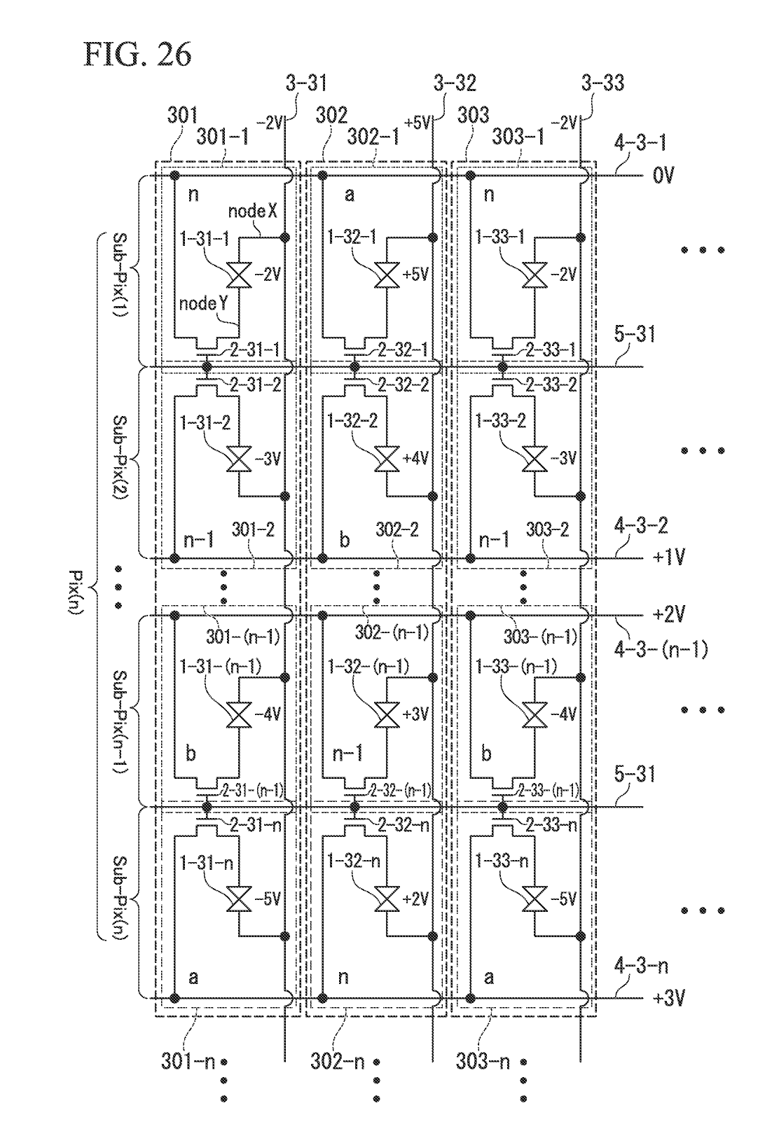

The eighth embodiment is an embodiment of a liquid crystal display device, which is constituted so that one pixel is made up of n (even) sub-pixels. FIG. 25 is an equivalent circuit describing the operation at the Lth frame of the liquid crystal display device of the eighth embodiment having a pixel (n) that has n sub-pixels (Sub-Pix(1), Sub-Pix(2), . . . , Sub-Pix(n−1), and Sub-Pix(n)). FIG. 26 is an equivalent circuit describing the operation at the (L+1) th frame of the liquid crystal display device in the eighth embodiment having a pixel (Pix(n)) that has n sub-pixels (Sub-Pix(1), Sub-Pix(2), . . . , Sub-Pix(n−1), and Sub-Pix(n)). As shown in FIG. 25, the liquid crystal display device in the eighth embodiment has pixels 301 to 303 adjacent in the row direction. The pixels 301 to 303 further have n sub-pixels. The pixel 301 has, with respect to the column direction, the sub-pixel 301-1 to the sub-pixel 301-n, disposed in that sequence. The pixel 302 has, with respect to the column direction, the sub-pixel 302-1 to the sub-pixel 302-n, disposed in that sequence.

The constitution of the sub-pixels 301-1 to the sub-pixels 301-n of the pixel 301 will first be described. The gate terminals of the switching element 2-31-1 to 2-31-n, are connected to the common scanning line 5-31. The source terminal of the switching element 2-31-1 is connected to the reference potential trunk line 4-3-1. The drain terminal of the switching element 2-31-1 is connected to one end of the liquid crystal element 1-31-1, via the display electrode 11. The other end of the liquid crystal element 1-31-1 is connected to the display signal line (first display signal line) 3-31, via the transparent electrode 13. The source terminal of the switching element 2-31-2 is connected to the reference potential trunk line 4-3-2. The drain terminal of the switching element 2-31-2 is connected to one end of the liquid crystal element 1-31-2, via the display electrode 11. The other end of the liquid crystal element 1-31-2 is connected to the display signal line 3-31, via the transparent electrode 13. Additionally, the source terminal of the switching element 2-31-(n−1) is connected to the reference potential trunk line 4-3-(n−1). The drain terminal of the switching element 2-31-(n−1) is connected to one end of the liquid crystal element 1-31-(n−1), via the display electrode 11. The other end of the liquid crystal element 1-31-(n−1) is connected to the display signal line 3-31, via the transparent electrode 13. Additionally, the source terminal of the switching element 2-31-n is connected to the reference potential trunk line 4-3-n. The drain terminal of the switching element 2-31-n is connected to one end of the liquid crystal element 1-31-n, via the display electrode 11, and the other end of the liquid crystal element 1-31-n is connected to the display signal line 3-31, via the transparent electrode 13.

Next, the constitution of the sub-pixels 302-1 to 302-2 of the pixel 202 will be described. The gate terminals of the switching elements 2-32-1 to 2-32-n are connected to the common scanning line 5-31. The source terminal of the switching element 2-32-1 is connected to the reference potential trunk line 4-3-1. The drain terminal of the switching element 2-32-1 is connected to one end of the liquid crystal element 1-32-1, via the display electrode 11. The other end of the liquid crystal element 1-32-1 is connected to the display signal line (second display signal line) 3-32, via the transparent electrode 13. The source terminal of the switching element 2-32-2 is connected to the reference potential trunk line 4-3-2. The drain terminal of the switching element 2-32-2 is connected to one end of the liquid crystal element 1-32-2, via the display electrode 11. The other end of the liquid crystal element 1-32-2 is connected to the display signal line 3-32, via the transparent electrode 13. Additionally, the source terminal of the switching element 2-32-(n−1) is connected to the reference potential trunk line 4-3-(n−1). The drain terminal of the switching element 2-32-(n−1) is connected to one end of the liquid crystal element 1-32-(n−1), via the display electrode 11. The other end of the liquid crystal element 1-32-(n−1) is connected to the display signal line 3-32, via the transparent electrode 13. Additionally, the source terminal of the switching element 2-32-n is connected to the reference potential trunk line 4-3-n. The drain terminal of the switching element 2-32-n is connected to one end of the liquid crystal element 1-32-n, via the display electrode 11. The other end of the liquid crystal element 1-32-n is connected to the display signal line 3-32, via the transparent electrode 13.

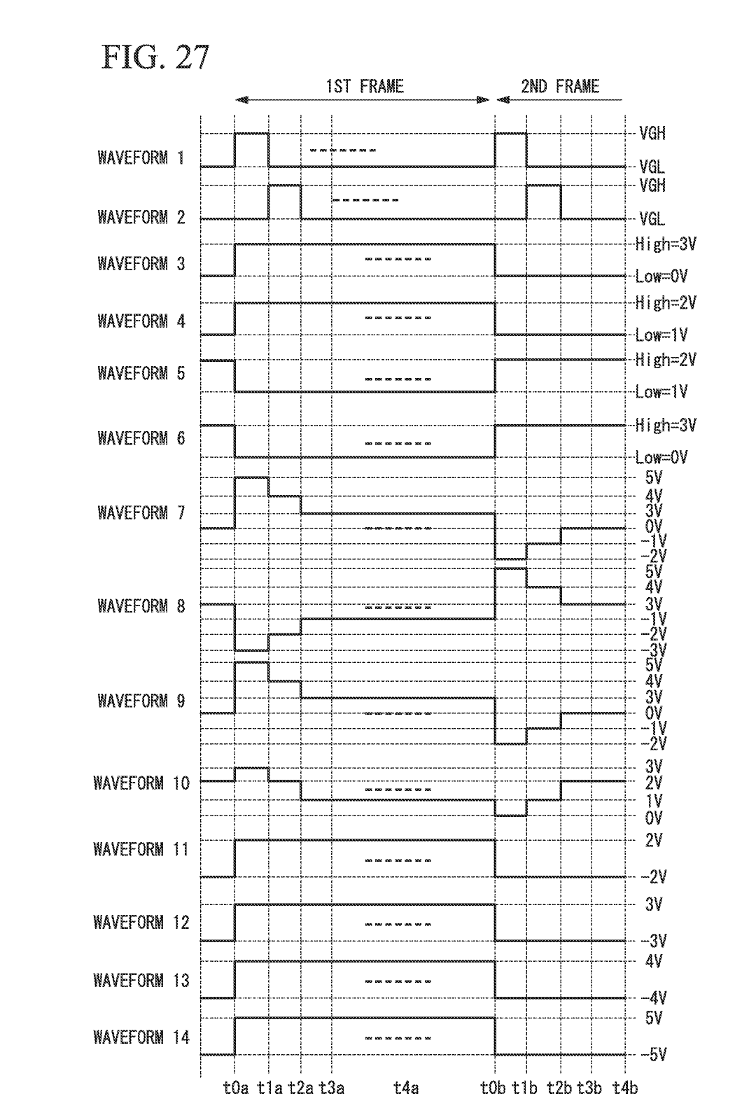

Next, the operation of the liquid crystal display device will be described, using FIG. 25 and FIG. 27. FIG. 27 is a timing diagram of the liquid crystal display device of the eighth embodiment at the Lth frame and at the (L+1) th frame.

The operation of each sub-pixel of the pixels 301 to 303 at the Lth frame (where L is a natural number 1 or larger) will first be described. The controller 12 controls the reference potential trunk line 4-3-1 to +3 V, controls the reference potential trunk line 4-3-2 to +2 V, controls the reference potential trunk line 4-3-(n−1) to +1 V, and controls the reference potential trunk line 4-3-n to 0 V (FIG. 27 at time t0a). That is, the controller 12 controls the magnitude of the potential to the relationship (reference potential trunk line 4-3-1>reference potential trunk line 4-3-2> . . . >reference potential trunk line 4-3-(n−1)>reference potential trunk line 4-3-n), in which the potential on the reference potential trunk line 4-3-1 is larger than that on the reference potential trunk line 4-3-2 and also the potential on the reference potential trunk line 4-3-2 is larger than that on the reference potential trunk line 4-3-(n−1), and further the potential on the reference potential trunk line 4-3-(n−1) is larger than that on the reference potential trunk line 4-3-n. The controller 12 supplies signals of +5 V to the pixel 301 and the pixel 303 from the display signal lines 3-31 and 3-33, and supplies a signal of −2 V to the pixel 302 from the display signal line 3-32. The range of the signal on each display signal line 3-11 to 3-13 is, for example, +5 V to +1 V on the positive polarity side and −5 V to −1 V on the negative polarity side.

Next, the controller 12 controls the scanning line 5-31 to the high level between times t0a to t1a, thus placing the switching elements 2-31-1 to 2-31-n, 2-32-1 to 2-32-n, and 2-33-1 to 2-33-n into the on state. Also, the signal levels on the display signal line 3-31 and display signal line 3-32 shown in FIG. 27 are signal levels showing one example of operation. The switching of each switching element to the on state and potential difference generated in each liquid crystal element will be described below.

The operation of the sub-pixel 301-1 to the sub-pixel 301-n of the pixel 301 will be described. During the time period t0a to t1a, the potential difference between +5 V on the display signal line 3-31 and +3 V on the reference potential trunk line 4-3-1, this being +2 V, is generated at the liquid crystal element 1-31-1 (equivalent electrical capacitance). Also, during the time period t0a to t1a, the potential difference between +5 V on the display signal line 3-31 and +2 V on the reference potential trunk line 4-3-2, this being +3 V, is generated at the liquid crystal element 1-31-2 (equivalent electrical capacitance). Additionally, during the time period t0a to t1a, the potential difference between +5 Von the display signal line 3-31 and +1 Von the reference potential trunk line 4-3-(n−1), this being +4 V, is generated at the liquid crystal element 1-31-(n−1) (equivalent electrical capacitance). Additionally, during the time period t0a to t1a, the potential difference between +5 V on the display signal line 3-31 and 0 V on the reference potential trunk line 4-3-n, this being +5 V, is generated at the liquid crystal element 1-31-n (equivalent electrical capacitance). As a result, in the luminance of the sub-pixels 301-1 to 301-n, in accordance with the potential difference, the luminance of the sub-pixel 301-n is higher than that of the sub-pixel 301-(n−1), also the luminance of the sub-pixel 301-(n−1) is higher than that of the sub-pixel 301-2, and further the luminance of the sub-pixel 301-2 is higher than that of the sub-pixel 301-1. In FIG. 25 and FIG. 26, the symbols a, b, . . . , n−1, and n represent the sequence of luminances, in which the luminance of a is higher than that of b, also the luminance of b is higher than that of n−1 and also the luminance of n−1 is higher than that of n (a>b> . . . >n−1>n).

The controller 12 supplies to the display signal line 3-33 a display signal having the same polarity as for the display signal line 3-31. For this reason, during the time period t0a to t1a, a potential difference of +2 V is generated at the liquid crystal element 1-33-1 (equivalent electrical capacitance) of the sub-pixel 303-1 of the pixel 303. Also, a potential difference of +3 V is generated at the liquid crystal element 1-33-2 (equivalent electrical capacitance) of the sub-pixel 303-2. Also, a potential difference of +4 V is generated at the liquid crystal element 1-33-(n−1) (equivalent electrical capacitance) of the sub-pixel 303-(n−1). Also, a potential difference of +5 V is generated at the liquid crystal element 1-33-n (equivalent electrical capacitance) of the sub-pixel 303-n. For this reason, in the luminance of the sub-pixel 303-1 to 303-n, in accordance with the potential difference, the luminance of the sub-pixel 303-n is higher than that of the sub-pixel 303-(n−1), also the luminance of the sub-pixel 303-(n−1) is higher than that of the sub-pixel 303-2, and also the luminance of the sub-pixel 303-2 is higher than that of the sub-pixel 303-1.

Next, the operation of the sub-pixel 302-1 to the sub-pixel 302-n of the pixel 302 will be described. During the time period t0a to t1a, the potential difference between −2 V on the display signal line 3-32 and +3 V on the reference potential trunk line 4-3-1, this being −5 V, is generated at the liquid crystal element 1-32-1 (equivalent electrical capacitance). Also, during the time period t0a to t1a, the potential difference between −2 V on the display signal line 3-32 and +2 V on the reference potential trunk line 4-3-2, this being −4 V, is generated at the liquid crystal element 1-32-2 (equivalent electrical capacitance). Additionally, during the time period t0a to t1a, the potential difference between −2 V on the display signal line 3-32 and +1 V on the reference potential trunk line 4-3-(n−1), this being −3 V, is generated at the liquid crystal element 1-32-(n−1). Additionally, during the time period t0a to t1a, the potential difference between −2 V on the display signal line 3-32 and 0 V on the reference potential trunk line 4-3-n, this being −2 V, is generated at the liquid crystal element 1-32-n (equivalent electrical capacitance). As a result, in the luminance of the sub-pixels 302-1 to 302-n, in accordance with the potential difference, the luminance of the sub-pixel 302-1 is higher than that of the sub-pixel 302-2, also the luminance of the sub-pixel 302-2 is higher than that of the sub-pixel 302-(n−1), and also the luminance of the sub-pixel 302-(n−1) is higher than that of the sub-pixel 302-n.

Next, the operation at (L+1) th frame will be described, using FIG. 26 and FIG. 27. FIG. 27 shows the timing diagram of the (L+1) th frame after the time t0b.

In FIG. 27, the horizontal axis represents time, and the vertical axis represents electrical potential. The waveform 1 in FIG. 27 shows the time variations of the potential on the scanning line 5-1. The waveform 2 in FIG. 27 shows the time variations of the potential on the scanning line 5-2. The waveform 3 in FIG. 27 shows the time variations of the potential on the reference potential trunk line 4-1. The waveform 4 in FIG. 27 shows the time variations of the potential on the reference potential trunk line 4-2. The waveform 5 in FIG. 27 shows the time variations of the potential on the reference potential trunk line 4-(n−1). The waveform 6 in FIG. 27 shows the time variations of the potential on the reference potential trunk line 4-(n). The waveform 7 in FIG. 27 shows the time variations of the potential on the reference potential trunk line 3-1. The waveform 8 in FIG. 27 shows the time variations of the potential on the display signal line 3-2. The waveform 9 in FIG. 27 shows the time variations of the potential on the node X. The waveform 10 in FIG. 27 shows the time variations of the potential on the node Y. The waveform 11 in FIG. 27 shows the time variations of the potential between node X and the node Y (voltage applied to Sub-pix1). The waveform 12 in FIG. 27 shows the time variations of the voltage applied to the liquid crystal of sub-pix(n−2). The waveform 13 in FIG. 27 shows the time variations of the voltage applied to the liquid crystal of sub-pix(n−1). The waveform 14 in FIG. 27 shows the time variations of the voltage applied to the liquid crystal of sub-pix(n).

During the vertical return interval, the controller 12 switches the polarity of the potentials on the display signal lines 3-31 to 3-33 to the polarity that is the reverse of the polarity in the Lth frame. Additionally, the controller 12 switches the potential on the reference potential trunk line 4-3-1 from +3 V to 0 V, switches the potential on the reference potential trunk line 4-3-2 from +2 V to +1 V, switches the potential on the reference potential trunk line 4-3-(n−1) from +1 V to +2 V, and switches the potential on the reference potential trunk line 4-3-n from 0 V to +3 V. That is, the controller 12 switches the relationship of the magnitude of the potential from the relationship (reference potential trunk line 4-3-1>reference potential trunk line 4-3-2> . . . >reference potential trunk line 4-3-(n−1)>reference potential trunk line 4-3-n), in which the potential on the reference potential trunk line 4-3-1 is larger than that of the reference potential trunk line 4-3-2, the potential on the reference potential trunk line 4-3-2 is larger than that of the reference potential trunk line 4-3-(n−1) and the potential on the reference potential trunk line 4-3-(n−1) is larger than that of the reference potential trunk line 4-3-(n), to the relationship (reference potential trunk line 4-3-1<reference potential trunk line 4-3-2< . . . <reference potential trunk line 4-3-(n−1)<reference potential trunk line 4-3-n) in which the potential on the reference potential trunk line 4-3-n is larger than that of the reference potential trunk line 4-3-(n−1), the potential on the reference potential trunk line 4-3-(n−1) is larger than that of the reference potential trunk line 4-3-2, and the potential on the reference potential trunk line 4-3-2 is larger than that of the reference potential trunk line 4-3-1. The controller 12 supplies −2 V from the display signal line 3-31 to the pixels 301 and 303, and supplies +5 V from the display signal line 3-12 to the pixel 302.

Next, the controller 12 controls the scanning line 5-31 to the high level between times t0b to t1b, thus placing the switching elements 2-31-1 to 2-31-n, 2-32-1 to 2-32-n, and 2-33-1 to 2-33-n into the on state. The switching of each switching element to the on state and potential difference generated in each liquid crystal element will be described below.

The operation of the sub-pixel 301-1 to the sub-pixel 301-n of the pixel 301 will be described. During the time period t0b to t1b, the potential difference between −2 V on the display signal line 3-31 and 0 Von the reference potential trunk line 4-3-1, this being −2 V, is generated at the liquid crystal element 1-31-1. Also, during the time period t0b to t1b, the potential difference between −2 V on the display signal line 3-31 and +1 V on the reference potential trunk line 4-3-2, this being −3 V, is generated at the liquid crystal element 1-11-2. Additionally, during the time period t0b to t1b, the potential difference between −2 V on the display signal line 3-31 and +2 V on the reference potential trunk line 4-3-(n−1), this being −4 V, is generated at the liquid crystal element 1-31-(n−1). Additionally, during the time period t0b to t1b, the potential difference between −2 V on the display signal line 3-31 and +3 V on the reference potential trunk line 4-3-n, this being −5 V, is generated at the liquid crystal element 1-31-n. As a result, in the luminance of the sub-pixels 301-1 to 301-n, in accordance with the potential differences, the luminance of the sub-pixel 301-n is higher than that of the sub-pixel 301-(n−1), also the luminance of the sub-pixel 301-(n−1) is higher than that of the sub-pixel 301-2, and also the luminance of the sub-pixel 301-2 is higher than that of the sub-pixel 301-1.

The controller 12 supplies to the display signal line 3-33 a display signal having the same polarity as for the display signal line 3-31. For this reason, during the time period t0b to t1b, a potential difference of −2 V is generated at the liquid crystal element 1-33-1 of the sub-pixel 303-1 of the pixel 303. Also, a potential difference of −3 V is generated at the liquid crystal element 1-33-2 of the sub-pixel 303-2. Also, a potential difference of −4 V is generated at the liquid crystal element 1-33-(n−1) of the sub-pixel 303-(n−1). Also, a potential difference of −5 V is generated at the liquid crystal element 1-33-n of the sub-pixel 303-n. For this reason, in the luminance of the sub-pixel 303-1 to 303-n, in accordance with the potential difference, the luminance of the sub-pixel 303-n is higher than that of the sub-pixel 303-(n−1), also the luminance of the sub-pixel 303-(n−1) is higher than that of the sub-pixel 303-2, and also the luminance of the sub-pixel 303-2 is higher than that of the sub-pixel 303-1.

Next, the operation of the sub-pixel 302-1 to the sub-pixel 302-n of the pixel 302 will be described. During the time period t0b to t1b, the potential difference between +5 V on the display signal line 3-32 and 0 V on the reference potential trunk line 4-3-1, this being +5 V, is generated at the liquid crystal element 1-32-1. Also, during the time period t0b to t1b, the potential difference between +5 V on the display signal line 3-32 and +1 V on the reference potential trunk line 4-3-2, this being +4 V, is generated at the liquid crystal element 1-32-2. Additionally, during the time period t0b to t1b, the potential difference between +5 V on the display signal line 3-32 and +2 V on the reference potential trunk line 4-3-(n−1), this being +3 V, is generated at the liquid crystal element 1-32-(n−1). Additionally, during the time period t0b to t1b, the potential difference between +5 V on the display signal line 3-32 and +3 V on the reference potential trunk line 4-3-n, this being +2 V, is generated at the liquid crystal element 1-32-n. As a result, in the luminance of the sub-pixels 302-1 to 302-n, in accordance with the potential difference, the luminance of the sub-pixel 302-1 is higher than that of the sub-pixel 302-2, also the luminance of the sub-pixel 302-2 is higher than that of the sub-pixel 302-(n−1), and further the luminance of the sub-pixel 302-(n−1) is higher than that of the sub-pixel 302-n.

In the present embodiment, although an example such as switching the potential on the reference potential trunk lines 4-3-1 to 4-3-n for each frame have been described, the switching may be done for each pixel selection period. The pixel selection period is, for example, in the case of a display device driven by 60-Hz with a Full HD resolution (having 1080 scanning lines), every 1/60/1080 s. Additionally, if the pixel selection period is defined as 1H, the potential may be switched every 2 kH (where k is an integer of one or larger).

As described above, it is possible to cause generation of different potential differences between equivalent electrical capacitance of each of the liquid crystal element of an even number of sub-pixels of one pixel, thereby obtaining a liquid crystal display device having a multipixel opposing matrix constitution by data-line-inversion drive. Also, because there is need to change the potential on each of the reference potential trunk lines 4-4-1 and 4-4-n only one time for one frame, a display device having low electrical power consumption can be achieved.

### Ninth Embodiment

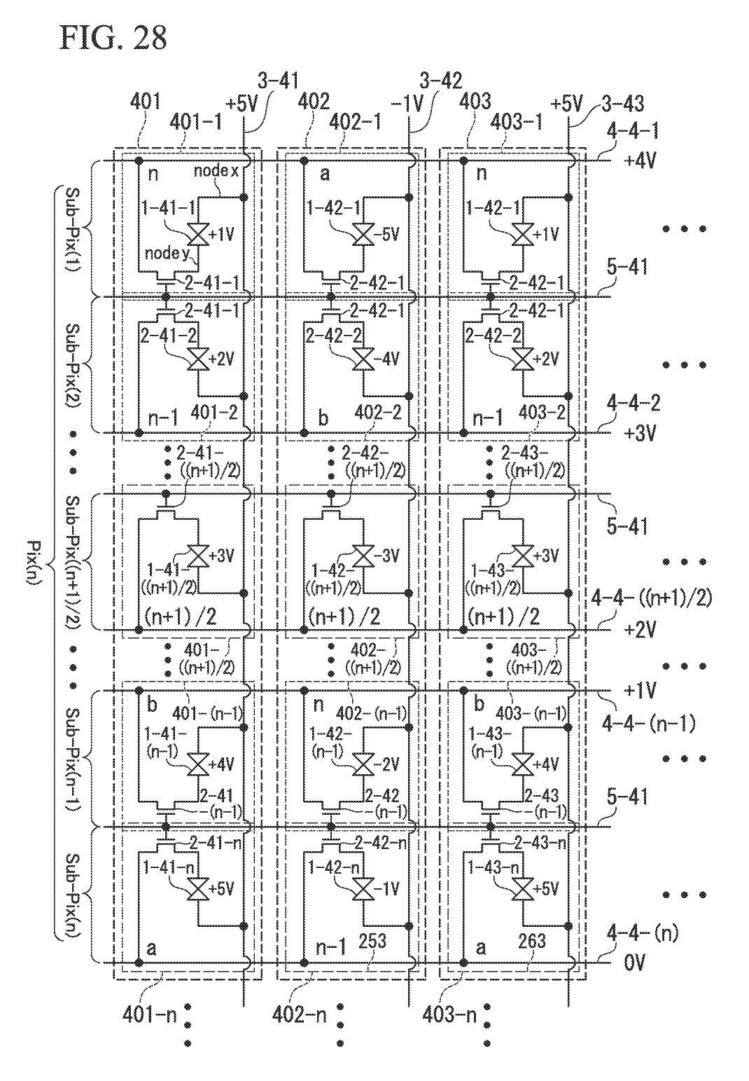

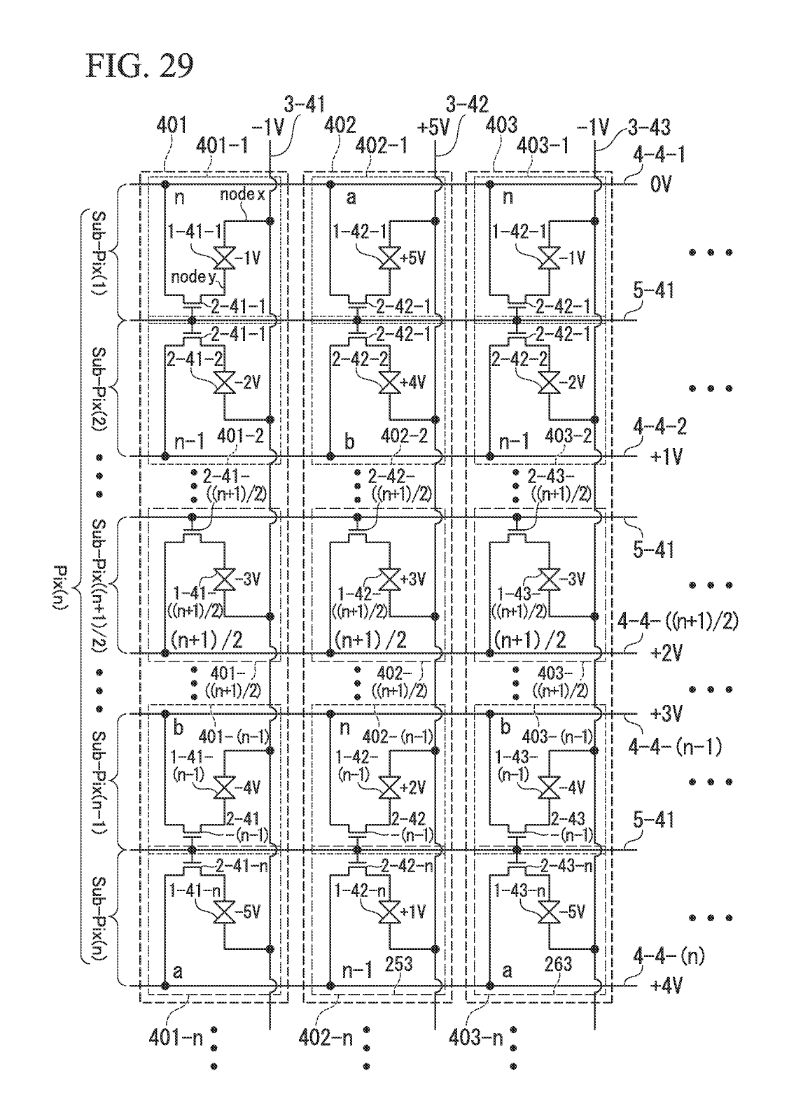

The ninth embodiment is an embodiment of a liquid crystal display device, which is constituted so that one pixel is made up of n sub-pixels (where n is an odd number). FIG. 28 is an equivalent circuit describing the operation at the Lth frame of the liquid crystal display device of the ninth embodiment, having a pixel (Pix(n)) that has n sub-pixels (Sub-Pix(1), Sub-Pix(2), . . . , Sub-Pix((n+1)/2), . . . , Sub-Pix(n−1), and Sub-Pix(n)). FIG. 29 is an equivalent circuit describing the operation at the (L+1) th frame of the liquid crystal display device of the ninth embodiment having a pixel (Pix(n)) that has n sub-pixels (Sub-Pix(1), Sub-Pix(2), . . . , Sub-Pix((n+1)/2), . . . , Sub-Pix(n−1), and Sub-Pix(n)). The liquid crystal display device of the ninth embodiment has pixels 401 to 403 that are adjacent to in the row direction. The pixels 401 to 403 further have n sub-pixels. The pixel 401 has, with respect to the column direction, the sub-pixel 401-1 to the sub-pixel 401-n, disposed in that sequence. The pixel 402 has, with respect to the column direction, the sub-pixel 402-1 to the sub-pixel 402-n, disposed in that sequence. The pixel 403 has, with respect to the column direction, the sub-pixel 403-1 to the sub-pixel 403-n, disposed in that sequence.

First, the constitution of the sub-pixels 401-1 to the sub-pixels 401-n of the pixel 401 will be described. The gate terminals of the switching element 2-41-1 to 2-41-n are connected to the common scanning line 5-41. The source terminal of the switching element 2-41-1 is connected to the reference potential trunk line 4-4-1. The drain terminal of the switching element 2-41-1 is connected to one end of the liquid crystal element 1-41-1, via the display electrode 11. The other end of the liquid crystal element 1-41-1 is connected to the display signal line (first display signal) 3-41, via the transparent electrode 13. The source terminal of the switching element 2-41-2 is connected to the reference potential trunk line 4-4-2. The drain terminal of the switching element 2-41-2 is connected to one end of the liquid crystal element 1-41-2, via the display electrode 11. The other end of the liquid crystal element 1-41-2 is connected to the display signal line 3-41, via the transparent electrode 13. Additionally, the source terminal of the switching element 2-41-(n+1)/2 is connected to the reference potential trunk line 4-4-(n+1)/2. The drain terminal of the switching element 2-41-(n+1)/2 is connected to one end of the liquid crystal element 1-41-(n+1)/2, via the display electrode 11. The other end of the liquid crystal element 1-41-(n+1)/2 is connected to the display signal line 3-41, via the transparent electrode 13. Additionally, the source terminal of the switching element 2-41-(n−1) is connected to the reference potential trunk line 4-4-(n−1). The drain terminal of the switching element 2-41-(n−1) is connected to one end of the liquid crystal element 1-41-(n−1), via the display electrode 11, and the other end of the liquid crystal element 1-41-(n−1) is connected to the display signal line 3-41, via the transparent electrode 13. Additionally, the source terminal of the switching element 2-41-n is connected to the reference potential trunk line 4-4-n. The drain terminal of the switching element 2-41-n is connected to one end of the liquid crystal element 1-41-n, via the display electrode 11, and the other end of the liquid crystal element 1-41-n is connected to the display signal line 3-41, via the transparent electrode 13.

Next, the constitution of the sub-pixels 402-1 to 402-n of the pixel 402 will be described. The gate terminals of the switching elements 2-42-1 to 2-42-n are connected to the common scanning line 5-41. The source terminal of the switching element 2-42-1 is connected to the reference potential trunk line 4-4-1. The drain terminal of the switching element 2-42-1 is connected to one end of the liquid crystal element 1-42-1, via the display electrode 11. The other end of the liquid crystal element 1-42-1 is connected to the display signal line (second display signal line) 3-42, via the transparent electrode 13. The source terminal of the switching element 2-42-2 is connected to the reference potential trunk line 4-4-2. The drain terminal of the switching element 2-42-2 is connected to one end of the liquid crystal element 1-42-2, via the display electrode 11, and the other end of the liquid crystal element 1-42-2 is connected to the display signal line 3-42, via the transparent electrode 13. Additionally, the source terminal of the switching element 2-42-(n+1)/2 is connected to the reference potential trunk line 4-4-(n+1)/2. The drain terminal of the switching element 2-42-(n+1)/2 is connected to one end of the liquid crystal element 1-42-(n+1)/2, via the display electrode 11. The other end of the liquid crystal element 1-42-(n+1)/2 is connected to the display signal line 3-42, via the transparent electrode 13. Additionally, the source terminal of the switching element 2-42-(n−1) is connected to the reference potential trunk line 4-4-(n−1). The drain terminal of the switching element 2-42-(n−1) is connected to one end of the liquid crystal element 1-42-(n−1), via the display electrode 11. The other end of the liquid crystal element 1-42-(n−1) is connected to the display signal line 3-42, via the transparent electrode 13. Additionally, the source terminal of the switching element 2-42-n is connected to the reference potential trunk line 4-4-n. The drain terminal of the switching element 2-42-n is connected to one end of the liquid crystal element 1-42-n, via the display electrode 11. The other end of the liquid crystal element 1-42-n is connected to the display signal line 3-42, via the transparent electrode 13.

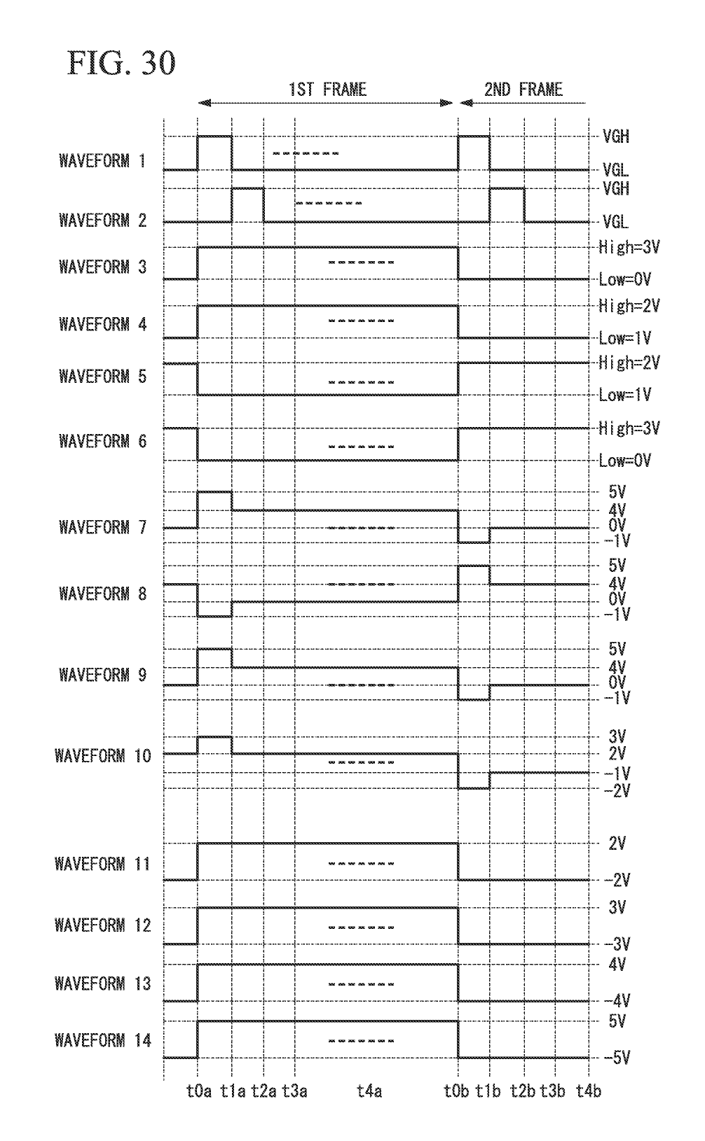

Next, the operation of the liquid crystal display device will be described, using FIG. 28 and FIG. 30. FIG. 30 is a timing diagram of the liquid crystal display device of the ninth embodiment at the Lth frame and at the (L+1) th frame.

The operation of each sub-pixel of the pixels 401 to 403 at the Lth frame (where L is a natural number 1 or larger) will be first described. The controller 12 controls the reference potential trunk line 4-4-1 to +4 V, controls the reference potential trunk line 4-4-2 to +3 V, controls the reference potential trunk line 4-(n−1)/2 to +2 V, controls the reference potential trunk line 4-4-(n−1) to +1 V, and controls the reference potential trunk line 4-4-n to 0 V (FIG. 28 at time t0a). That is, the controller 12 controls the magnitude of the potential to the relationship (reference potential trunk line 4-4-1>reference potential line 4-4-2> . . . >reference potential line 4-(n+1)/2> . . . >reference potential line 4-4-(n−1)>reference potential trunk line 4-4-n) in which the potential on the reference potential line 4-4-1 is larger than that on the reference potential line 4-4-2 and also the potential on the reference potential line 4-4-2 is larger than that on the reference potential trunk line 4-(n+1)/2, also the potential on the reference potential line 4-(n+1)/2 is larger than that on the reference potential line 4-4-(n−1), and also the potential on the reference potential line 4-4-(n−1) is larger than that on the reference potential line 4-4-n. The controller 12 supplies signals of +5 V to the pixel 401 and the pixel 403 from the display signal lines 3-41 and 3-43, and supplies a signal of −1 V to the pixel 402 from the display signal line 3-42. The range of the signal on each display signal line 3-11 to 3-13 is, for example, +5 V to +1 V on the positive polarity side and −5 V to −1 V on the negative polarity side.

Next, the controller 12 controls the scanning line 5-41 to the high level between times t0a to t1a, thus placing the switching elements 2-41-1 to 2-41-n, 2-42-1 to 2-32-n, and 2-33-1 to 2-43-n into the on state. Also, the signal levels on the display signal line 3-41 and display signal line 3-42 shown in FIG. 30 are signal levels showing one example of operation. The switching of each switching element to the on state and potential difference generated in each liquid crystal element will be described below.

The operation of the sub-pixel 401-1 to the sub-pixel 401-n of the pixel 401 will be described. During the time period t0a to t1a, the potential difference between +5 V on the display signal line 3-41 and +4 V on the reference potential trunk line 4-4-1, this being +1 V, is generated at the liquid crystal element 1-41-1 (equivalent electrical capacitance). Also, during the time period t0a to t1a, the potential difference between +5 V on the display signal line 3-41 and +3 V on the reference potential trunk line 4-4-2, this being +2 V, is generated at the liquid crystal element 1-41-2 (equivalent electrical capacitance). Additionally, during the time period t0a to t1a, the potential difference between +5 V on the display signal line 3-41 and +2 V on the reference potential trunk line 4-4-(n+1)/2, this being +3 V, is generated at the liquid crystal element 1-41-(n+1)/2 (equivalent electrical capacitance). Additionally, during the time period t0a to t1a, the potential difference between +5 V on the display signal line 3-41 and +1 V on the reference potential trunk line 4-4-(n−1), this being +4 V, is generated at the liquid crystal element 1-41-(n−1) (equivalent electrical capacitance). Additionally, during the time period t0a to t1a, the potential difference between +5 V on the display signal line 3-41 and 0 V on the reference potential trunk line 4-4-n, this being +5 V, is generated at the liquid crystal element 1-41-n (equivalent electrical capacitance). As a result, in the luminance of the sub-pixels 401-1 to 401-n, in accordance with the potential difference, the luminance of the sub-pixel 401-n is higher than that of the sub-pixel 401-(n−1), the luminance of the sub-pixel 401-(n−1) is higher than that of the sub-pixel 401-(n+1)/2, the luminance of the sub-pixel 401-(n+1)/2 is higher than that of the sub-pixel 401-2, and the luminance of the sub-pixel 401-2 is higher than that of the sub-pixel 401-1. In FIG. 28 and FIG. 29, the symbols a, b, . . . , n−1, and n represent the sequence of luminances, in which the luminance of a is higher than that of b, the luminance of b is higher than that of n−1, and the luminance of n−1 is higher than that of n (a>b> . . . >n−1>n).

The controller 12 supplies to the display signal line 3-43 a display signal having the same polarity as for the display signal line 3-41. For this reason, during the time period t0a to t1a, a potential difference of +1 V is generated at the liquid crystal element 1-43-1 (equivalent electrical capacitance) of the sub-pixel 403-1 of the pixel 403. Also, a potential difference of +2 V is generated at the liquid crystal element 1-43-2 (equivalent electrical capacitance) of the sub-pixel 403-2. Also, the potential difference of +3 V is generated at the liquid crystal element 1-43-(n+1)/2 of the sub-pixel 403-(n+1)/2. Also, the potential difference of +4 V is generated at the liquid crystal element 1-4-(n−1) (equivalent electrical capacitance) of the sub-pixel 403-(n−1). Also, the potential difference of +5 V is generated at the liquid crystal element 1-4-n (equivalent electrical capacitance) of the sub-pixel 403-n. For this reason, in the luminance of the sub-pixel 403-1 to 403-n, in accordance with the potential difference, the luminance of the sub-pixel 403-n is higher than that of the sub-pixel 403-(n−1), the luminance of the sub-pixel 403-(n−1) is higher than that of the sub-pixel 403-(n+1)/2, the luminance of the sub-pixel 403-(n+1)/2 is higher than that of the sub-pixel 403-2, and also the luminance of the sub-pixel 403-2 is higher than that of the sub-pixel 403-1.

Next, the operation of the sub-pixel 402-1 to the sub-pixel 402-n of the pixel 402 will be described. During the time period t0a to t1a, the potential difference between −1 V on the display signal line 3-42 and +4 V on the reference potential trunk line 4-4-1, this being −5 V, is generated at the liquid crystal element 1-42-1 (equivalent electrical capacitance). Also, during the time period t0a to t1a, the potential difference between −1 V on the display signal line 3-42 and +3 V on the reference potential trunk line 4-4-2, this being −4 V, is generated at the liquid crystal element 1-42-2 (equivalent electrical capacitance). Additionally, during the time period t0a to t1a, the potential difference between −1 V on the display signal line 3-42 and +2 V on the reference potential trunk line 4-4-(n+1)/2, this being −3 V, is generated at the liquid crystal element 1-42-(n+1)/2 (equivalent electrical capacitance). Additionally, during the time period t0a to t1a, the potential difference between −1 V on the display signal line 3-42 and +1 V on the reference potential trunk line 4-4-(n−1), this being −2 V, is generated at the liquid crystal element 1-42-(n−1) (equivalent electrical capacitance). Additionally, during the time period t0a to t1a, the potential difference between −1 V on the display signal line 3-42 and 0 V on the reference potential trunk line 4-4-n, this being −1 V, is generated at the liquid crystal element 1-42-n (equivalent electrical capacitance). As a result, in the luminance of the sub-pixels 402-1 to 402-n, in accordance with the potential difference, the luminance of the sub-pixel 402-1 is higher than that of the sub-pixel 402-2, the luminance of the sub-pixel 402-2 is higher than that of the sub-pixel 402-(n+1)/2, the luminance of the sub-pixel 402-(n+1)/2 is higher than that of the sub-pixel 402-(n−1), and the luminance of the sub-pixel 402-(n−1) is higher than that of the sub-pixel 402-n.

Next, the operation at (L+1) th frame will be described, using FIG. 29 and FIG. 30. FIG. 30 shows the timing diagram of the (L+1) th frame after the time t0b. In FIG. 30, the horizontal axis represents time, and the vertical axis represents electrical potential. The waveform 1 in FIG. 30 shows the time variations of the potential on the scanning line 5-21. The waveform 2 in FIG. 30 shows the time variations of the potential on the scanning line 5-22. The waveform 3 in FIG. 30 shows the time variations of the potential on the reference potential trunk line 4-21. The waveform 4 in FIG. 30 shows the time variations of the potential on the reference potential trunk line 4-22. The waveform 5 in FIG. 30 shows the time variations of the potential on the reference potential trunk line 4-(n−1). The waveform 6 in FIG. 30 shows the time variations of the potential on the reference potential trunk line 4-(n). The waveform 7 in FIG. 30 shows the time variations of the potential on the reference potential trunk line 3-21. The waveform 8 in FIG. 30 shows the time variations of the potential on the display signal line 3-22. The waveform 9 in FIG. 30 shows the time variations of the potential on the node X. The waveform 10 in FIG. 30 shows the time variations of the potential on the node Y. The waveform 11 in FIG. 30 shows the time variations of the potential between node X and the node Y (voltage applied to Sub-pix(n−3)). The waveform 12 in FIG. 30 shows the time variations of the voltage applied to the liquid crystal of sub-pix(n−2). The waveform 13 in FIG. 30 shows the time variations of the voltage applied to the liquid crystal of sub-pix(n−1). The waveform 14 in FIG. 30 shows the time variations of the voltage applied to the liquid crystal of sub-pix(n).

During the vertical return interval, the controller 12 switches the polarity of the potentials on the display signal lines 3-41 to 3-43 to the polarity that is the reverse of the polarity in the Lth frame. Additionally, the controller 12 switches the potential on the reference potential trunk line 4-4-1 from +4 V to 0 V, switches the potential on the reference potential trunk line 4-4-2 from +3 V to +1 V, switches the potential on the reference potential trunk line 4-4-(n−1) from +1 V to +3 V, and switches the potential on the reference potential trunk line 4-4-n from 0 V to +4 V. That is, the controller 12 switches the relationship of the magnitude of the potential (reference potential trunk line 4-4-1>reference potential trunk line 4-4-2> . . . >reference potential trunk line 4-(n+1)12> . . . >reference potential trunk line 4-4-(n−1)>reference potential trunk line 4-4-n) from the relationship in which the potential on the reference potential trunk line 4-4-1 is larger than that of the reference potential trunk line 4-4-2, the potential on the reference potential trunk line 4-4-2 is larger than that of the reference potential trunk line 4-(n+1)/2, and the potential on the reference potential trunk line 4-(n+1)/2 is larger than that of the reference potential trunk line 4-4-(n−1), and also the potential on the reference potential trunk line 4-4-(n−1) is larger than that of the reference potential trunk line 4-4-n, to the relationship (reference potential trunk line 4-4-1<reference potential trunk line 4-4-2< . . . <reference potential trunk line 4-(n+1)/2< . . . <reference potential trunk line 4-4-(n−1)<reference potential trunk line 4-4-n), in which the potential on the reference potential trunk line 4-4-n is larger than that of the reference potential trunk line 4-4-(n−1), the potential on the reference potential trunk line 4-4-(n−1) is larger than that of the reference potential trunk line 4-(n+1)/2, also the potential on the reference potential trunk line 4-(n+1)/2 is larger than that of the reference potential trunk line 4-4-2, and also the potential on the reference potential trunk line 4-4-2 is larger than that of the reference potential trunk line 4-4-1. The controller 12 supplies −1 V from the display signal line 3-31 to the pixels 301 and 403, and supplies +5 V from the display signal line 3-12 to the pixel 402.

Next, the controller 12 controls the scanning line 5-41 to the high level between times t0b to t1b, thus placing the switching elements 2-401-1 to 2-41-n, 2-42-1 to 2-42-n, and 2-43-1 to 2-43-n into the on state. The switching of each switching element to the on state and potential difference generated in each liquid crystal element will be described below.

The operation of the sub-pixel 401-1 to the sub-pixel 401-n of the pixel 401 will be described. The potential difference between −1 V on the display signal line 3-41 and 0 V on the reference potential trunk line 4-4-1, this being −1 V, is generated at the liquid crystal element 1-41-1. Also, the potential difference between −1 V on the display signal line 3-41 and +1 V on the reference potential trunk line 4-4-2, this being −2 V, is generated at the liquid crystal element 1-41-2. Additionally, the potential difference between −1 V on the display signal line 3-41 and +2 V on the reference potential trunk line 4-4-(n+1)/2, this being −3 V, is generated at the liquid crystal element 1-41-(n+1)/2. Additionally, the potential difference between −1 V on the display signal line 3-41 and +3 V on the reference potential trunk line 4-4-(n−1), this being −4 V, is generated at the liquid crystal element 1-41-(n−1). Additionally, the potential difference between −1 V on the display signal line 3-41 and +4 V on the reference potential trunk line 4-4-n, this being −5 V, is generated at the liquid crystal element 1-41-n. As a result, in the luminance of the sub-pixels 401-1 to 401-n, in accordance with the potential differences, the luminance of the sub-pixel 401-n is higher than that of the sub-pixel 401-(n−1), the luminance of the sub-pixel 401-(n−1) is higher than that of the sub-pixel 401-(n+1)/2, the luminance of the sub-pixel 401-(n+1)/2 is higher than that of the sub-pixel 401-2, and the luminance of the sub-pixel 401-2 is higher than that of the sub-pixel 401-1.

The controller 12 supplies to the display signal line 3-43 a display signal having the same polarity as for the display signal line 3-41. For this reason, a potential difference of −1 V is generated at the liquid crystal element 1-43-1 of the sub-pixel 403-1 of the pixel 403. Also, a potential difference of −2 V is generated at the liquid crystal element 1-43-2 of the sub-pixel 403-2. Also, a potential difference of −3 V is generated at the liquid crystal element 1-43-(n+1)/2 of the sub-pixel 403-(n+1)/2. Also, a potential difference of −4 V is generated at the liquid crystal element 1-4-(n−1) of the sub-pixel 403-(n−1). Also, a potential difference of −5 V is generated at the liquid crystal element 1-4-n of the sub-pixel 403-n. For this reason, in the luminance of the sub-pixel 403-1 to 403-n, in accordance with the potential difference, the luminance of the sub-pixel 403-n is higher than that of the sub-pixel 403-(n−1), the luminance of the sub-pixel 403-(n−1) is higher than that of the sub-pixel 403-(n+1)/2, the luminance of the sub-pixel 403-(n+1)/2 is higher than that of the sub-pixel 403-2, and the luminance of the sub-pixel 403-2 is higher than that of the sub-pixel 403-1.

Next, the operation of the sub-pixel 402-1 to the sub-pixel 402-n of the pixel 402 will be described. The potential difference between +5 V on the display signal line 3-42 and 0 Von the reference potential trunk line 4-1-1, this being +5 V, is generated at the liquid crystal element 1-42-1. Also, the potential difference between +5 V on the display signal line 3-42 and +1 V on the reference potential trunk line 4-4-2, this being +4 V, is generated at the liquid crystal element 1-42-2. Additionally, the potential difference between +5 V on the display signal line 3-42 and +2 V on the reference potential trunk line 4-4-(n+1)/2, this being +3 V, is generated at the liquid crystal element 1-42-(n+1)/2. Additionally, the potential difference between +5 V on the display signal line 3-42 and +3 V on the reference potential trunk line 4-4-(n−1), this being +2 V, is generated at the liquid crystal element 1-42-(n−1). Additionally, the potential difference between +5 V on the display signal line 3-42 and 0 V on the reference potential trunk line 4-4-n, this being +1 V, is generated at the liquid crystal element 1-42-n.

As a result, in the luminance of the sub-pixels 402-1 to 402-n, in accordance with the potential difference, the luminance of the sub-pixel 402-1 is higher than that of the sub-pixel 402-2, the luminance of the sub-pixel 402-2 is higher than that of the sub-pixel 402-(n+1)/2, the luminance of the sub-pixel 402-(n+1)/2 is higher than that of the sub-pixel 402-(n−1), and the luminance of the sub-pixel 402-(n−1) is higher than that of the sub-pixel 402-n.

In the present embodiment, although an example such as switching the potential on the reference potential trunk lines 4-4-1 to 4-4-n for each frame has been described, the switching may be done for each pixel selection period. The pixel selection period is, for example, in the case of a display device driven by 60-Hz with a Full HD resolution (having 1080 scanning lines), every 1/60/1080 s. Additionally, if the pixel selection period is defined as 1H, the potential may be switched every 2 kH (where k is an integer of one or larger).

As described above, it is possible to cause generation of different potential differences between equivalent electrical capacitances of each liquid crystal element of even number of sub-pixels of one pixel, thereby obtaining a liquid crystal display device having a multipixel opposing matrix constitution by data-line-inversion drive. Also, because there need to change the potential on each reference potential trunk lines 4-4-1 to 4-4-n only one time for one frame, a display device having low electrical power consumption can be achieved.

Also, in the present embodiment, although the operation of the liquid crystal display device of the present invention have been described regarding a constitution of three pixels to six pixels, the number of pixels may be further constituted in the row direction and in the column direction.

In the present embodiment, although an example such as controlling each of the display signal lines 3, each of the reference potential trunk lines 4, and each of the scanning lines 5 by the controller 12 has been described, the controlling may be done by separate drivers.

Also, the signal levels and the potentials on the reference potential trunk lines used in the description of the present embodiments are exemplary, and if the polarity and magnitude of the potentials to relationships described in each embodiment are maintained, embodiment with potentials other than those noted is possible.

### INDUSTRIAL APPLICABILITY

The present invention is applicable to a liquid crystal display device having a multipixel constitution with an opposing matrix.

### REFERENCE SYMBOLS

1, 1-11 to 1-12, 1-21 to 1-22, 1-31 to 1-32, 1-41 to 1-42, 1-51 to 1-52, 1-61 to 1-62: Liquid crystal element
2, 2-11 to 2-12, 2-21 to 2-22, 2-31 to 2-32, 2-41 to 2-42, 2-51 to 2-52, 2-61 to 2-62: Switching element
3, 3-1 to 3-3: Display signal line
4, 4-1 to 4-2: Reference potential trunk line
5, 5-1 to 5-2: Scanning line
10: First substrate
11: Electrode
12: Controller
13: Transparent electrode
20: Second substrate
101 to 106: Pixel
111 to 113, 121 to 123, 131 to 133, 141 to 143, 151 to 152, 161 to 163: Sub pixel

1. A liquid crystal display device comprising:
pixels each composed of n (n≧2, where n is a positive integer) sub-pixels that correspond to a plurality of luminance regions, the pixels being arranged in a matrix;
a switching element provided for each sub-pixel;
a liquid crystal element provided for each sub-pixel;
n (1st to nth) reference potential trunk lines having a mutually different magnitude of potential;
a first display signal line that supplies a display signal;
a scanning line;
a controller;
a first substrate on which the n (1st to nth) reference potential trunk lines and the switching elements are disposed; and
a second substrate on which the first display signal lines are disposed;
wherein the liquid crystal elements are formed in between the first substrate and the second substrate,
a pole at one end of each liquid crystal element of the n sub-pixels is connected to the first display signal line, and a pole at the other end of each liquid crystal element of the n sub-pixels is connected to the respective first to nth reference potential trunk lines via the respective switching elements, and
from the scanning line, the controller supplies an on-state signal to each switching element of the n sub-pixels with the same timing.

2. The liquid crystal display device according to claim 1, wherein the controller switches the polarity of the potential of the first reference potential trunk line for each frame.

3. The liquid crystal display device according to claim 2, wherein the controller alternately switches the magnitude of potential to the sequence from the first reference potential trunk line to the nth reference potential trunk line and from the nth reference potential trunk line to the first reference potential trunk line for each frame.

4. The liquid crystal display device according to claim 1, wherein the controller switches the potential of the first display signal line for each frame, about a prescribed reference voltage as the center, additionally adds the prescribed voltage amplitude about the potential to the prescribed reference voltage as the center, and alternately switches the magnitude of the potential between the sequence from the first reference potential trunk line to the nth reference potential trunk line and the sequence from the nth reference potential trunk line to the first reference potential trunk line for each frame.

5. The liquid crystal display device according to claim 2, further comprising a second display signal line that supplies a display signal line, wherein
each of the liquid crystal elements of n sub-pixels that is disposed so to be adjacent to the n sub-pixels in the row direction has one end that is connected to the second display signal line and another end that is connected from the first reference potential trunk line to the nth reference potential trunk line, via each respective switching element, and wherein
the controller alternately switches the polarity of the potential on the first display signal line and the second display signal line for each frame.

6. The liquid crystal display device according to claim 1, wherein
pixels constituted by the n sub-pixels and the n sub-pixels disposed so as to be adjacent thereto in the row direction are disposed in a matrix,
and further comprising:
a first' reference trunk line having a potential that differs in magnitude with the first reference trunk line and
a second display signal line that supplies a display signal
wherein
the liquid crystal elements of the sub-pixels of pixels that are adjacent in the row direction to sub-pixels of the liquid crystal elements connected to the first reference trunk line via the switching elements have one end that is connected to the second display signal line and another end that is connected to the first' reference potential trunk line via the switching element,
the liquid crystal elements of the sub-pixels of pixels that are adjacent in the row direction to sub-pixels of the liquid crystal elements connected to the second reference trunk line via the switching elements have one end that is connected to the second display signal line and have another end that is connected to the second reference potential trunk line via the switching element, and
the controller
alternately switches the relationship between the magnitude of the potential on the first reference potential trunk line and the magnitude of the potential on the first' reference trunk line for each frame.

7. The liquid crystal display device according to claim 6, wherein the controller
alternately switches from a relationship in which the potential on the first reference potential trunk line is larger than the potential on the first' reference trunk line to a relationship in which the potential on the first' reference trunk line is larger than the potential on the first reference potential trunk line for each frame,
or
alternately exchanges the polarity of the potential on the first' reference trunk line with the polarity of the potential on the first reference potential trunk line for each frame.

8. The liquid crystal display device according to claim 1, wherein
pixels constituted by the n sub-pixels and the n sub-pixels disposed so as to be adjacent thereto in the row direction are disposed in a matrix,
and further comprising:
a first' reference trunk line having a potential that differs in magnitude with that of the first reference trunk line,
a third' reference trunk line having a potential that differs in magnitude with that of a third reference trunk line, and
a second display signal line supplying a display signal,
wherein
the liquid crystal elements of the sub-pixels of pixels that are adjacent in the row direction to sub-pixels of the liquid crystal elements connected to the first reference trunk line via the switching elements have one end that is connected to the second display signal line and another end that is connected to the first' reference potential trunk line via the switching element,
the liquid crystal elements the sub-pixels of pixels that are adjacent in the row direction to sub-pixels of the liquid crystal elements connected to the second reference trunk line via the switching elements have one end that is connected to the second display signal line and another end that is connected to the second reference potential trunk line via the switching element, and
the liquid crystal elements of the sub-pixels of pixels that are adjacent in the row direction to sub-pixels of the liquid crystal elements connected to the third reference trunk line via the switching elements have one end that is connected to the second display signal line and another end that is connected to the third' reference potential trunk line via the switching element, wherein
the controller
alternately exchanges the relationship of the magnitude of the potential on the first reference potential trunk line and the magnitude of the potential on the first' reference trunk line and the relationship of the magnitude of the potential on the third reference potential trunk line and the magnitude of the potential on the third' reference trunk line, for each frame.

9. The liquid crystal display device according to claim 8, wherein
the controller
alternately switches form a relationship in which the potential on the first reference potential trunk line is larger than the potential on the first' reference trunk line and also the potential on the third reference potential trunk line is larger than the potential on the third' reference trunk line, to a relationship in which the potential on the first' reference trunk line is larger than the potential on the first reference potential trunk line and also the potential on the third' reference trunk line is larger than the potential on the third reference potential trunk line, for each frame,
or
alternately switches from a relationship in which the potential on the first' reference trunk line is larger than the potential on the first reference potential trunk line and also the potential on the third reference potential trunk line is larger than the potential on the third' reference trunk line, to a relationship in which the potential on the first reference potential trunk line is larger than the potential on the first' reference trunk line and also the potential on the third' reference trunk line is larger than the potential on the third reference potential trunk line, for each frame.

10. The liquid crystal display device according to claim 1, wherein each sub-pixel of pixels on the s-th row (where s is a positive integer) is, with respect to the n-th reference potential trunk line, disposed in linear symmetry with each sub-pixel of the pixels on the (s−1)th row.

11. A pixel circuit of a liquid crystal display device in which a liquid crystal is formed between a first substrate, on which a 1st to the nth reference potential trunk lines and the switching elements are disposed, and a second substrate, on which the first display signal lines are disposed, wherein
pixels constituted by n (where n, a positive integer, is greater than or equal to 2) sub-pixels corresponding to a plurality of luminance regions are disposed in a matrix,
and comprising:
switching elements provided for each of the sub-pixels,
liquid crystal elements provided for each of the sub-pixels,
n reference potential trunk lines from the 1st reference potential trunk line to the nth reference potential trunk line, having mutually different magnitudes of potential,
a first display signal line that supplies a display signal,
a scanning line, and
a controller,
wherein
a pole at one end of each liquid crystal element of the n sub-pixels is connected to the first display signal line, and a pole at the other end of each liquid crystal element of the n sub-pixels is connected to the respective first to nth reference potential trunk lines via the respective switching elements, and
the controller
supplies an on-state signal from the scanning line to each of switching element of the n sub-pixels with the same timing.

12. A pixel driving method in which a liquid crystal is formed between a first substrate, on which 1st to nth reference potential trunk lines and switching elements are disposed, and a second substrate, on which first display signal lines are disposed, wherein
pixels constituted by n (where n, a positive integer, is greater than or equal to 2) sub-pixels corresponding to a plurality of luminance regions are disposed in a matrix,
and comprising:
switching elements provided for each of the sub-pixels,
liquid crystal elements provided for each of the sub-pixels,
n reference potential trunk lines from the 1st reference potential trunk line to the nth reference potential trunk line, having mutually different magnitudes of potential,
a first display signal line supplying a display signal,
a scanning line, and
a controller,
wherein
a pole at one end of each liquid crystal element of the n sub-pixels is connected to the first display signal line, and a pole at the other end of each liquid crystal element of the n sub-pixels is connected to the respective first to nth reference potential trunk lines via the respective switching elements, and
the controller
supplies an on-state signal from the scanning line to each of switching element of the n sub-pixels with the same timing.
